(19) United States
(12) Patent Application Publication
(10) Pub. No.: US 2026/0355936 A1
(43) Pub. Date: Nov. 12, 2026

(54) SYSTEMS AND METHODS FOR ROBOTIC SOLAR INSTALLATION

(71) Applicant: Luminous Robotics, Inc., Boston, MA (US)

(72) Inventors: Jay Ming Wong, Boston, MA (US); Robert Thomas Boyd, Weston, MA (US); Emma Sage Gardner-Garvey, Meredith, NH (US); Matthew Aidan Sweeney, North Billerica, MA (US); Harvey Anthony Koselka, Bolton, MA (US)

(21) Appl. No.: 19/670,919

(22) Filed: May 7, 2026

Related U.S. Application Data
(60) Provisional application No. 63/802,214, filed on May 8, 2025.
(60) Provisional application No. 63/854,602, filed on Jul. 31, 2025.

(51) Int. Cl. B25J 9/00; B25J 5/00; B25J 9/16; B25J 15/06; B25J 18/00; H02S 20/20; H02S 99/00

(52) U.S. Cl. CPC B25J 9/0009; B25J 5/005; B25J 9/1612; B25J 9/1697; B25J 15/065; B25J 18/007; H02S 20/20; H02S 99/00

(57) ABSTRACT

Systems and methods for installing solar panels using a robotic system are disclosed. A robotic system can include a movable base that navigates an environment for solar panel installation. An articulated arm can be disposed on the movable base and can include a gripper that couples to a solar panel. A controller can control the articulated arm and the gripper to move towards a first surface of the solar panel. The controller can actuate a vacuum source to couple the gripper to the first surface of the solar panel, with the solar panel having a first orientation relative to a body of the movable base. The controller can control the articulated arm to move the solar panel to a mounting location in the environment at a second orientation relative to the body of the movable base.

### CROSS-REFERENCE TO RELATED APPLICATION

The present application claims priority to U.S. Provisional Patent Application No. 63/802,214, filed on May 8, 2025, and U.S. Provisional Patent Application No. 63/854,602, filed on Jul. 31, 2025, each of which is incorporated herein by reference in its entirety.

### BACKGROUND

Solar panel installation environments can include rows of racking infrastructure, such as torque tubes and hat rails, onto which solar panels are mounted across large areas of terrain. Placing solar panels onto racking infrastructure can involve transporting each panel from a staging location to a mounting location and positioning the panel in a particular orientation relative to the racking infrastructure. However, performing such placement operations in outdoor solar installation environments presents challenges related to coordinating panel handling, positioning, and orientation across variable site conditions.

### SUMMARY

The systems and methods of the present disclosure provide robotic systems and methods for coordinating panel handling, positioning, and orientation that can travel along a row of a solar installation environment, pick up a solar panel from a staging location using an underhand vacuum engagement, and place the solar panel laterally onto racking infrastructure without turning a movable base. The systems and methods described herein can employ an articulated arm with a rotatable gripper assembly that provides an additional rotational degree of freedom, such that a solar panel can be rotated to a target orientation during transport without reorienting the arm. The systems and methods described herein can use camera imagery to determine the position of electrical lead terminals on a solar panel and select a coupling location and mounting orientation based on the determined terminal position, a travel direction of the mobile base, and a deployment side of the arm. The systems and methods described herein can determine a next mounting location based on image data depicting a previously placed panel and can withhold a release operation until the mobile base is within a threshold distance of the mounting location. The systems and methods described herein can calibrate cameras mounted on the mobile base and on the articulated arm by moving a marker on the arm into different positions within the fields of view of base-mounted cameras and by moving the arm camera to view a marker on the base, using known arm poses to update calibration data. The systems and methods described herein can use camera-based object detection to restrict movement of the articulated arm and the mobile base when a movement termination condition is satisfied, and can select from a plurality of predetermined safety zones based on whether the gripper is carrying a solar panel.

Furthermore, the systems and methods described herein provide a gripper assembly that includes a frame structure rotatably coupled to a frame mounting structure, with a plurality of suction cups mounted to the frame structure and a rotational actuation system that rotates the frame structure relative to the frame mounting structure. The frame structure can be formed from a lightweight, rigid material such as carbon fiber, and can carry the suction cups at distributed positions across the frame. A rotational shaft can be disposed within the frame mounting structure and can be rigidly coupled to the frame structure, and an actuator can be operably coupled to the rotational shaft to drive rotation of the frame structure. The suction cups can be mounted through compliant mounts that permit each suction cup to independently adjust to local surface contours and irregularities, including rear-surface features of solar panels such as junction boxes and electrical leads. In doing so, the systems and methods described herein can provide a dedicated rotational degree of freedom at the gripper that can relieve the articulated arm from providing final orientation adjustments, can reduce the payload burden on the articulated arm through lightweight frame construction, and can distribute gripping force across the panel surface through compliant suction cup mounts, thereby improving the speed, precision, and damage resistance of automated solar panel installation.

At least one aspect relates to a robotic system. The robotic system can include a movable base configured to navigate along a first direction of a row of an environment for solar panel installation. The robotic system can include an articulated arm disposed on the movable base and including a gripper configured to couple to a solar panel. The robotic system can include a controller. The controller can control the articulated arm and the gripper to move towards a first surface of the solar panel. The controller can actuate a vacuum source to couple the gripper to the first surface of the solar panel, the solar panel having a first orientation relative to a body of the movable base. The controller can control the articulated arm to move the solar panel to a mounting location in the environment at a second orientation relative to the body of the movable base, the articulated arm to move the solar panel in a second direction transverse to the first direction.

In some implementations, the first surface of the solar panel is an underside of the solar panel, and the solar panel is above the gripper while the articulated arm moves the solar panel to the mounting location following coupling to the first surface. In some implementations, the first surface is a non-active surface of the solar panel. In some implementations, the solar panel is a first solar panel moved according to a first operating mode of the controller, the mounting location is a first mounting location, the row is a first row of the environment, and the gripper couples to the first surface at a first coupling location. In some implementations, the controller can determine, in a second operating mode while the movable base moves along a second direction opposite the first direction of a second row of the environment, a second coupling location on the solar panel different from the first coupling location. In some implementations, the controller can control, in the second operating mode, the articulated arm and the gripper to couple to the solar panel at the second coupling location. In some implementations, the controller can control, in the second operating mode, the articulated arm to move the solar panel to a second mounting location in the environment different from the mounting location. In some implementations, the movable base includes a track to move the movable base along the row. In some implementations, in the first orientation, the solar panel extends along a first plane and in the second orientation, the solar panel extends along a second plane angled relative to the first plane. In some implementations, the gripper includes a plurality of suction cups configured to engage the first surface of the solar panel in response to the vacuum source being actuated. In some implementations, in response to actuating the vacuum source to decouple the gripper from the first surface and disposing the solar panel at the mounting location, the controller can control the articulated arm to move in a third direction transverse to the first direction and the second direction, and back towards the movable base along the second direction. In some implementations, the movable base is in an orientation extending along the first direction during coupling of the gripper to the solar panel and movement of the solar panel to the mounting location. In some implementations, the first surface of the solar panel is substantially perpendicular to the first direction.

At least one other aspect relates to a method for installing a solar panel in an environment using a robotic system including a movable base, an articulated arm, a gripper, a vacuum source, and a controller. The method can be performed, for example, by one or more processors coupled to non-transitory memory. The method can include navigating the movable base along a first direction of a row of the environment. The method can include controlling the articulated arm disposed on the movable base to move the gripper toward a first surface of the solar panel. The method can include actuating the vacuum source to couple the gripper to the first surface of the solar panel, the solar panel having a first orientation relative to a body of the movable base. The method can include controlling the articulated arm to move the solar panel to a mounting location in the environment at a second orientation relative to the body of the movable base, the articulated arm moving the solar panel in a second direction transverse to the first direction.

In some implementations, the first surface of the solar panel is an underside of the solar panel, and the solar panel is positioned above the gripper while the articulated arm moves the solar panel to the mounting location following coupling to the first surface. In some implementations, the first surface is a non-active surface of the solar panel. In some implementations, the solar panel is a first solar panel moved according to a first operating mode of the controller, the mounting location is a first mounting location, the row is a first row of the environment, and the gripper couples to the first surface at a first coupling location. In some implementations, the method can include determining, in a second operating mode while the movable base moves along a second direction opposite the first direction of a second row of the environment, a second coupling location on the solar panel different from the first coupling location. In some implementations, the method can include controlling, in the second operating mode, the articulated arm and the gripper to couple to the solar panel at the second coupling location. In some implementations, the method can include controlling, in the second operating mode, the articulated arm to move the solar panel to a second mounting location in the environment different from the mounting location. In some implementations, navigating the movable base includes moving the movable base along the row using a track. In some implementations, in the first orientation, the solar panel extends along a first plane and in the second orientation, the solar panel extends along a second plane angled relative to the first plane. In some implementations, coupling the gripper to the first surface includes actuating the vacuum source to draw suction through a plurality of suction cups of the gripper to engage the first surface of the solar panel. In some implementations, the method can include deactivating the vacuum source to decouple the gripper from the first surface after disposing the solar panel at the mounting location, and controlling the articulated arm to move in a third direction transverse to the first direction and the second direction, and then back toward the movable base along the second direction. In some implementations, the movable base is oriented to extend along the first direction during both coupling of the gripper to the solar panel and movement of the solar panel to the mounting location. In some implementations, the first surface of the solar panel is substantially perpendicular to the first direction.

At least one other aspect relates to a robotic system. The robotic system can include a movable base. The robotic system can include an articulated arm disposed on the movable base and including a gripper configured to couple to a solar panel. The robotic system can include a controller. The controller can determine a position of an electrical lead terminal coupled to the solar panel. The controller can select a coupling location on the solar panel and a mounting orientation for the solar panel based on the position of the electrical lead terminal. The controller can control the articulated arm and the gripper to move towards the coupling location on a first surface of the solar panel. The controller can cause the gripper to couple to the solar panel at the coupling location. The controller can control the articulated arm to move the solar panel to a mounting location on a torque tube in the mounting orientation. The controller can release the solar panel proximate to the mounting location on the torque tube.

In some implementations, the controller can select at least one of the coupling location on the solar panel or a movement trajectory of the articulated arm based at least in part on a travel direction of the movable base when approaching the solar panel. In some implementations, the controller can select at least one of the coupling location on the solar panel or the mounting orientation for the solar panel based at least in part on a direction at which the articulated arm moves the solar panel proximate to the mounting location on the torque tube. In some implementations, the electrical lead terminal includes a first electrical lead terminal and a second electrical lead terminal, the first electrical lead terminal and the second electrical lead terminal having predetermined locations on the solar panel, and determining the position of the electrical lead terminal includes determining a position of at least one of the first electrical lead terminal or the second electrical lead terminal relative to the gripper. In some implementations, the robotic system can include a vacuum source, and the controller can actuate the vacuum source to cause the gripper to couple to the solar panel at the coupling location. In some implementations, the gripper includes a plurality of suction cups configured to engage the first surface of the solar panel in response to the vacuum source being actuated. In some implementations, the vacuum source includes a plurality of vacuum sources, and a first subset of the plurality of suction cups is fluidly connected to a first vacuum source and a second subset of the plurality of suction cups is fluidly connected to a second vacuum source. In some implementations, the plurality of suction cups includes four suction cups arranged in a rectangular configuration. In some implementations, the controller can control the articulated arm to move the solar panel to the mounting location by positioning the electrical lead terminal such that, upon release of the solar panel, the electrical lead terminal is positioned proximate to a target connector coupled to the torque tube. In some implementations, the controller can select the mounting orientation based on a direction at which the torque tube extends along.

At least one other aspect relates to a method for installing a solar panel using a robotic system. The method can be performed, for example, by one or more processors coupled to non-transitory memory. The method can include determining a position of an electrical lead terminal coupled to the solar panel. The method can include selecting a coupling location on the solar panel and a mounting orientation for the solar panel based on the position of the electrical lead terminal. The method can include controlling an articulated arm disposed on a movable base to move a gripper of the robotic system toward the coupling location on a first surface of the solar panel. The method can include causing the gripper to couple to the solar panel at the coupling location. The method can include controlling the articulated arm to move the solar panel to a mounting location on a torque tube in the mounting orientation. The method can include releasing the solar panel proximate to the mounting location on the torque tube.

In some implementations, selecting the coupling location on the solar panel or selecting a movement trajectory of the articulated arm is based at least in part on a travel direction of the movable base when approaching the solar panel. In some implementations, selecting the coupling location on the solar panel or selecting the mounting orientation for the solar panel is based at least in part on a direction at which the articulated arm moves to release the solar panel proximate to the mounting location on the torque tube. In some implementations, the electrical lead terminal includes a first electrical lead terminal and a second electrical lead terminal having predetermined locations on the solar panel stored by the controller, and determining the position of the electrical lead terminal includes determining a position of at least one of the first electrical lead terminal or the second electrical lead terminal relative to the gripper. In some implementations, causing the gripper to couple to the solar panel at the coupling location includes actuating a vacuum source to couple the gripper to the solar panel. In some implementations, coupling the gripper to the solar panel includes engaging the first surface of the solar panel using a plurality of suction cups in response to the vacuum source being actuated. In some implementations, actuating the vacuum source includes actuating a plurality of vacuum sources such that a first subset of the plurality of suction cups is fluidly connected to a first vacuum source and a second subset of the plurality of suction cups is fluidly connected to a second vacuum source. In some implementations, the plurality of suction cups includes four suction cups arranged in a rectangular configuration. In some implementations, controlling the articulated arm to move the solar panel to the mounting location includes positioning the electrical lead terminal such that, upon release of the solar panel, the electrical lead terminal is positioned proximate to a target connector coupled to the torque tube. In some implementations, selecting the mounting orientation for the solar panel is based at least in part on a direction along which the torque tube extends.

At least one other aspect relates to a robotic system. The robotic system can include a movable base. The robotic system can include an articulated arm disposed on the movable base and including a gripper configured to couple to a solar panel. The robotic system can include a controller. The controller can identify a first mounting location of a first solar panel on a torque tube. The controller can obtain image data depicting an environment including the torque tube. The controller can determine, based on the image data and the first mounting location, a second mounting location for a second solar panel, the second mounting location proximate to the first mounting location. The controller can control the articulated arm to move the second solar panel towards the second mounting location on the torque tube proximate to the first solar panel.

In some implementations, the controller can, prior to identifying the first mounting location, control the articulated arm to move the first solar panel to the first mounting location on the torque tube at a first mounting orientation. In some implementations, the controller can control the articulated arm to couple the gripper to the second solar panel prior to moving the second solar panel toward the second mounting location, and the gripper couples to the second solar panel via a vacuum source. In some implementations, the gripper includes a plurality of suction cups configured to engage the second solar panel in response to the vacuum source being actuated. In some implementations, the vacuum source includes a plurality of vacuum sources, and a first subset of the plurality of suction cups is fluidly connected to a first vacuum source and a second subset of the plurality of suction cups is fluidly connected to a second vacuum source. In some implementations, the controller can determine that the second solar panel is within a first threshold distance of the second mounting location based on the image data, and release the second solar panel in response to determining that the second solar panel is within the first threshold distance of the second mounting location. In some implementations, controlling the articulated arm to move the second solar panel toward the second mounting location includes adjusting a position of the movable base while the second solar panel is coupled to the gripper. In some implementations, the controller can control the movable base to move toward the torque tube while the second solar panel is coupled to the gripper, and control the articulated arm to move the second solar panel toward the second mounting location in response to the movable base being within a second threshold distance of the torque tube. In some implementations, the robotic system can include a user interface, and the controller can cause the user interface to display one or more graphical indicators representing at least one of the first mounting location, the second mounting location, a distance between the movable base and the torque tube, or a distance between the second solar panel and the second mounting location. In some implementations, the robotic system can include a first set of cameras coupled to the articulated arm and a second set of cameras coupled to the movable base, the controller configured to obtain the image data from at least one of the first set of cameras or the second set of cameras.

At least one other aspect relates to a method for installing solar panels using a robotic system. The method can be performed, for example, by one or more processors coupled to non-transitory memory. The method can include identifying a first mounting location of a first solar panel on a torque tube. The method can include obtaining image data depicting an environment including the torque tube. The method can include determining, based on the image data and the first mounting location, a second mounting location for a second solar panel, the second mounting location being proximate to the first mounting location. The method can include controlling an articulated arm disposed on a movable base of the robotic system to move the second solar panel toward the second mounting location on the torque tube proximate to the first mounting location.

In some implementations, the method can include, prior to identifying the first mounting location, controlling the articulated arm to move the first solar panel to the first mounting location on the torque tube at a first mounting orientation. In some implementations, the method can include controlling the articulated arm to couple a gripper to the second solar panel prior to moving the second solar panel toward the second mounting location, and the gripper couples to the second solar panel via a vacuum source. In some implementations, coupling the gripper to the second solar panel includes actuating the vacuum source to engage the second solar panel using a plurality of suction cups. In some implementations, actuating the vacuum source includes actuating a plurality of vacuum sources such that a first subset of the plurality of suction cups is fluidly connected to a first vacuum source and a second subset of the plurality of suction cups is fluidly connected to a second vacuum source. In some implementations, the method can include determining, based on the image data, that the second solar panel is within a threshold distance of the second mounting location, and releasing the second solar panel in response to determining that the second solar panel is within the threshold distance of the second mounting location.

In some implementations, controlling the articulated arm to move the second solar panel toward the second mounting location includes adjusting a position of the movable base while the second solar panel is coupled to a gripper of the articulated arm. In some implementations, the method can include controlling the movable base to move toward the torque tube while the second solar panel is coupled to the gripper, and controlling the articulated arm to move the second solar panel toward the second mounting location in response to the movable base being within a second threshold distance of the torque tube. In some implementations, the method can include causing a user interface to display one or more graphical indicators representing at least one of the first mounting location, the second mounting location, a distance between the movable base and the torque tube, or a distance between the second solar panel and the second mounting location. In some implementations, obtaining the image data includes obtaining image data from at least one of a first set of cameras coupled to the articulated arm or a second set of cameras coupled to the movable base.

At least one other aspect relates to a robotic system. The robotic system can include a movable base coupled with a first image sensor. The robotic system can include an articulated arm disposed on the movable base coupled with a second image sensor. The robotic system can include a first marker positioned on the articulated arm. The robotic system can include a controller. The controller can cause the articulated arm to move to a first pose, such that the first marker enters a field of view of the first image sensor. The controller can capture a first image using the first image sensor while the articulated arm is in the first pose. The controller can cause the articulated arm to move to a second pose, such that the first marker enters the field of view of the first image sensor. The controller can capture a second image using the first image sensor while the articulated arm is in the second pose. The controller can determine first pixel coordinates of the first marker depicted in the first image and second pixel coordinates of the first marker depicted in the second image. The controller can update a calibration data structure for the first image sensor based on the first pixel coordinates, the second pixel coordinates, the first pose, and the second pose.

In some implementations, at least one of a pose or position of the first image sensor is fixed relative to the movable base and at least one of a pose or position of the second image sensor is fixed relative to the articulated arm. In some implementations, the articulated arm includes a proximal portion coupled to the movable base and a distal portion opposite the proximal portion, the second image sensor coupled to the articulated arm proximate to the distal portion. In some implementations, the first marker is positioned proximate to the distal portion of the articulated arm. In some implementations, the robotic system can include a second marker positioned on the movable base. In some implementations, the second marker is positioned such that the second marker is outside a field of view of the second image sensor during at least the first pose and the second pose. In some implementations, the controller can cause the articulated arm to move to a third pose such that the second marker enters a field of view of the second image sensor, capture a third image using the second image sensor while the articulated arm is in the third pose, cause the articulated arm to move to a fourth pose such that the second marker enters the field of view of the second image sensor, capture a fourth image using the second image sensor while the articulated arm is in the fourth pose, determine third pixel coordinates of the second marker depicted in the third image and fourth pixel coordinates of the second marker depicted in the fourth image, and update a calibration data structure for the second image sensor based on the third pixel coordinates, the fourth pixel coordinates, the third pose, and the fourth pose. In some implementations, the controller can select the first pose and the second pose such that the first marker is depicted in images captured by the first image sensor and is not depicted in images captured by the second image sensor. In some implementations, the robotic system can include a user interface, and the controller can receive, via the user interface, a selection of at least one of the first image sensor or the second image sensor for calibration. In some implementations, the robotic system can include a second marker positioned on the movable base, and in response to receiving the selection of both the first image sensor and the second image sensor for calibration, the controller can select the first pose and the second pose that allows the first marker to enter the field of view of the first image sensor and the second marker to enter the field of view of the second image sensor simultaneously such that the first image and the second image include the first marker and the second marker, and update the calibration data structure for the first image sensor and the second image sensor based at least on the first pose and the second pose.

At least one other aspect relates to a method for calibrating image sensors of a robotic system. The method can be performed, for example, by one or more processors coupled to non-transitory memory. The method can include causing an articulated arm disposed on a movable base of the robotic system to move to a first pose such that a first marker positioned on the articulated arm enters a field of view of a first image sensor coupled to the movable base. The method can include capturing a first image using the first image sensor while the articulated arm is in the first pose. The method can include causing the articulated arm to move to a second pose such that the first marker enters the field of view of the first image sensor. The method can include capturing a second image using the first image sensor while the articulated arm is in the second pose. The method can include determining first pixel coordinates of the first marker depicted in the first image and second pixel coordinates of the first marker depicted in the second image. The method can include updating a calibration data structure for the first image sensor based on the first pixel coordinates, the second pixel coordinates, the first pose, and the second pose.

In some implementations, at least one of a position or a pose of the first image sensor is fixed relative to the movable base and at least one of a position or a pose of a second image sensor is fixed relative to the articulated arm. In some implementations, the articulated arm includes a proximal portion coupled to the movable base and a distal portion opposite the proximal portion, and a second image sensor is coupled to the distal portion of the articulated arm. In some implementations, the first marker is positioned proximate to the distal portion of the articulated arm. In some implementations, a second marker is positioned on the movable base and a second image sensor is coupled with the articulated arm. In some implementations, the second marker is positioned such that the second marker is outside a field of view of the second image sensor during at least the first pose and the second pose. In some implementations, the method can include causing the articulated arm to move to a third pose such that the second marker enters a field of view of the second image sensor, capturing a third image using the second image sensor while the articulated arm is in the third pose, causing the articulated arm to move to a fourth pose such that the second marker enters the field of view of the second image sensor, capturing a fourth image using the second image sensor while the articulated arm is in the fourth pose, determining third pixel coordinates of the second marker depicted in the third image and fourth pixel coordinates of the second marker depicted in the fourth image, and updating a calibration data structure for the second image sensor based on the third pixel coordinates, the fourth pixel coordinates, the third pose, and the fourth pose. In some implementations, the method can include receiving, via a user interface, a selection of at least one of the first image sensor or a second image sensor for calibration. In some implementations, the method can include positioning a second marker on the movable base, and in response to receiving a selection of both the first image sensor and the second image sensor for calibration, selecting the first pose and the second pose such that the first marker enters the field of view of the first image sensor and the second marker enters the field of view of the second image sensor simultaneously, such that the first image and the second image each depict the first marker and the second marker, and updating the calibration data structure for the first image sensor and the second image sensor based at least on the first pose and the second pose.

At least one other aspect relates to a robotic system. The robotic system can include a movable base. The robotic system can include an articulated arm disposed on the movable base coupled with an image sensor. The robotic system can include a first marker positioned on the movable base. The robotic system can include a controller. The controller can cause the articulated arm to move to a first pose, such that the first marker enters a field of view of the image sensor. The controller can capture a first image using the image sensor while the articulated arm is in the first pose. The controller can cause the articulated arm to move to a second pose, such that the first marker enters the field of view of the image sensor. The controller can capture a second image using the image sensor while the articulated arm is in the second pose. The controller can determine first pixel coordinates of the first marker depicted in the first image and second pixel coordinates of the first marker depicted in the second image. The controller can update a calibration data structure for the image sensor based on the first pixel coordinates, the second pixel coordinates, the first pose, and the second pose.

At least one other aspect relates to a robotic system. The robotic system can include a movable base coupled with a first image sensor. The robotic system can include an articulated arm disposed on the movable base, the articulated arm including a gripper and coupled with a second image sensor. The robotic system can include a controller. The controller can control the articulated arm and the gripper to couple with a first surface of a solar panel. The controller can control the articulated arm to move the solar panel to a mounting location. The controller can obtain, during movement of the solar panel, image data from the first image sensor or the second image sensor. The controller can determine, based on the image data, that a movement termination condition is satisfied. The controller can restrict movement of the articulated arm and the movable base in response to determining that the movement termination condition is satisfied.

In some implementations, the articulated arm includes a proximal portion coupled to the movable base and a distal portion opposite the proximal portion, the second image sensor coupled to the distal portion. In some implementations, the controller can control the articulated arm to move the solar panel to the mounting location by executing a movement routine including a sequence of articulated arm motions, and the controller can restrict movement by terminating the movement routine in response to determining that the movement termination condition is satisfied. In some implementations, the controller can determine that the movement termination condition is satisfied by detecting, based on the image data, an object within a predetermined zone associated with the articulated arm or the movable base. In some implementations, the controller can select the predetermined zone from a plurality of predetermined zones based at least in part on whether the gripper is coupled to the solar panel. In some implementations, the plurality of predetermined zones includes a first zone corresponding to the gripper not being coupled to the solar panel and a second zone corresponding to the gripper being coupled to the solar panel, the first zone being different from the second zone. In some implementations, a dimension of the second zone is greater than a dimension of the first zone. In some implementations, the controller can operate in a first mode in which the gripper is coupled with the solar panel and the movement termination condition corresponds to a first movement termination condition, or a second mode subsequent to releasing the solar panel from the gripper and the movement termination condition corresponds to a second movement termination condition, the second movement termination condition different from the first movement termination condition. In some implementations, the first movement termination condition corresponds to a first zone and the second movement termination condition corresponds to a second zone, a dimension of the second zone being greater than a dimension of the first zone. In some implementations, the robotic system can include a second controller associated with the articulated arm, and restricting movement includes transmitting a restriction signal to the second controller to cause the second controller to inhibit motion of the articulated arm.

At least one other aspect relates to a method. The method can be performed, for example, by one or more processors coupled to non-transitory memory. The method can include controlling an articulated arm and a gripper to couple with a first surface of a solar panel, the articulated arm disposed on a movable base coupled with a first image sensor, the articulated arm coupled with a second image sensor. The method can include controlling the articulated arm to move the solar panel to a mounting location. The method can include obtaining, during movement of the solar panel, image data from the first image sensor or the second image sensor. The method can include determining, based on the image data, that a movement termination condition is satisfied. The method can include restricting movement of the articulated arm and the movable base in response to determining that the movement termination condition is satisfied.

In some implementations, the articulated arm includes a proximal portion coupled to the movable base and a distal portion opposite the proximal portion, and the second image sensor is coupled to the distal portion. In some implementations, controlling the articulated arm to move the solar panel to the mounting location includes executing a movement routine including a sequence of articulated arm motions, and restricting movement includes terminating the movement routine in response to determining that the movement termination condition is satisfied. In some implementations, determining that the movement termination condition is satisfied includes detecting, based on the image data, an object within a predetermined zone associated with the articulated arm or the movable base. In some implementations, the method can include selecting the predetermined zone from a plurality of predetermined zones based at least in part on whether the gripper is coupled to the solar panel. In some implementations, the plurality of predetermined zones includes a first zone corresponding to the gripper not being coupled to the solar panel and a second zone corresponding to the gripper being coupled to the solar panel, the first zone being different from the second zone. In some implementations, a dimension of the second zone is greater than a dimension of the first zone. In some implementations, the method can include operating in a first mode in which the gripper is coupled with the solar panel and the movement termination condition corresponds to a first movement termination condition, or a second mode subsequent to releasing the solar panel from the gripper and the movement termination condition corresponds to a second movement termination condition, the second movement termination condition different from the first movement termination condition. In some implementations, the first movement termination condition corresponds to a first zone and the second movement termination condition corresponds to a second zone, a dimension of the second zone greater than a dimension of the first zone. In some implementations, the robotic system includes a second controller associated with the articulated arm, and restricting movement includes transmitting a restriction signal to the second controller to cause the second controller to inhibit motion of the articulated arm.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (e.g., computer-readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a schematic of an example robotic system, according to aspects of the present disclosure.

FIG. 2 illustrates another schematic of the robotic system of FIG. 1, according to aspects of the present disclosure.

FIG. 3 illustrates an exploded view of the robotic system of FIG. 1, according to aspects of the present disclosure.

FIG. 4A illustrates an isometric view of a gripper assembly, according to aspects of the present disclosure.

FIG. 4B illustrates an orthogonal view of the gripper assembly, according to aspects of the present disclosure.

FIG. 4C illustrates another orthogonal view of the gripper assembly, according to aspects of the present disclosure.

FIG. 4D illustrates an orthogonal top view of the gripper assembly, according to aspects of the present disclosure.

FIG. 4E illustrates an orthogonal side view of the gripper assembly, according to aspects of the present disclosure.

FIG. 4F illustrates an orthogonal side view of the gripper assembly, according to aspects of the present disclosure.

FIG. 4G illustrates an isometric view of the gripper assembly, according to aspects of the present disclosure.

FIG. 5A illustrates a top perspective view of a gripper assembly with a carbon fiber frame, according to aspects of the present disclosure.

FIG. 5B illustrates a bottom perspective view of the gripper assembly of FIG. 5A, according to aspects of the present disclosure.

FIG. 5C illustrates a top orthogonal view of the gripper assembly, according to aspects of the present disclosure.

FIG. 5D illustrates a bottom orthogonal view of the gripper assembly in a diamond configuration, according to aspects of the present disclosure.

FIG. 5E illustrates an orthogonal side view of the gripper assembly, according to aspects of the present disclosure.

FIG. 5F illustrates an isometric view of the gripper assembly, according to aspects of the present disclosure.

FIG. 6A illustrates an isometric view of a rotational actuation assembly, according to aspects of the present disclosure.

FIG. 6B illustrates an orthogonal side view of the rotational actuation assembly, according to aspects of the present disclosure.

FIG. 6C illustrates another orthogonal side view of the rotational actuation assembly, according to aspects of the present disclosure.

FIG. 6D illustrates an orthogonal side view of the rotational actuation assembly, according to aspects of the present disclosure.

FIG. 6E illustrates an orthogonal side view of the rotational actuation assembly, according to aspects of the present disclosure.

FIG. 6F illustrates an isometric view of the rotational actuation assembly, according to aspects of the present disclosure.

FIGS. 7, 8, and 9 illustrate various views of a gripper assembly attached to an articulated arm, according to aspects of the present disclosure.

FIG. 10 illustrates a top view of a gripper assembly attached to an articulated arm, according to aspects of the present disclosure.

FIGS. 11A and 11B are perspective views of a gripper assembly, according to aspects of the present disclosure.

FIGS. 12A, 12B, 13A, and 13B, illustrate orthogonal side views of the gripper assembly, according to aspects of the present disclosure.

FIGS. 14A and 14B illustrate top views of the gripper assembly, according to aspects of the present disclosure.

FIGS. 15A and 15B illustrate other views of a gripper assembly attached to an articulated arm, according to aspects of the present disclosure.

FIG. 16 illustrates a view of a panel held by a gripper assembly, according to aspects of the present disclosure.

FIG. 17 illustrates a view of a gripper assembly, according to aspects of the present disclosure.

FIG. 18 illustrates a schematic of an example environment of an example robotic system, according to aspects of the present disclosure.

FIG. 19 illustrates a perspective view of an example robotic system coupling to an example solar panel, according to aspects of the present disclosure.

FIG. 20 illustrates a perspective view of an example robotic system moving an example solar panel, according to aspects of the present disclosure.

FIG. 21 illustrates a perspective view of a surface of an example solar panel, according to aspects of the present disclosure.

FIG. 22 illustrates a perspective view of another surface of an example solar panel, according to aspects of the present disclosure.

FIG. 23 illustrates a schematic of example orientations of an example solar panel, according to aspects of the present disclosure.

FIG. 24 illustrates a flow diagram of an example process of detecting an example solar panel, according to aspects of the present disclosure.

FIG. 25 illustrates a flow diagram of an example process of determining a mounting location, according to aspects of the present disclosure.

FIG. 26 illustrates a flow diagram of an example process for mounting a solar panel, according to aspects of the present disclosure.

FIG. 27 illustrates a flow diagram of an example process for a trajectory of mounting a solar panel, according to aspects of the present disclosure.

FIG. 28 illustrates a flow diagram of an example method for mounting a solar panel, according to aspects of the present disclosure.

FIG. 29 illustrates a flow diagram of an example method for mounting a solar panel, according to aspects of the present disclosure.

FIG. 30 illustrates a flow diagram of an example method for mounting a solar panel, according to aspects of the present disclosure.

FIG. 31 illustrates a perspective view of an example robotic system including markers, according to aspects of the present disclosure.

FIG. 32 illustrates another perspective view of the robotic system of FIG. 31, according to aspects of the present disclosure.

FIG. 33 illustrates a flow diagram of an example method for calibrating image sensors of an example robotic system, according to aspects of the present disclosure.

FIG. 34 illustrates a schematic for a first mode of an example robotic system, according to aspects of the present disclosure.

FIG. 35 illustrates a schematic for a second mode of an example robotic system, according to aspects of the present disclosure.

FIG. 36 illustrates a flow diagram of an example method for restricting movement of an example robotic system, according to aspects of the present disclosure.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Solar panel installation environments can include rows of racking infrastructure, such as torque tubes with hat rails, onto which solar panels are mounted across large areas of terrain. Installing solar panels on racking infrastructure can involve transporting each panel from a staging location to a mounting location and positioning the panel in a particular orientation relative to the racking infrastructure. However, some robotic approaches to solar panel installation can present challenges such as requiring a robot to turn or reorient at each panel placement, which can increase cycle time and reduce throughput. Additionally, some approaches may lack the ability to determine the position of electrical lead terminals on a solar panel prior to gripping, which can result in panels being placed with incorrect electrical polarity orientation and can complicate subsequent wiring operations. Determining a mounting location for a next solar panel on a torque tube can also be difficult when the robotic system lacks information about the position of a previously placed panel or when camera conditions vary due to environmental factors such as sun angle. Some safety systems may also fail to account for the varying risk profiles that arise when the gripper is holding a panel versus when the gripper has released the panel, which can result in either overly conservative safety zones that reduce operational throughput or insufficiently conservative safety zones that increase risk to nearby personnel. Camera calibration in mobile robotic systems can also degrade over time due to vibrations and environmental exposure, and some calibration approaches may not leverage the precise pose information available from the articulated arm to recalibrate cameras in the field without external calibration fixtures.

The systems and methods described herein provide robotic systems and methods for installing solar panels in solar farm environments that address the above-mentioned challenges, among others. The systems and methods described herein can provide a row-native installation approach in which the movable base travels along a first direction through a row of the environment and remains oriented along the first direction during panel placement, such that the movable base does not turn left or right. The articulated arm can extend forward to engage a staged panel from an underside surface and can move the panel laterally in a second direction transverse to the first direction to a mounting location. The systems and methods described herein can further provide electrical lead-oriented gripping and placement, in which a controller determines the position of an electrical lead terminal on the solar panel and selects a coupling location and a mounting orientation based on the determined position, a travel direction of the movable base, and a deployment side of the articulated arm. The systems and methods described herein can also provide camera-based placement determination using a previously placed panel as a reference anchor, redundant multi-path vacuum control with fail-safe persistence, mode-dependent camera-based safety restriction, and camera calibration using markers on the articulated arm and the movable base in conjunction with known arm poses.

To implement the systems and methods described herein, the controller can coordinate pick-and-place operations across multiple phases. During a pick phase, the controller can cause the articulated arm to extend forward from the movable base and move the gripper toward an underside surface of a staged solar panel. The controller can actuate a vacuum source to couple the gripper to the panel while the panel is in a first orientation relative to the movable base. During a placement phase, the controller can command the articulated arm to rotate and translate the panel laterally to a mounting location on a torque tube, such that the panel arrives at the mounting location in a second orientation different from the first orientation. The controller can determine the position of electrical lead terminals using camera imagery and can select from predetermined rotation paths, such as clockwise or counterclockwise paths, based on the terminal position, the travel direction, and the deployment side. For placement determination, the controller can identify a first mounting location of a previously placed panel and can obtain image data from arm cameras or chassis cameras to determine a second mounting location for a next panel. The controller can select which camera to use based on viewing conditions affecting a given camera. The controller can withhold a release operation until the movable base is within a threshold distance of the torque tube.

For safety, the controller can obtain image data during panel movement and can determine whether a movement termination condition is satisfied by detecting an object within a predetermined zone. The controller can restrict movement of the articulated arm and the movable base in response to detecting the object. The controller can select from a plurality of predetermined zones based on whether the gripper is coupled to the solar panel. For camera calibration, the controller can cause the articulated arm to move to multiple poses such that a marker on the arm enters the field of view of a chassis camera. The controller can update a calibration data structure based on marker pixel coordinates and known arm poses.

By maintaining the orientation of the movable base along the travel direction throughout pick-and-place operations, the systems and methods described herein can reduce cycle time relative to approaches that require the movable base to reorient for each panel placement. By determining the position of electrical lead terminals and selecting coupling locations and mounting orientations based on the determined position, the systems and methods described herein can provide consistent electrical polarity orientation across panels along a row, which can simplify subsequent wiring operations. By using a previously placed panel as a reference anchor for determining the mounting location of a next panel, the systems and methods described herein can maintain placement accuracy without relying on absolute positioning information. The mode-dependent safety zones, in which a larger zone is applied after panel release and a smaller zone is applied while the panel is coupled to the gripper, can provide a safety restriction approach that accounts for the different risk profiles of the two operating states. The camera calibration approach using arm-mounted and base-mounted markers with known arm poses can allow field recalibration without external fixtures, which can address calibration degradation due to vibrations and environmental exposure during operation at solar installation sites.

### A.Overview of Robotic System

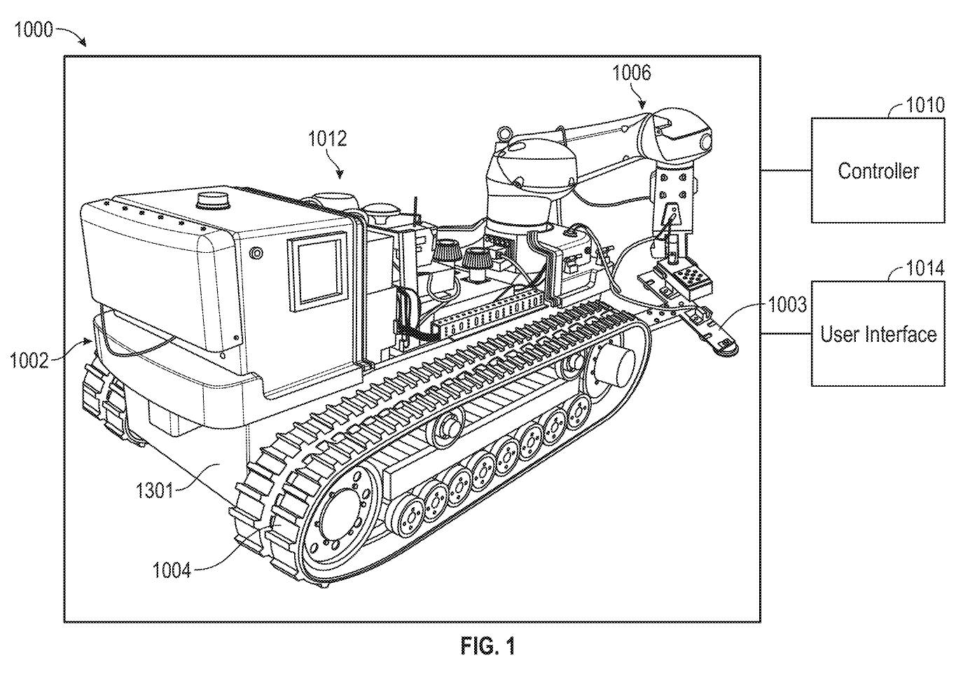

Referring now to FIG. 1, illustrated is a perspective view of a robotic system 1000 (e.g., a robotic installation platform, tracked robot, etc.), in accordance with one or more implementations. The robotic system 1000 can include at least one of: a movable base 1002 (e.g., a tracked vehicle, mobile platform, etc.), an articulated arm 1006 (e.g., a multi-joint robotic arm, manipulator, etc.) disposed on the movable base 1002, a gripper assembly 1003 (e.g., an end effector, suction gripper, vacuum gripper, etc.) coupled to a distal end of the articulated arm 1006, a controller 1010, a vacuum source 1012 (e.g., one or more vacuum pumps, vacuum generators, negative pressure sources, diaphragm pumps, pneumatic suction sources, etc.), or a user interface 1014 (e.g., a display, remote controller, tablet, handheld terminal, operator interface device, etc.). The robotic system 1000 can be used in solar panel installation environments to perform pick-and-place operations in which solar panels (e.g., solar panel 1804) are transported from a staging location to a mounting location on racking infrastructure such as torque tubes with hat rails. The robotic system 1000 can travel along rows of the installation environment, pick up solar panels using vacuum-actuated suction, and place the solar panels onto the racking infrastructure using coordinated movements of the articulated arm 1006 and the gripper assembly 1003.

The movable base 1002 can be a tracked vehicle that provides a mobile platform for the articulated arm 1006, the gripper assembly 1003, the controller 1010, the vacuum source 1012, and other onboard subsystems of the robotic system 1000. As shown in FIG. 1, the movable base 1002 can include a pair of tracks 1004 (e.g., one or more continuous belts, treads, crawlers, track assemblies such as rubber tracks, composite tracks, steel-body tracks, etc.) disposed on opposing lateral sides of a chassis (e.g., chassis 1301, etc.) of the movable base 1002. Each of the tracks 1004 can extend along a longitudinal axis of the movable base 1002 and can engage the ground surface beneath the movable base 1002 to propel the movable base 1002 in a travel direction. The tracks 1004 can provide stability on uneven terrain that can be encountered at solar construction sites, such as graded earth, gravel, or compacted soil. In some implementations, the tracks 1004 can be formed from a flexible composite material with steel bodies. The tracked drivetrain of the movable base 1002 can distribute the weight of the robotic system 1000 across a contact area defined by the footprint of the pair of tracks 1004. In some implementations, the contact area can be in a range of about 1.5 square meters to about 4.0 square meters, such as about 2.5 square meters to about 3.5 square meters. The distribution of the weight of the robotic system 1000 across this contact area can reduce the ground pressure exerted by the robotic system 1000 on the terrain surface.

The articulated arm 1006 can be disposed on the movable base 1002 and can carry the gripper assembly 1003 at a distal end of the articulated arm 1006. The articulated arm 1006 can be a multi-joint robotic arm that provides multiple degrees of freedom for positioning the gripper assembly 1003 in three-dimensional space relative to the movable base 1002. In some implementations, the articulated arm 1006 can provide six degrees of freedom through six rotational joints arranged in a serial kinematic chain. In some implementations, a seventh degree of freedom can be provided by a rotational actuator (e.g., actuator 114, etc.) interposed between an end effector flange of the articulated arm 1006 and the gripper assembly 1003. The articulated arm 1006 can be mounted toward a front portion of a chassis 1301 of the movable base 1002, which can position the articulated arm 1006 to reach forward and engage solar panels that are staged ahead of the robotic system 1000 in the travel direction. In some implementations, the articulated arm 1006 can include an arm controller that receives control signals from the controller 1010 and that generates joint-level motor commands to position the articulated arm 1006 at commanded poses. The articulated arm 1006 can provide the reach and payload capacity to pick up solar panels from a staging location, transport the solar panels across the lateral span of the movable base 1002, and lower the solar panels onto racking infrastructure at a mounting location.

The gripper assembly 1003 can include a support beam (e.g., support beam 106, etc.) carrying a plurality of suction cups (e.g., suction cups 108, etc.) arranged to engage a surface of a solar panel. The suction cups can be fluidly coupled to the vacuum source 1012 housed on the movable base 1002 through vacuum lines routed through or alongside the articulated arm 1006. When the vacuum source 1012 is activated, negative pressure can be supplied to the suction cups, which can draw the suction cups against the surface of the solar panel and couple the gripper assembly 1003 to the solar panel. The gripper assembly 1003 can include a rotational actuator that provides an additional rotational degree of freedom beyond the joints of the articulated arm 1006, as described herein. The gripper assembly 1003 can engage the underside or non-active surface (e.g., first surface 1902, etc.) of the solar panel during transport from the staging location to the mounting location.

The controller 1010 can be communicatively coupled with and can coordinate operation of the articulated arm 1006, the gripper assembly 1003, the vacuum source 1012, and the movable base 1002 during pick-and-place operations. In some implementations, the controller 1010 is disposed in or otherwise coupled to the movable base 1002. The controller 1010 can include one or more processors, one or more memory devices, and communications interfaces for transmitting and receiving control signals. The controller 1010 can transmit a first control signal to an arm controller of the articulated arm 1006 to position the gripper assembly 1003 adjacent to a solar panel. The controller 1010 can transmit a second control signal to activate the vacuum source 1012 to couple the suction cups of the gripper assembly 1003 to the solar panel. The controller 1010 can transmit additional control signals to coordinate movement of the articulated arm 1006 and rotation of the gripper assembly 1003 to transport the solar panel to a mounting location and to orient the solar panel in a mounting orientation. The controller 1010 can receive input from the user interface 1014 and can generate commands in response to the received input. In some implementations, the controller 1010 can receive input from one or more cameras coupled to the articulated arm 1006 and/or to the movable base 1002 and can use image data from the cameras to determine panel positions, mounting locations, electrical lead terminal positions, and safety conditions, as described herein.

The vacuum source 1012 can be housed on the movable base 1002 and can generate negative pressure for coupling the suction cups of the gripper assembly 1003 to a solar panel. In some implementations, the vacuum source 1012 can include one or more vacuum pumps, such as diaphragm pumps, piston pumps, or rotary vane pumps. In some implementations, the vacuum source 1012 can include two or more vacuum sources that are fluidly coupled to respective subsets of the suction cups of the gripper assembly 1003 through separate vacuum lines, as described herein. Each vacuum source can be individually sufficient to maintain coupling of the solar panel to the gripper assembly 1003 via its respective subset of suction cups, independent of the other vacuum source. The vacuum source 1012 can be fluidly coupled to the suction cups through vacuum lines that are routed through or alongside the articulated arm 1006 from the movable base 1002 to the gripper assembly 1003. A positive pressure source, such as a compressed air source, can also be housed on the movable base 1002 and can be fluidly coupled to the suction cups through the same fluid lines used for vacuum. The positive pressure source can be activated during a release sequence to blow compressed air through the suction cups and break residual stiction between the suction cups and the panel surface.

The user interface 1014 can provide an interface through which an operator can interact with the robotic system 1000. The user interface 1014 can be communicatively coupled with the controller 1010, and can provide inputs from the operator to the controller 1010. In some implementations, the user interface 1014 can be a remote controller, a tablet, a display, or a handheld device that communicates with the controller 1010 via a wired or wireless connection. The user interface 1014 can display image data from cameras of the robotic system 1000, status information about the articulated arm 1006 and the vacuum source 1012, and graphical indicators representing panel positions, mounting locations, distances, and alignment information. The user interface 1014 can receive operator inputs such as commands to initiate a pick operation, a place operation, a release operation, or a navigation command. In some implementations, the user interface 1014 can display visual cues such as red, yellow, and green color coding to indicate proximity and alignment of a solar panel to a target placement position, as described herein. In some implementations, the user interface 1014 can receive a selection of one or more cameras for calibration, as described herein.

In some implementations, the robotic system 1000 can include one or more image sensors (e.g., cameras, sensors, etc.) coupled to the movable base 1002 and/or to the articulated arm 1006. The image sensors can capture image data of the installation environment, including the staged solar panels, the torque tubes, previously placed solar panels, and objects in the vicinity of the robotic system 1000. The controller 1010 can receive the image data from the image sensors and can use the image data to determine panel positions, mounting locations, electrical lead terminal positions, viewing conditions, and safety conditions, as described herein. The image sensors coupled to the movable base 1002 can have a pose that is fixed relative to the movable base 1002, and the image sensors coupled to the articulated arm 1006 can have a pose that moves with the articulated arm 1006 as the articulated arm 1006 changes position. The controller 1010 can select which image sensor to use based on viewing conditions affecting one or more of the image sensors, such as sun angle or glare that may degrade the image quality from a particular image sensor at a given time of day.

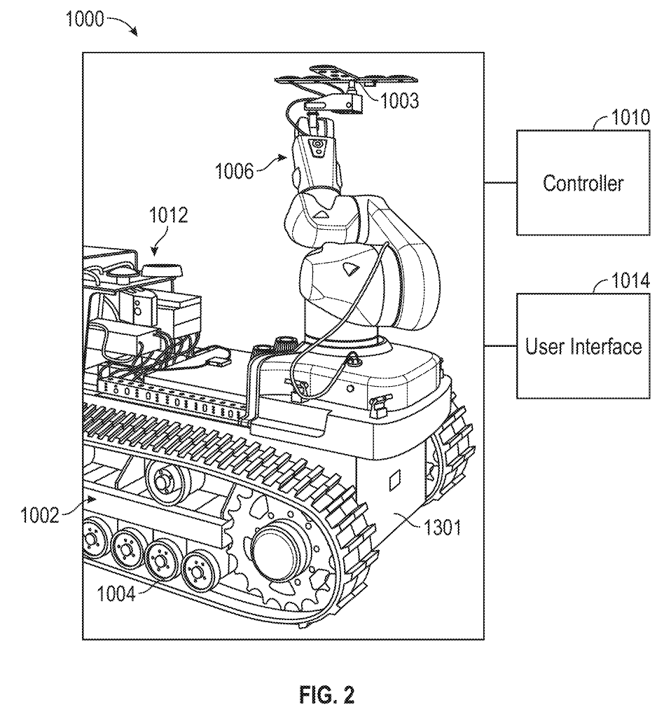

Referring now to FIG. 2, illustrated is a perspective view of the robotic system 1000 including the movable base 1002 and the articulated arm 1006 coupled with the gripper assembly 1003, in accordance with one or more implementations. As shown in FIG. 2, the articulated arm 1006 can be positioned in a configuration in which the gripper assembly 1003 is elevated above the movable base 1002 and oriented in a raised position.

The articulated arm 1006 in FIG. 2 can be shown in a configuration in which multiple joints of the articulated arm 1006 are articulated to position the gripper assembly 1003 at an elevated position relative to the movable base 1002. This configuration can correspond to a transport pose or a placement pose in which the articulated arm 1006 carries a solar panel laterally from the movable base 1002 toward a mounting location on a torque tube. The gripper assembly 1003 can be visible at the distal end of the articulated arm 1006 and can include the frame structure and the plurality of suction cups described herein. The user interface 1014 can be depicted adjacent to the robotic system 1000 and can communicate with the controller 1010 to receive operator inputs and to display status information during the pick-and-place operation.

FIG. 2 can illustrate the relationship between the articulated arm 1006 and the movable base 1002 during a phase of a pick-and-place cycle in which the articulated arm 1006 is extended upward and to one side of the movable base 1002. The articulated arm 1006 can include multiple links connected by rotational joints, and each joint can be actuated by a respective motor that receives commands from the arm controller in response to control signals from the controller 1010. The articulated arm 1006 can position the gripper assembly 1003 at a range of positions and orientations relative to the movable base 1002, including positions that are forward of the movable base 1002 for panel pickup, positions that are lateral to the movable base 1002 for panel transport, and positions that are above the movable base 1002 for panel placement onto a torque tube. The multiple degrees of freedom of the articulated arm 1006, combined with the additional rotational degree of freedom provided by the rotational actuator of the gripper assembly 1003, can provide the robotic system 1000 with the kinematic capability to pick up a solar panel from a staged orientation and to transport and rotate the solar panel into a mounting orientation without reorienting the movable base 1002.

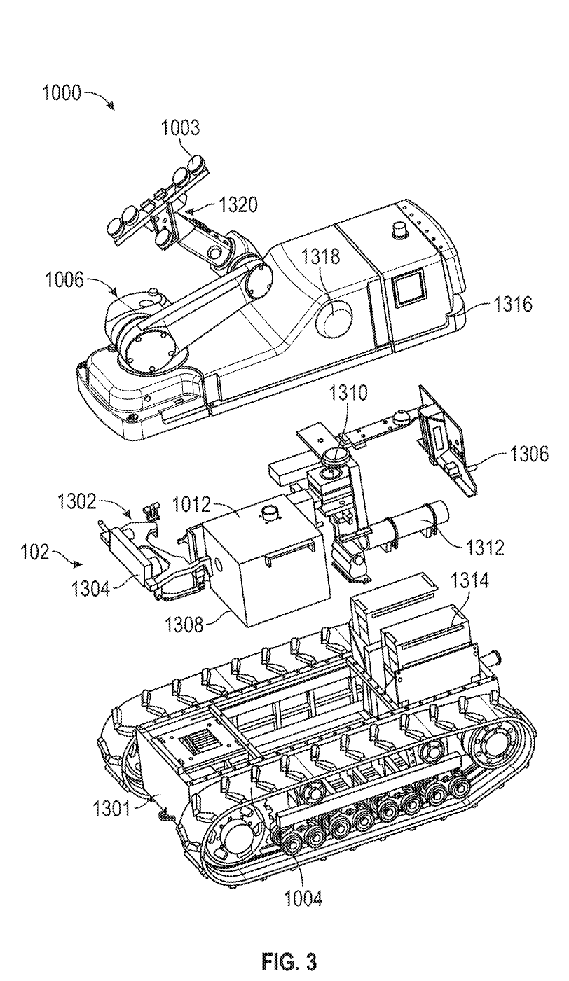

Referring now to FIG. 3, illustrated is an exploded perspective view of the robotic system 1000 showing the movable base 1002, onboard subsystems, the articulated arm 1006, and the gripper assembly 1003, in accordance with one or more implementations. FIG. 3 can depict the robotic system 1000 with the subsystems separated from the chassis 1301 of the movable base 1002 to illustrate the arrangement and positioning of each subsystem within the robotic system 1000. As shown in FIG. 3, the robotic system 1000 can include the gripper assembly 1003, the articulated arm 1006, the controller 1010, the vacuum source 1012, one or more image sensors 1302 (e.g., one or more cameras, image sensors, RGB-D sensors, depth cameras, optical detectors, etc.) coupled to the movable base 1002, one or more image sensors 1320 (e.g., one or more cameras, image sensors, RGB-D sensors, depth cameras, optical detectors, etc.) coupled to the articulated arm 1006 proximate to the gripper assembly 1003, an electrical enclosure 1304 (e.g., a sealed cabinet, electronics housing, wiring enclosure, or electrical compartment, etc.), a power assembly 1306 (e.g., a power converter, voltage regulator, inverter, charge controller unit, etc.), a compressor assembly 1308 (e.g., a compressor, pneumatic pump, air compressor, etc.), a rear intake fan 1310 (e.g., a cooling fan, exhaust blower, ventilation fan, air intake impeller, etc.), batteries 1312 (e.g., one or more battery cells, battery packs, energy storage cells, rechargeable accumulators, etc.), a battery assembly 1314 (e.g., a battery pack, energy storage assembly, battery tray, power storage bank, etc.), a hood 1316 (e.g., a cover, cowling, canopy, protective shell, enclosure lid, etc.), and an exhaust 1318 (e.g., a vent, exhaust port, air outlet, thermal exhaust, etc.).

A chassis 1301 (e.g., frame, etc.) of the movable base 1002 is depicted in FIG. 3, and can be formed from a rigid material, such as steel or aluminum, and can provide a structural platform for mounting the onboard subsystems. The chassis 1301 can define an interior volume or a plurality of mounting surfaces for receiving the electrical enclosure 1304, the power assembly 1306, the compressor assembly 1308, the batteries 1312, the battery assembly 1314, and the controller 1010. The tracks 1004 can be coupled to the chassis 1301 via a tracked drivetrain assembly that includes drive sprockets, idler wheels, and track tensioning elements. The tracks 1004 can receive drive commands from the controller 1010 to propel the movable base 1002 in a travel direction along a row of the installation environment.

The one or more image sensors 1302 can be coupled to the movable base 1002 at positions on the chassis 1301. As shown in FIG. 3, the movable base 1002 can include four image sensors 1302 coupled to the chassis 1301, with two image sensors 1302 positioned at a front portion of the chassis 1301 and one image sensor 1302 positioned on each lateral side of the chassis 1301 facing laterally outward. The image sensors 1302 can capture image data of the installation environment, including the terrain ahead of the robotic system 1000, the staged solar panels, the torque tubes, and any objects or personnel in the vicinity of the robotic system 1000. Each of the image sensors 1302 can have a pose that is fixed relative to the movable base 1002, such that the position and orientation of each image sensor 1302 in the coordinate frame of the movable base 1002 does not change as the articulated arm 1006 moves. The controller 1010 can receive image data from the image sensors 1302 and can use the image data to determine panel positions, mounting locations, previously placed panel locations, and safety conditions. In some implementations, the controller 1010 can select which of the image sensors 1302 to use based on viewing conditions affecting one or more of the image sensors 1302, such as sun angle or glare that may degrade the image quality from a particular image sensor 1302 at a given time of day. For example, a west-facing image sensor 1302 may be affected by glare near sunset, and the controller 1010 can select a different image sensor 1302 that is not affected by the glare condition.

The one or more image sensors 1320 can be coupled to the articulated arm 1006 proximate to the distal end of the articulated arm 1006, near the gripper assembly 1003. As shown in FIG. 3, the robotic system 1000 can include two image sensors 1320 coupled to the articulated arm 1006. Each of the image sensors 1320 can have a pose that is fixed relative to the articulated arm 1006, such that the image sensors 1320 move with the articulated arm 1006 as the articulated arm 1006 changes position and orientation during pick-and-place operations. The image sensors 1320 can capture image data from a vantage point at the end of the articulated arm 1006, which can be distinct from the vantage points of the image sensors 1302 on the chassis 1301. The image sensors 1320 can provide image data of the solar panel surface, the electrical lead terminals of the solar panel, the torque tube and hat rails at the mounting location, and the gap between the gripper assembly 1003 and the panel surface during engagement. The controller 1010 can receive image data from the image sensors 1320 and can use the image data to determine the position of electrical lead terminals, to identify coupling locations on the solar panel, and to determine the alignment between the solar panel and the mounting location. In some implementations, when the gripper assembly 1003 is holding a solar panel, the image sensors 1320 may be partially occluded by the solar panel, and the controller 1010 can rely on the image sensors 1302 on the chassis 1301 in that state, or vice versa.

The electrical enclosure 1304 can be disposed within the chassis 1301 of the movable base 1002 and can house electrical components of the robotic system 1000. The electrical enclosure 1304 can include power distribution circuitry, motor controllers, communications interfaces, and other electrical hardware that distributes electrical power from the battery system to the various subsystems of the robotic system 1000 and that routes control signals and data between the controller 1010 and the other subsystems. In some implementations, the electrical enclosure 1304 can be a sealed or partially sealed enclosure that provides protection for the electrical components from environmental contaminants such as dust, moisture, and debris that can be present at outdoor solar installation sites. The electrical enclosure 1304 can be positioned within the chassis 1301 in a location that provides access for maintenance and service while maintaining a compact arrangement within the movable base 1002.

The power assembly 1306 can be disposed within the chassis 1301 of the movable base 1002 and can include power conversion and distribution equipment for the robotic system 1000. In some implementations, the power assembly 1306 can include voltage converters, inverters, charge controllers, and/or power management circuitry that regulate the flow of electrical power from the batteries 1312 to the various subsystems of the robotic system 1000. The power assembly 1306 can receive electrical power from the battery assembly 1314 and can convert the received power to one or more voltage levels used by the articulated arm 1006, the controller 1010, the vacuum source 1012, and other subsystems.

The compressor assembly 1308 can be disposed within the chassis 1301 of the movable base 1002 and can generate vacuum and/or compressed air for the gripper assembly 1003. The compressor assembly 1308 can include one or more compressors, vacuum pumps, accumulators, pressure regulators, valves, and/or fluid lines for generating and distributing negative pressure (vacuum) and positive pressure (compressed air) to the suction cups of the gripper assembly 1003. In some implementations, the compressor assembly 1308 can include the vacuum source 1012 and a positive pressure source that share the same fluid lines to the suction cups, such that the system can switch between a vacuum mode for panel engagement and a positive pressure mode for panel release. In some implementations, the compressor assembly 1308 can include a first vacuum source and a second vacuum source that are fluidly coupled to respective subsets of the suction cups through separate vacuum lines. Each vacuum source can be individually sufficient to maintain coupling of the solar panel to the gripper assembly 1003 via its respective subset of suction cups, independent of the other vacuum source. This dual-path vacuum architecture can mitigate a single-point vacuum failure from resulting in a dropped solar panel.

The rear intake fan 1310 can be disposed at a rear portion of the chassis 1301 of the movable base 1002 and can draw air into the chassis 1301 to provide cooling for the onboard subsystems. The rear intake fan 1310 can be electrically coupled to the power assembly 1306 and/or the electrical enclosure 1304 and can be controlled by the controller 1010 to operate at one or more fan speeds based on the thermal conditions within the chassis 1301. In some implementations, the robotic system 1000 can include front intake fans positioned at a front portion of the chassis 1301 in addition to the rear intake fan 1310, such that airflow passes through the chassis 1301 from the front to the rear. The exhaust 1318 can be disposed at the rear or upper portion of the movable base 1002 and can provide an outlet for heated air to exit the chassis 1301. The rear intake fan 1310 and the exhaust 1318 can cooperate to maintain the temperature of the onboard subsystems within operating limits during sustained pick-and-place operations in outdoor solar installation environments where ambient temperatures can be elevated.

The batteries 1312 can be disposed within the chassis 1301 of the movable base 1002 and can store electrical energy for powering the robotic system 1000. The batteries 1312 can be part of the battery assembly 1314, which can include the batteries 1312, a battery management system, and wiring that connects the batteries 1312 to the power assembly 1306 and the electrical enclosure 1304. The battery assembly 1314 can provide sufficient energy to power the robotic system 1000 throughout an entire work shift of solar panel installation operations. For example, the batteries 1312 can provide electrical power to the articulated arm 1006, the controller 1010, the vacuum source 1012, and other onboard subsystems. The batteries 1312 can be positioned within the chassis 1301 in a location that distributes the weight of the batteries 1312 across the chassis 1301 to reduce the ground pressure of the movable base 1002.

The hood 1316 can be a cover or enclosure element that is disposed over the upper portion of the chassis 1301 of the movable base 1002. The hood 1316 can provide environmental protection for the onboard subsystems, such as the controller 1010, the power assembly 1306, and the electrical enclosure 1304, from rain, dust, solar radiation, and debris. The hood 1316 can be formed from a rigid material, such as sheet metal, fiberglass, or a polymer material, and can be coupled to the chassis 1301 via fasteners, latches, or hinges that allow the hood 1316 to be opened for maintenance and service. The hood 1316 can define the upper profile of the movable base 1002 and can be contoured to provide clearance for the articulated arm 1006 and for any torque tubes or racking infrastructure that may be positioned above the movable base 1002 as the robotic system 1000 travels along a row of the installation environment. In some implementations, the robotic system 1000 can have a lower profile that facilitates navigation beneath torque tubes.

The controller 1010 can coordinate pick-and-place operations across multiple phases. During a pick phase, the controller 1010 can receive image data (e.g., image data 2402, one or more image frames, captured photographs, sensor frames, or pixel arrays, etc.) from the image sensors 1302 and/or the image sensors 1320 and can determine the position and orientation of a staged solar panel ahead of the robotic system 1000. The controller 1010 can transmit a control signal to the arm controller of the articulated arm 1006 to extend the articulated arm 1006 forward from the movable base 1002 and to move the gripper assembly 1003 toward the underside of the staged solar panel. The controller 1010 can activate the vacuum source 1012 to generate vacuum at the suction cups of the gripper assembly 1003, and the suction cups can couple to the underside of the solar panel. In some implementations, the controller 1010 can activate the vacuum source 1012 while the gripper assembly 1003 is approaching the solar panel, such that the vacuum is at operating capacity by the time physical contact is made between the suction cups and the panel surface. In some implementations, the controller 1010 can activate the vacuum source 1012 in response to the gripper assembly 1003 being within a threshold distance from the solar panel.

During a placement phase, the controller 1010 can transmit control signals to the arm controller of the articulated arm 1006 to rotate and translate the solar panel laterally in a second direction transverse to the travel direction of the movable base 1002. The controller 1010 can transmit a control signal to the rotational actuator of the gripper assembly 1003 to rotate the solar panel to a mounting orientation. In some implementations, the controller 1010 can transmit the arm movement control signal and the gripper rotation control signal simultaneously, such that the articulated arm 1006 is moving while the rotational actuator of the gripper assembly 1003 is simultaneously rotating the solar panel. The solar panel can be above the gripper assembly 1003 during the lateral movement, and the articulated arm 1006 can swing the solar panel to the left or right side of the movable base 1002 and lower the solar panel onto the hat rails at the mounting location. Throughout the pick and placement phases, the movable base 1002 can remain oriented along the travel direction and does not turn left or right.

During a release phase, the controller 1010 can deactivate the vacuum source 1012 when the solar panel is proximate to the mounting location. The controller 1010 can activate the positive pressure source to blow compressed air through the suction cups and break residual stiction between the suction cups and the panel surface. In some implementations, the controller 1010 can activate the positive pressure source for a predetermined time period and then automatically deactivate the positive pressure source. In some implementations, the controller 1010 can command the articulated arm 1006 to retract toward the movable base 1002 while the positive pressure source is still active, which can assist in physically separating the suction cups from the panel surface. In some implementations, the controller 1010 can apply a slight oscillation or jiggle motion to the articulated arm 1006 during release to overcome stiction between the suction cups and the panel surface. The release can be triggered by user input via the user interface 1014, or the release can be triggered by a condition satisfied by a position of the solar panel, such as a distance of the solar panel to the mounting location falling below a threshold, an orientation of the solar panel being achieved, an elapsed time, or contact of the solar panel at the mounting location being detected.

During a return phase, the controller 1010 can command the articulated arm 1006 to retract, moving in a third direction transverse to the travel direction and the lateral placement direction, and then back toward the movable base 1002 to a neutral position. The controller 1010 can then command the movable base 1002 to advance along the row to the position of the next staged solar panel, and the pick-and-place cycle can repeat.

The controller 1010 can operate in multiple operating modes to accommodate bidirectional travel along rows of the installation environment. In a first operating mode, the controller 1010 can control the movable base 1002 to travel in a first direction, such as from south to north, along a first row. In a second operating mode, the controller 1010 can control the movable base 1002 to travel in a second direction opposite the first direction, such as from north to south, along a second row. In the second operating mode, the controller 1010 can determine a different coupling location on the next solar panel and a different mounting location based on the reversed travel direction. This bidirectional capability can allow the robotic system 1000 to install solar panels in both travel directions without repositioning at the end of each row.

FIG. 3 can illustrate the spatial arrangement of the subsystems within the robotic system 1000. A proximal end of the articulated arm 1006 can be disposed at the front of the chassis 1301, with the gripper assembly 1003 and the image sensors 1320 at the distal end of the articulated arm 1006. The image sensors 1302 can be coupled to the chassis 1301 at the front and side positions. The vacuum source 1012 can be disposed in a mid-region of the chassis 1301. The electrical enclosure 1304 and the compressor assembly 1308 can be disposed adjacent to the controller 1010. The batteries 1312 and the battery assembly 1314 can be disposed in a lower or rear portion of the chassis 1301. The hood 1316 can cover the upper portion of the chassis 1301, and the rear intake fan 1310 and the exhaust 1318 can be positioned at the rear of the chassis 1301 to provide airflow. The tracks 1004 can extend along the lower lateral sides of the chassis 1301 and can provide the locomotion for the movable base 1002. This arrangement can integrate all electronics, power, vacuum, and computing systems on board the movable base 1002, which can eliminate the need for a separate trailer and can provide a self-contained mobile platform for solar panel installation operations.

### B. Overview of Gripper

The robotic system 1000 includes the gripper assembly 1003 for use in solar panel installation systems. The gripper assembly can be part of a larger automated system for increasing the speed of solar panel deployment. In some cases, the system incorporating the gripper assembly can be capable of accelerating deployment speeds by up to tenfold compared to other methods.

The gripper assembly 1003 can be incorporated into existing solar panel installation operations without substantial alterations to established processes or extensive onsite integration efforts. The gripper assembly 1003 can allow for versatile application across various solar construction projects. The gripper assembly 1003 can include a frame structure, multiple suction cups to secure panel engagement, a rotational shaft, and an actuation system. The combination of these elements can enable the gripper assembly to perform reorientation maneuvers while maintaining a grip on solar panels throughout the installation process. The actuation system can drive rotation of the frame structure using either a direct-drive or gear-driven arrangement. In a direct-drive arrangement, the actuation system can be coupled to the rotational shaft without intermediate transmission elements. In a gear-driven arrangement, the actuation system can be coupled to multiple gears, which drive the rotational shaft to rotate the frame structure. The frame mounting structure can include a plurality of interconnected sidewalls defining an interior volume that houses the actuation components, and the actuator can be mounted to a sidewall of the frame mounting structure. The frame mounting structure can provide an attachment interface to an end effector flange of the articulated arm.

By incorporating automation and mechanical systems at the gripper level, the gripper assembly can contribute to streamlining solar panel installation procedures. This approach can lead to improvements in deployment efficiency and overall project timelines for solar farm construction.

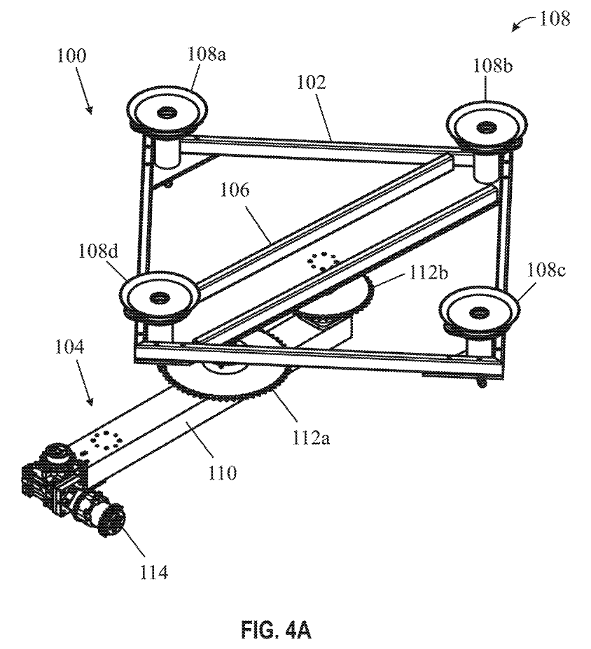

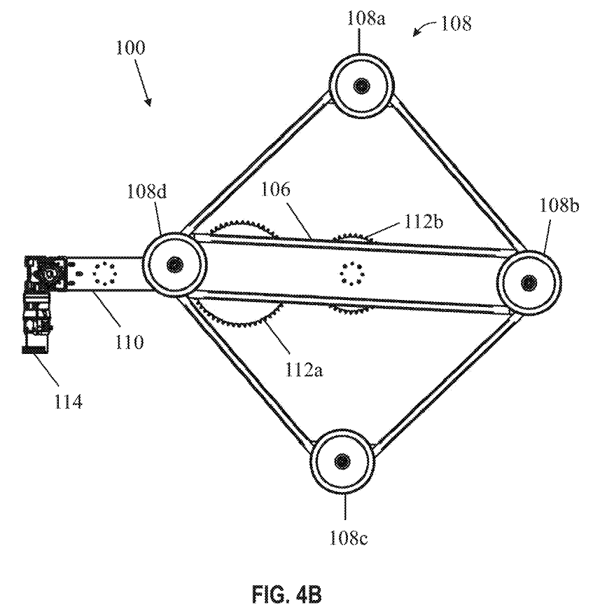

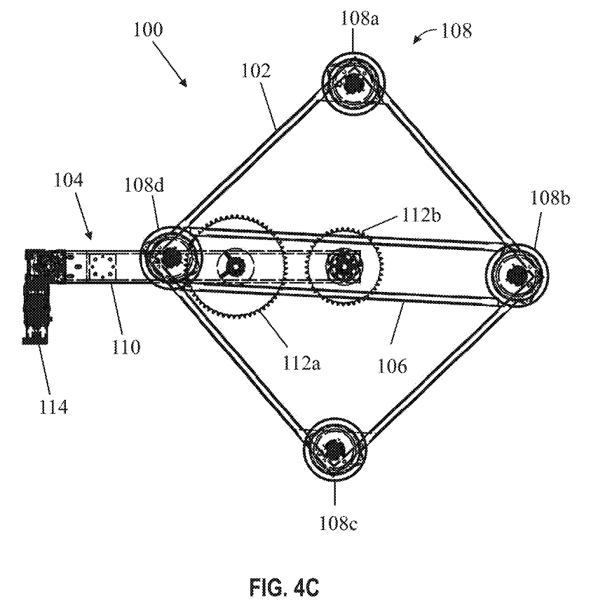

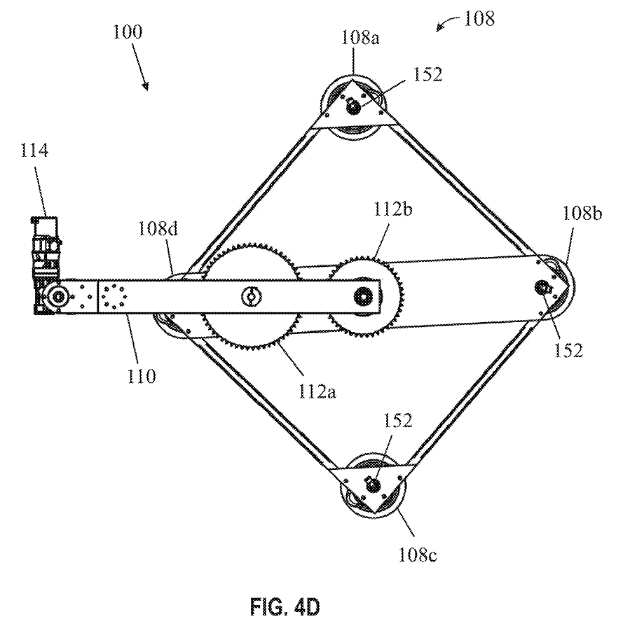

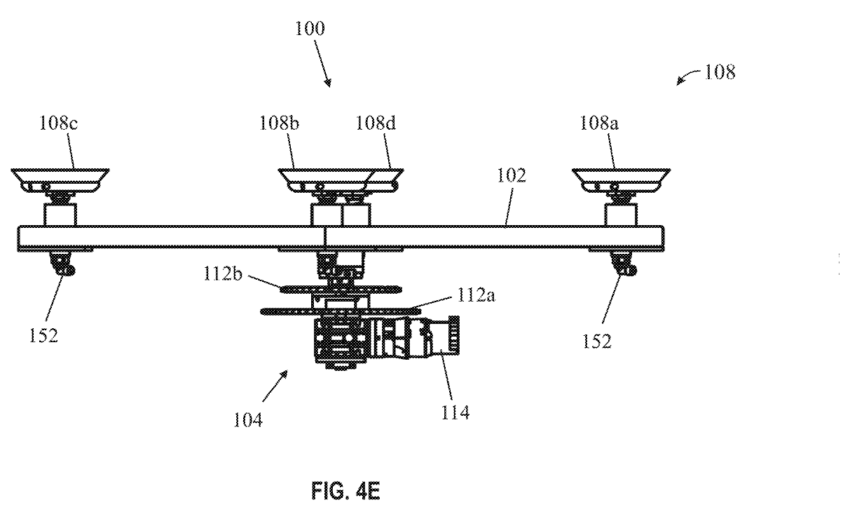

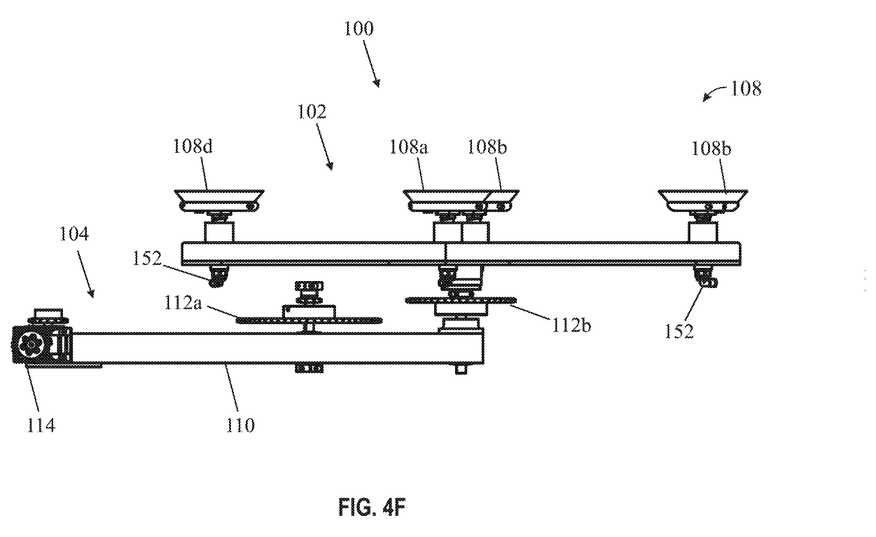

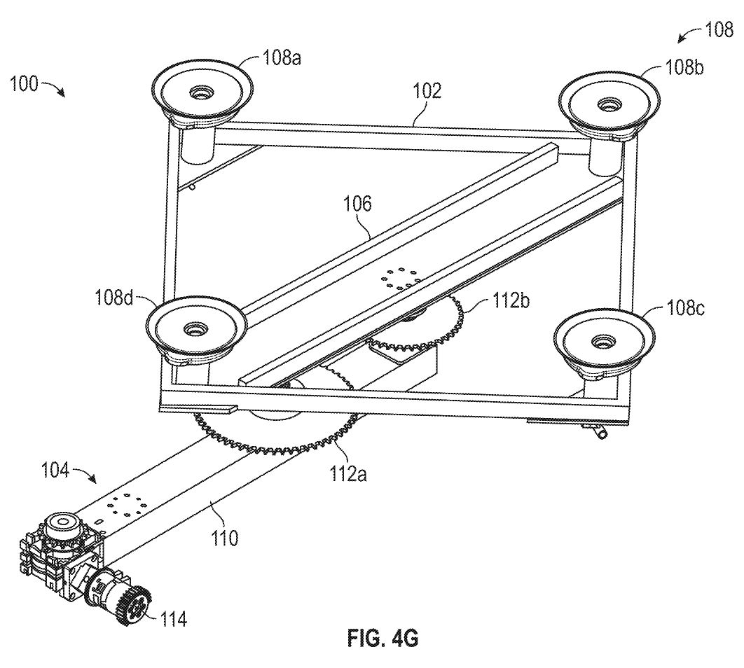

Referring now to FIGS. 4A through 4G , illustrated are various views of a gripper assembly 100, in accordance with one or more implementations. The gripper assembly 100 can be an example of the gripper assembly 1003 and/or the gripper assembly 1003 can include the gripper assembly 100. The gripper assembly 100 can include a frame structure 102 (e.g., frame, etc.) and a frame mounting structure 104 (e.g., first frame mounting structure, first frame mount, etc.). The frame structure 102 can serve as a distal, object-engaging portion of the gripper assembly 100 and can carry a plurality of suction cups 108 that contact and retain a solar panel or other planar object. The frame mounting structure 104 can serve as a proximal region that interfaces with a robotic arm or other manipulator and that houses or provides structural mounting for rotational components of the gripper assembly 100. The frame structure 102 can be rotatably coupled to the frame mounting structure 104 such that the frame structure 102 rotates relative to the frame mounting structure 104 about a rotational axis. This rotational coupling can enable the gripper assembly 100 to reorient a grasped object without requiring repositioning of the robotic arm itself. The frame mounting structure 104 can include a plurality of interconnected sidewalls defining an interior volume that accommodates the actuation system and rotational components of the gripper assembly 100.

As shown in FIG. 4A, the gripper assembly 100 can include a support beam 106 that extends across the frame structure 102. The support beam 106 can be a diagonal or transverse structural element that contributes to the rigidity of the frame structure 102 and maintains dimensional stability during panel handling operations. In some implementations, the support beam 106 can span between opposing corners or between opposing sides of the frame structure 102, forming a cross-brace that distributes mechanical loads across the frame and resists deflection when the gripper assembly 100 is retaining a solar panel or other planar object. The support beam 106 can be formed from carbon fiber, metal, composite material, or a combination thereof. In some implementations, the support beam 106 can be integrally formed with other members of the frame structure 102, while in other implementations, the support beam 106 can be a discrete structural member that is fastened, bonded, or otherwise affixed to the perimeter members of the frame structure 102.

In some implementations, the plurality of suction cups 108 can include a first suction cup 108a, a second suction cup 108b, a third suction cup 108c, and a fourth suction cup 108d. These suction cups 108 can be positioned at or near respective corners of the frame structure 102 and can be arranged in a rectangular arrangement. The rectangular arrangement can distribute contact forces across a broad area of the solar panel surface, which can reduce localized stress concentrations and can reduce the risk of damage to fragile panel substrates during lifting and transport operations. In some implementations, the suction cups 108 can be positioned at locations that are inboard from the corners of the frame structure 102 by a predetermined distance, such that the suction cups 108 contact a solar panel at positions that are spaced from the panel edges. In some implementations, the positions of the suction cups 108 can be selected based on the dimensions and geometry of the solar panels intended to be retained, such that the contact points avoid regions of the panel that are susceptible to mechanical stress or that include protruding features on the rear surface of the panel. Each suction cup 108 can be mounted to the frame structure 102 via a suction cup mount 152 (e.g., a suction cup bracket, vacuum pad holder, retention cup fitting, pneumatic cup seat, etc.) that includes a port fluidly connecting the suction cup 108 to a vacuum source (e.g., vacuum source 1012, etc.). In some implementations, a first subset of the plurality of suction cups 108 can be fluidly coupled to a first vacuum source through a first vacuum line, and a second subset of the plurality of suction cups 108 can be fluidly coupled to a second vacuum source through a second vacuum line separate from the first vacuum line, such that each vacuum source can be individually sufficient to maintain coupling of a solar panel to the gripper assembly 100 via its respective subset of suction cups 108 independent of the other vacuum source.

The gripper assembly 100 can include a member 110 (e.g., a shaft, axle, spindle, rotary rod, or rotational coupling member, shown as a rotational shaft, or bar member, etc.) that extends along or across the frame mounting structure 104. The member 110 can be an elongate structural element, such as a rectangular bar member, a channel member, or an extruded profile, that provides a mounting platform for one or more components of the actuation system. For example, the member 110 can carry a gear system that includes a first gear 112a (e.g., a first toothed wheel, spur gear, drive gear, rotary transmission element, etc.) and a second gear 112b (e.g., a second toothed wheel, spur gear, driven gear, pinion, etc.). The first gear 112a and the second gear 112b can be mounted on or along the member 110 in a spaced arrangement. In some implementations, the member 110 can include bearing seats, shaft mounts, or mounting bosses at positions corresponding to the rotational axes of the first gear 112a and the second gear 112b. The member 110 can be formed from metal, such as aluminum or steel, or from a composite material, and can be dimensioned to receive the mechanical loads transmitted through the gear system during frame rotation.

An actuator 114 (e.g., a motor, servo, rotary driver, electric actuator, torque generator, etc.) can be mechanically coupled to the gear system and can be positioned at or near one end of the frame mounting structure 104. The actuator 114 can drive rotation of the frame structure 102 via the gear system. In some implementations, the actuator 114 can include a servo motor, a brushless DC motor, a high-torque motor, an integrated actuator and gearbox unit, or a direct-drive motor. In some implementations, the actuator 114 can be a stepper motor or a rotary actuator that provides precise angular control. The actuator 114 can be mounted to a sidewall of the frame mounting structure 104. The actuator 114 can provide rotational torque to the first gear 112a, which in turn can mesh with or otherwise transmit rotational motion to the second gear 112b. The second gear 112b can be coupled to the frame structure 102 or to a rotational shaft that is coupled to the frame structure 102, such that rotation of the second gear 112b causes corresponding rotation of the frame structure 102 relative to the frame mounting structure 104. In some implementations, the actuator 114 can include an output pinion or drive gear that meshes with the first gear 112a, or the actuator 114 can be coupled to the first gear 112a via a keyed shaft, a splined connection, or a coupling hub. The gear system can transmit torque from the actuator 114 to the frame structure 102 at a gear ratio determined by the relative sizes of the first gear 112a and the second gear 112b, enabling the actuator 114 to control the angular position, speed, and torque at the frame structure 102 during panel manipulation. In some implementations, the actuator 114 can be coupled to the rotational shaft without an intermediate gear system in a direct-drive arrangement, such that the shaft of the actuator 114 itself serves as the rotational shaft.

Referring now to FIG. 4B, illustrated is a plan view of the gripper assembly 100, in accordance with one or more implementations. As shown in FIG. 4B, the support beam 106 can extend across the frame structure 102 in a diagonal orientation relative to the outer perimeter of the frame structure 102. The support beam 106 can provide additional structural reinforcement that resists torsional and bending loads experienced during panel handling. In some implementations, the support beam 106 can extend between diagonally opposite corners of the frame structure 102, forming a diagonal strut that triangulates the frame geometry and increases the torsional stiffness of the frame structure 102. In some implementations, the frame structure 102 can include two or more diagonal structural elements that intersect at or near the center of the frame, forming an X-shaped bracing pattern.

The first suction cup 108a, the second suction cup 108b, the third suction cup 108c, and the fourth suction cup 108d can be positioned at the four corner regions of the frame structure 102 in a diamond arrangement when viewed from above. In this view, the diamond arrangement can be understood as a rotation of the rectangular arrangement, with suction cups 108 positioned at the top, bottom, left, and right extremities of the frame when viewed in plan. The member 110 can extend outward from the frame structure 102 toward the actuator 114, carrying the first gear 112a and the second gear 112b along its length. In some implementations, the first gear 112a can have a larger diameter than the second gear 112b, which can provide a gear reduction that increases torque output at the frame structure 102 while reducing rotational speed. In other implementations, the relative diameters of the first gear 112a and the second gear 112b can be reversed or can be equal, depending on the torque and speed characteristics desired for a given application. For example, equal-diameter gears can provide a one-to-one gear ratio that preserves the output speed of the actuator 114 without torque amplification, while a gear arrangement in which the second gear 112b has a larger diameter than the first gear 112a can provide a speed increase at the output at the expense of reduced torque.

Referring now to FIG. 4C, illustrated is another plan view of the gripper assembly 100, in accordance with one or more implementations. As depicted in FIG. 4C, the frame mounting structure 104 can extend laterally from the frame structure 102 and can serve as an attachment point for coupling the gripper assembly 100 to a robotic arm, a manipulator, or another automated handling system. The frame mounting structure 104 can include one or more mechanical interfaces, such as attachment flanges, bolt holes, recessed channels, quick-release connectors, or dovetail joints, that facilitate secure mounting of the gripper assembly 100 to the distal end of the robotic arm. In some implementations, the frame mounting structure 104 can include a tool plate or adapter for compatibility with robotic arm end-effector interfaces, such as flanges or adapters. The arrangement of the suction cups 108, the member 110, and the gear system including the first gear 112a and the second gear 112b can cooperate to enable controlled rotational movement and positioning of objects retained by the gripper assembly 100. The support beam 106 can be visible in this view extending across the interior of the frame structure 102, providing a structural cross-brace that can maintain the planar geometry of the frame structure 102 under loading conditions encountered during panel pickup and transport. In some implementations, the support beam 106 can serve as a cable or tubing routing path, with vacuum lines or electrical wiring secured along the length of the support beam 106 to maintain an organized routing arrangement within the frame structure 102.

Referring now to FIG. 4D, illustrated is a plan view of the gripper assembly 100 showing suction cup mounts 152, in accordance with one or more implementations. As shown in FIG. 4D, the gripper assembly 100 can include suction cup mounts 152 for attaching the suction cups 108 to the frame structure 102. Each of the suction cup mounts 152 can provide a secure mechanical connection between a respective suction cup 108 and the frame structure 102. The suction cup mounts 152 can be positioned at the corner regions of the frame structure 102, corresponding to the locations of the first suction cup 108a, the second suction cup 108b, the third suction cup 108c, and the fourth suction cup 108d. Each suction cup mount 152 can include a base portion that attaches to the frame structure 102 and an upper portion that receives and retains the corresponding suction cup 108. In some implementations, the base portion can be bolted, riveted, welded, or adhesively bonded to a surface of the frame structure 102, and the upper portion can include a socket, a collar, a threaded receiver, or a snap-fit interface that mechanically captures the suction cup 108. Each suction cup mount 152 can include a port that fluidly connects the suction cup 108 to a vacuum source via a vacuum line routed along or through the frame structure 102. The suction cup mounts 152 can incorporate a degree of flexibility or adjustability, allowing the suction cups 108 to move and adjust their position relative to the frame structure 102. This adjustability can enable the suction cups 108 to accommodate variations in the surface geometry of solar panels or other objects being gripped by the gripper assembly 100. In some implementations, each suction cup mount 152 can include a compliant element, such as a coil spring, an elastomeric bushing, or a rubber boot, that provides vertical compliance and permits the suction cup 108 to deflect toward or away from the frame structure 102 within a predetermined travel range.

In some implementations, the suction cup mounts 152 can include articulation points or flexible joints that permit limited movement in multiple directions. For example, each suction cup mount 152 can include a ball-and-socket joint, a gimbal-type connection, a spring-loaded pivot, a universal joint, or a compliant elastomeric coupling that allows the corresponding suction cup 108 to tilt, swivel, or translate along one or more axes relative to the frame structure 102. This multi-axis movement capability can allow each suction cup 108 to independently adjust its level and orientation when brought into contact with a target surface. In some implementations, each suction cup mount 152 can permit angular deflection of up to about 5 degrees, about 10 degrees, about 15 degrees, or about 20 degrees, among others, from a neutral position, and can permit vertical translation of up to about 5 mm, about 10 mm, about 15 mm, or about 20 mm, among others. Such adaptability can be beneficial when retaining solar panels or other objects that do not have flat or uniform surfaces. For example, when grasping the rear side of a solar panel, the surface can include raised junction boxes, protruding electrical leads, adhesive pads, label stickers, or other irregularities that form a non-planar contact surface. The compliant suction cup mounts 152 can allow each suction cup 108 to self-level and maintain a seal against the panel surface despite these local variations in surface topology. In some implementations, the suction cup mounts 152 can include a spring return that biases the suction cup 108 toward a neutral position when no external contact force is applied, which can facilitate consistent initial engagement across successive pick-and-place cycles.

The ability of the suction cups 108 to self-adjust via the suction cup mounts 152 can extend the versatility of the gripper assembly 100 across a range of panel types and surface conditions. In some implementations, this feature can allow the gripper assembly 100 to maintain a secure grip on panels with slight warping, manufacturing variations, thermal distortion, or other minor surface irregularities. The independent adjustment of each suction cup 108 can distribute the gripping force across the panel surface in a manner that reduces the risk of localized stress concentrations. Distributing the gripping force can be beneficial for fragile solar panel substrates, which can be susceptible to cracking or microcracking under concentrated loads. In some implementations, the suction cup mounts 152 can include a self-leveling feature in which the suction cup 108 passively returns to a neutral orientation when not in contact with a panel surface, which can facilitate repeatable and consistent engagement across successive pick-and-place cycles. In some implementations, each suction cup mount 152 can include a vacuum port or fluid passage that extends through the mount body and fluidly connects the suction cup 108 to a vacuum line routed along or through the frame structure 102. This integrated vacuum routing can simplify the tubing layout and can reduce the number of external tubing connections within the gripper assembly 100.

Referring now to FIG. 4E, illustrated is a front elevational view of the gripper assembly 100, in accordance with one or more implementations. As shown in FIG. 4E, the frame structure 102 can extend laterally and can carry the first suction cup 108a, the second suction cup 108b, the third suction cup 108c, and the fourth suction cup 108d at distributed positions along its span. The suction cup mounts 152 can be visible below the frame structure 102, coupling each suction cup 108 to the frame. In some implementations, the suction cup mounts 152 can include compliant spring elements that are visible in the front elevational view as coiled or compressed springs disposed between the suction cup 108 body and the frame surface. The frame mounting structure 104 can be positioned below the frame structure 102 in this view and can include the first gear 112a and the second gear 112b disposed within or adjacent to the frame mounting structure 104. The actuator 114 can be visible at one side of the frame mounting structure 104. The arrangement of the frame structure 102, with suction cups 108 distributed at spaced intervals, can provide multiple contact points when gripping objects. This distributed contact arrangement can contribute to the stability of the gripper assembly 100 during operation by mitigating the grasped panel from tilting or shifting during rotation and transport. The front elevational view can illustrate the relative vertical separation between the frame structure 102 and the frame mounting structure 104, which can be defined by a rotational shaft or axle that couples the two structures and permits relative rotation therebetween. In some implementations, the vertical separation can be selected to provide clearance for the gear system and the rotational shaft while maintaining a compact overall profile for the gripper assembly 100. In some implementations, the vertical separation between the frame structure 102 and the frame mounting structure 104 can be about 20 mm, about 40 mm, about 60 mm, or about 80 mm, among others, depending on the dimensions of the gear system and the rotational shaft.

Referring now to FIG. 4F, illustrated is a side elevational view of the gripper assembly 100, in accordance with one or more implementations. As depicted in FIG. 4F, the frame structure 102 can be visible as an elongate horizontal element carrying the first suction cup 108a, the second suction cup 108b, and the fourth suction cup 108d at spaced positions along its length, each mounted via respective suction cup mounts 152. The member 110 can extend below the frame structure 102, and the first gear 112a and the second gear 112b can be visible along the member 110. The actuator 114 can be positioned at the end of the frame mounting structure 104 opposite the gear system. In some implementations, the frame structure 102 can be constructed from carbon fiber or another composite material, such as fiberglass, aramid fiber, or a hybrid composite laminate. The carbon fiber construction can provide a high stiffness-to-weight ratio, which can reduce the payload burden on the robotic arm and can improve the dynamic response of the robotic system during rapid pick-and-place operations. In some implementations, the gripper assembly 100 can incorporate cushioning elements or compliant pads at the interface between the suction cups 108 and the frame structure 102, which can further reduce the risk of panel fractures during handling. The gripper assembly 100 can achieve millimeter-level precision in grasping and placing solar panels, which can be beneficial for delicate photovoltaic modules where dimensional accuracy during installation affects both structural fitment and electrical connectivity. The side elevational view of FIG. 4F can illustrate the spatial relationship between the first gear 112a and the second gear 112b, showing how the two gears can be spaced along the member 110 and can mesh at a tangential point between their toothed perimeters. In some implementations, the first gear 112a can be positioned closer to the junction between the frame mounting structure 104 and the frame structure 102, while the second gear 112b can be positioned closer to the actuator 114, or vice versa, depending on the specific gear train layout.

Referring now to FIG. 4G, illustrated is a perspective view of the gripper assembly 100, in accordance with one or more implementations. As shown in FIG. 4G, the frame structure 102 can be visible as a rectangular frame carrying the first suction cup 108a, the second suction cup 108b, the third suction cup 108c, and the fourth suction cup 108d at its four corners. The support beam 106 can extend diagonally across the interior of the frame structure 102, providing structural bracing. The frame mounting structure 104 can extend from one side of the frame structure 102 and can carry the member 110, the first gear 112a, the second gear 112b, and the actuator 114. The perspective view of FIG. 4G can illustrate the three-dimensional spatial relationship among the frame structure 102, the frame mounting structure 104, and the gear system. In some implementations, the frame structure 102 can be formed from carbon fiber frame members having a woven or layered composite construction that can be visible as a textured surface in the perspective view. The woven carbon fiber construction can include a twill weave, a plain weave, or a unidirectional fiber layup, depending on the mechanical properties and manufacturing approach selected for the frame. The arrangement of the actuator 114 working in conjunction with the gear system and the member 110 can enable controlled rotational movement of the frame structure 102 and the attached suction cups 108 relative to the frame mounting structure 104. This arrangement can provide the gripper assembly 100 with the capability to perform rotational maneuvers while maintaining a secure grip on objects being retained, such as solar panels being transferred from a pallet to a mounting structure. In some implementations, the gripper assembly 100 can rotate the frame structure 102 while the robotic arm is stationary, while the robotic arm is in motion, or during a combined motion sequence in which both the robotic arm and the frame structure 102 are simultaneously repositioned.

In some implementations, the actuator 114 can generate rotational torque that is transmitted through the gear system to rotate the frame structure 102 about an axis that is perpendicular to the plane of the frame structure 102. The gear system can include meshing spur gears, as illustrated in FIGS. 4A through 4G , or can include other gear types such as worm gears, harmonic gearing, planetary gears, or belt-driven or chain-driven transmission elements. The selection of gear type can depend on the torque, speed, backlash, and packaging constraints of a particular implementation. For example, spur gears can provide a compact and straightforward meshing arrangement with a defined gear ratio, worm gears can provide a self-locking characteristic that resists back driving under external loads, harmonic gearing can provide high gear ratios in a compact envelope with reduced backlash, and planetary gears can provide high torque density in a coaxial arrangement. Belt-driven or chain-driven arrangements can accommodate larger center-to-center distances between the driving and driven elements and can provide flexibility in routing the transmission path around other components within the frame mounting structure 104. In some implementations, the first gear 112a can have a larger pitch diameter than the second gear 112b, which can provide a gear reduction ratio that increases the output torque available at the frame structure 102 while decreasing the rotational speed. This torque amplification can be beneficial when the gripper assembly 100 is carrying a heavy solar panel and the rotational actuation system is tasked with overcoming the inertial and gravitational loads of the panel during rotation. In some implementations, the gear ratio between the first gear 112a and the second gear 112b can be about 2:1, about 3:1, about 4:1, about 5:1, about 10:1, about 75:1, or about 300:1, among others, depending on the torque and speed constraints of the application.

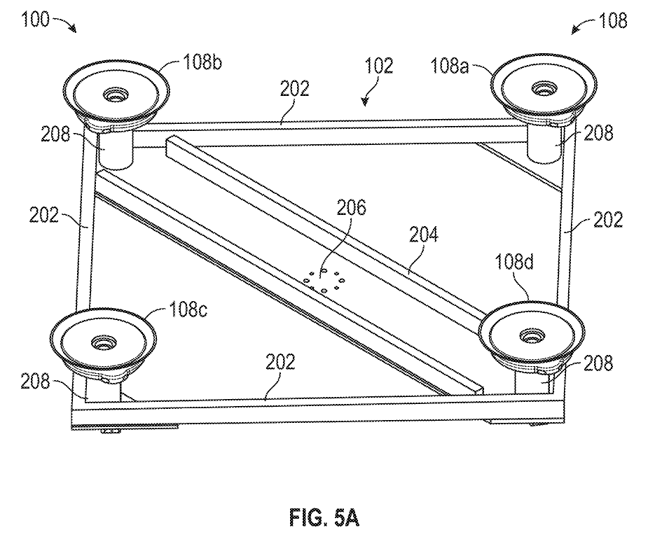

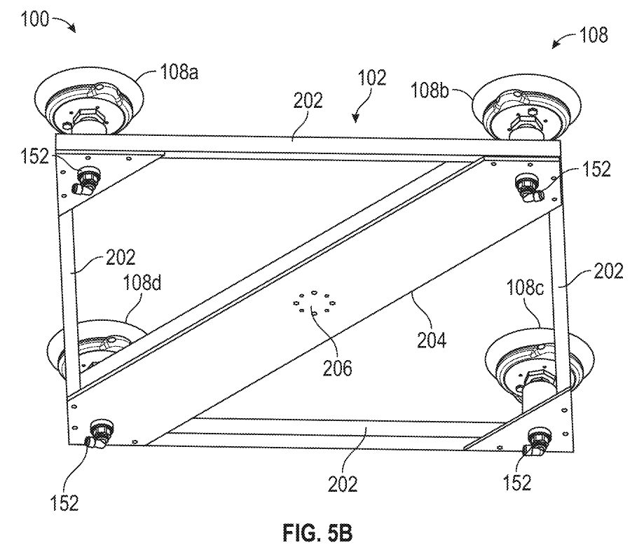

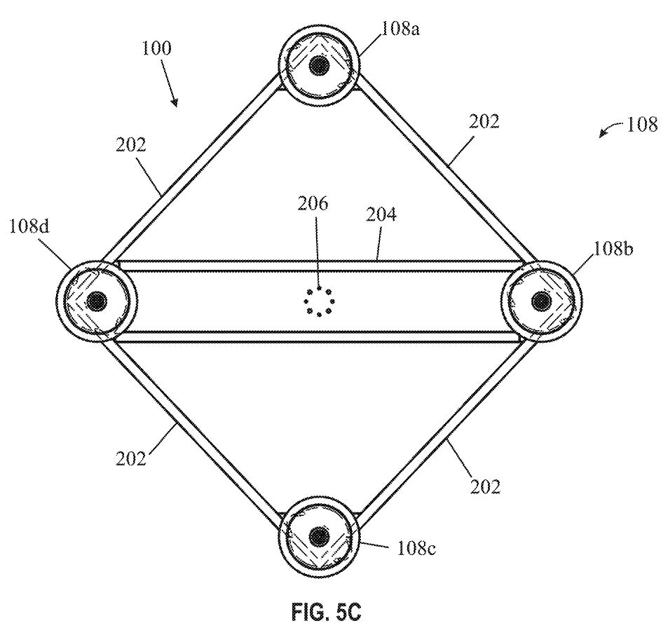

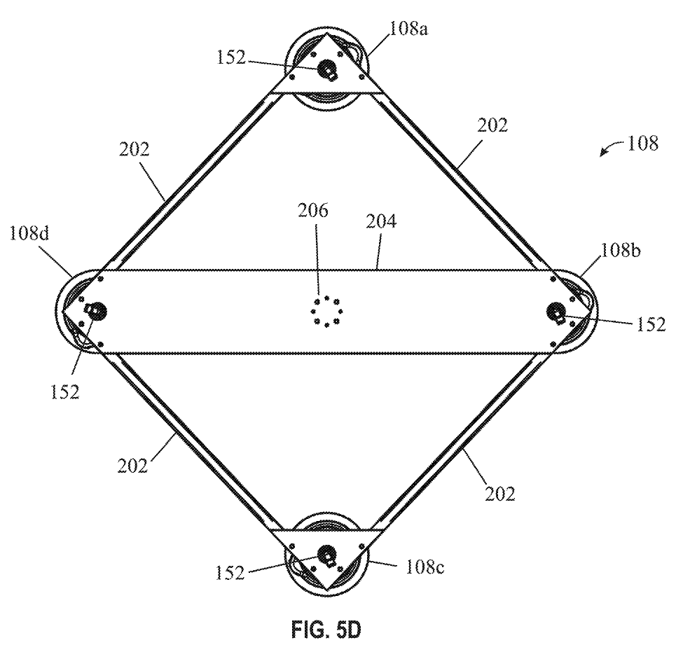

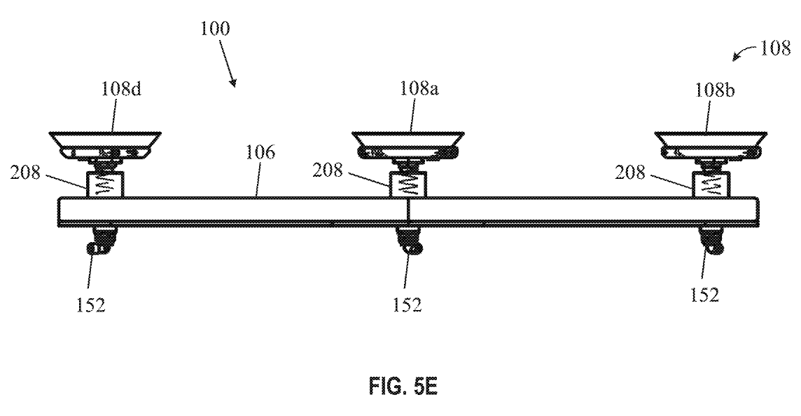

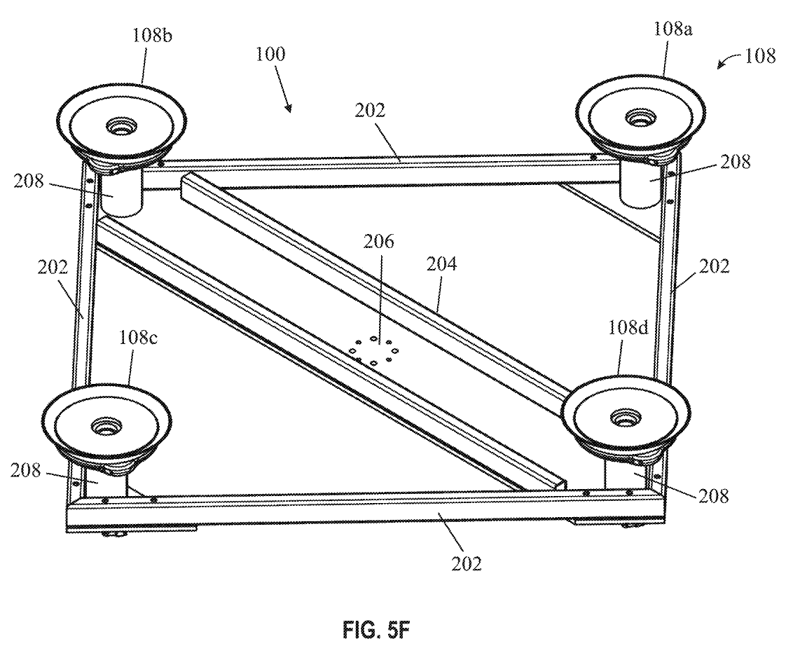

Referring now to FIGS. 5A through 5F illustrated are various views of the gripper assembly 100 with a carbon fiber frame, in accordance with one or more implementations. As shown in FIG. 5A, the gripper assembly 100 can include a carbon fiber frame member 202 (e.g., a perimeter rail, edge extrusion, border beam, boundary bar, etc.) that forms a structural base for the assembly. The carbon fiber frame member 202 can include a plurality of carbon fiber frame members arranged in a rectangular or other polygonal geometry. In some implementations, the carbon fiber frame member 202 can include four perimeter members that define the outer boundary of a rectangular frame, with the members joined at their ends by corner brackets, adhesive bonds, mechanical fasteners, or interlocking joints. The carbon fiber frame member 202 can provide a lightweight yet rigid foundation for the gripper assembly 100, which can reduce the overall mass of the end effector and can improve the reach, payload capacity, and dynamic performance of the robotic arm to which the gripper assembly 100 is attached. In some implementations, the carbon fiber frame member 202 can have an overall length of about 500 mm to about 2000 mm and an overall width of about 300 mm to about 1500 mm, depending on the dimensions of the solar panels intended to be retained. The cross-sectional profile of each carbon fiber frame member can be rectangular, square, circular, or tubular, and the wall thickness can be selected based on the structural loading constraints of the particular application.

The gripper assembly 100 can include a plurality of suction cups 108 mounted to the carbon fiber frame member 202. In some implementations, the plurality of suction cups 108 can include the first suction cup 108a, the second suction cup 108b, the third suction cup 108c, and the fourth suction cup 108d. These suction cups 108 can be positioned at or near each corner of the carbon fiber frame member 202 and can be arranged in a rectangular arrangement. The suction cups 108 can be mounted to the carbon fiber frame member 202 via suction cup mounts 208 (e.g., one or more cup bases, compliant brackets, spring mounts, or suction cup pedestals, etc.). Each of the suction cup mounts 208 can include a base flange, a cylindrical post, a threaded stud, or another mounting interface that couples the suction cup 108 to the carbon fiber frame member 202. In some implementations, the suction cup mounts 208 can include compliant elements such as springs, elastomeric bushings, bellows, or articulating joints that permit each suction cup 108 to self-level relative to the surface being grasped. In some implementations, each of the suction cup mounts 208 can include a fluid passage or port that provides a vacuum connection between the suction cup 108 and a vacuum line routed along the carbon fiber frame member 202. Mounting holes 206 (e.g., one or more apertures, bores, bolt holes, through-holes, fastener receptacles, etc.) can be incorporated into the carbon fiber frame member 202 at or near the center of the frame. The mounting holes 206 can define an area where the carbon fiber frame member 202 can be coupled to the frame mounting structure 104 or to a rotational shaft that passes through the frame and connects to the actuation system disposed in the frame mounting structure 104. In some implementations, the mounting holes 206 can include a reinforced plate, a hub insert, or a metal fitting bonded or mechanically fastened to the carbon fiber frame members, providing a durable interface for transferring rotational loads between the shaft and the frame.

Referring now to FIG. 5B, illustrated is a bottom perspective view of the gripper assembly 100, in accordance with one or more implementations. As shown in FIG. 5B, the carbon fiber frame member 202 can include a plurality of frame members that define the perimeter of the rectangular frame, with a cross member 204 (e.g., a diagonal brace, cross member, truss element, or angular reinforcement, etc.) extending diagonally across the carbon fiber frame member 202. The cross member 204 can provide additional structural reinforcement and can resist torsional deflection of the carbon fiber frame member 202 under loading. In some implementations, the cross member 204 can extend between two diagonally opposite corners of the carbon fiber frame member 202. In some implementations, two cross members can be provided in an X-shaped arrangement, with each beam extending between a respective pair of diagonally opposite corners. The cross member 204 can be formed of carbon fiber, which can further contribute to the lightweight and rigid characteristics of the gripper assembly 100. In some implementations, the cross member 204 can be formed from a different material, such as aluminum, steel, or fiberglass, where the stiffness characteristics of the diagonal member differ from those of the perimeter members. The suction cup mounts 152 can be visible on the underside of the carbon fiber frame member 202, illustrating how each suction cup 108 is mechanically coupled to the frame from below. The mounting holes 206 can be visible at or near the center of the carbon fiber frame member 202, indicating the region where the rotational shaft can pass through the frame to connect with the actuation system. In some implementations, the mounting holes 206 can include a hub, a flange, a reinforced plate, or a set of bolt holes that receive and secure the rotational shaft, establishing a rigid coupling between the shaft and the carbon fiber frame member 202 such that rotation of the shaft causes corresponding rotation of the entire frame. In some implementations, the mounting holes 206 can include a metal insert that is co-molded or secondarily bonded into the carbon fiber layup, providing a metal-to-metal interface for the shaft connection that can resist wear and fatigue over repeated rotational cycles.

Referring now to FIG. 5C, illustrated is a plan view of the gripper assembly 100 in a diamond arrangement, in accordance with one or more implementations. As depicted in FIG. 5C, the carbon fiber frame member 202 can be arranged such that the frame members form a diamond shape when viewed from above, with the first suction cup 108a positioned at the top vertex, the third suction cup 108c positioned at the bottom vertex, and the second suction cup 108b and fourth suction cup 108d positioned at the left and right vertices, respectively. The carbon fiber frame member 202 can include a plurality of interconnected frame members that extend between adjacent suction cup 108 locations, creating the diamond-shaped geometry. In some implementations, each frame member can extend between two adjacent vertices, forming four frame members that together define a rhombus or square shape when oriented in the diamond arrangement. A cross member 204 can extend horizontally across the midpoint of the diamond arrangement, connecting the left and right vertices. The mounting holes 206 can be positioned at or near the center of the diamond shape where the cross member 204 intersects the frame members. This diamond arrangement can provide an alternative suction cup 108 placement pattern that can be advantageous for certain panel geometries or for achieving a more symmetric load distribution during rotational operations. In some implementations, the diamond arrangement can distribute the suction cups 108 at positions that correspond to the midpoints of the edges of a rectangular solar panel, rather than at the corners, which can provide a different stress distribution pattern on the panel surface. The diamond arrangement can provide the gripper assembly 100 with a more balanced rotational inertia about the rotational axis, which can reduce the torque and power constraints of the actuator 114 during rapid angular repositioning.

Referring now to FIG. 5D, illustrated is a front view of the gripper assembly 100 in the diamond arrangement, in accordance with one or more implementations. As shown in FIG. 5D, the carbon fiber frame member 202 can be visible in elevation, with the suction cup mounts 152 coupling each of the first suction cup 108a, second suction cup 108b, third suction cup 108c, and fourth suction cup 108d to the frame members. The cross member 204 can extend transversely across the frame, and the mounting holes 206 can be visible at the central junction. This view can illustrate how the suction cup mounts 152 extend from the frame members and position the suction cups 108 at positions that can be offset from the plane of the frame. In some implementations, each suction cup mount 152 can include a vertical post or standoff that spaces the suction cup 108 away from the carbon fiber frame member 202 by a predetermined distance, which can provide clearance for the suction cup 108 to compress and form a seal against the panel surface without interference from the frame members. In some implementations, the standoff height can be about 10 mm, about 20 mm, about 30 mm, or about 50 mm, among others, depending on the depth of the suction cup 108 and the expected compression travel during engagement. In some implementations, the suction cup mounts 152 can include a pivot or articulation feature at the junction between the standoff and the frame member, which can allow the suction cup 108 to tilt relative to the frame when engaging non-planar surfaces.

Referring now to FIGS. 5E and 5F , illustrated are additional views of the gripper assembly 100, in accordance with one or more implementations. As shown in FIG. 5E, the support beam 106 can extend horizontally across the assembly, with the first suction cup 108a, the second suction cup 108b, and the fourth suction cup 108d mounted at spaced positions along the support beam 106 via respective suction cup mounts 208 and suction cup mounts 152. Each of the suction cup mounts 208 can include a compliant element, such as a spring, that can allow the corresponding suction cup 108 to translate vertically relative to the support beam 106. In some implementations, each suction cup mount 208 can include a coil spring disposed between the suction cup 108 body and the frame surface, with the spring set to compress when the suction cup 108 contacts the panel surface and to extend when the suction cup 108 is disengaged. The spring constant can be selected to provide sufficient compliance to accommodate surface irregularities while maintaining adequate preload to establish a vacuum seal. This compliance can enable each suction cup 108 to independently conform to local surface variations when the gripper assembly 100 is pressed against a solar panel. As shown in FIG. 5F, the gripper assembly 100 can be illustrated in a perspective view showing the carbon fiber frame member 202 with the cross member 204 extending diagonally across the frame, the mounting holes 206 positioned at the center of the frame, and the suction cup mounts 208 coupling the first suction cup 108a, the second suction cup 108b, the third suction cup 108c, and the fourth suction cup 108d to respective corners of the carbon fiber frame member 202. This arrangement can provide a stable gripping with the suction cups 108 positioned at distributed intervals along the frame perimeter. The perspective view of FIG. 5F can illustrate the three-dimensional profile of the suction cup mounts 208, showing how the compliant mounting elements project from the surface of the carbon fiber frame member 202 and position the suction cups 108 at an elevated position above the frame plane.

The use of carbon fiber for the carbon fiber frame member 202 can provide several benefits for the gripper assembly 100. Carbon fiber composite materials can exhibit a high strength-to-weight ratio, allowing the gripper assembly 100 to maintain structural integrity while minimizing overall mass. A lightweight frame construction can be advantageous in robotic systems for solar panel installation, where reducing the mass of the end effector can extend the effective reach of the robotic arm, can increase the allowable payload capacity, and can improve the dynamic response during rapid repositioning maneuvers. In some implementations, the carbon fiber frame member 202 can weigh less than a comparable frame formed from aluminum or steel while providing equivalent or greater rigidity. For example, a carbon fiber frame can weigh about 30 percent to about 70 percent less than an equivalent aluminum frame having similar bending and torsional stiffness characteristics. The reduced mass can decrease the inertial loads experienced by the rotational actuation system during frame rotation, which can allow a smaller or less powerful actuator 114 to be used while still achieving adequate rotational performance. In some implementations, the carbon fiber frame member 202 can be formed using a pultrusion process, a filament winding process, a hand layup process, or an autoclave-cured prepreg laminate process, depending on the production volume and the mechanical performance constraints of the application.

In some implementations, the gripper assembly 100 can be part of a system capable of lifting panels from pallets and positioning the panels onto mounting structures such as racking systems used in solar farm installations. The carbon fiber frame member 202 can contribute to the precision and stability of such operations by maintaining its planar geometry under load and by resisting deflection during transport and placement. The gripper assembly 100 can be incorporated into a robotic system that includes a mobile base. In some implementations, the mobile base can navigate autonomously or semi-autonomously within the installation site, using onboard navigation sensors, GPS, or pre-programmed path plans to reach the pallet location and the panel placement location.

The arrangement of the suction cups 108 in a rectangular or diamond arrangement on the carbon fiber frame member 202 can distribute contact forces across a broad area of the panel surface during gripping. This distributed contact arrangement can reduce the stress experienced at any individual suction cup 108 location, which can reduce the risk of damage to the panel during lifting and positioning operations. In some implementations, the spacing between the suction cups 108 can be selected based on the dimensions of the solar panel being retained, such that the suction cups 108 contact the panel at positions that are offset from fragile or sensitive regions of the panel. For example, the suction cups 108 can be spaced to avoid contact with the cells or busbars visible through the rear back sheet of the solar panel, or the suction cups 108 can be positioned at locations that are offset from the junction box and electrical lead regions of the panel. In some implementations, the suction cup 108 spacing can be adjustable, with the suction cup mounts 208 mounted to slotted tracks or sliding rails that allow the spacing to be modified to accommodate different panel sizes.

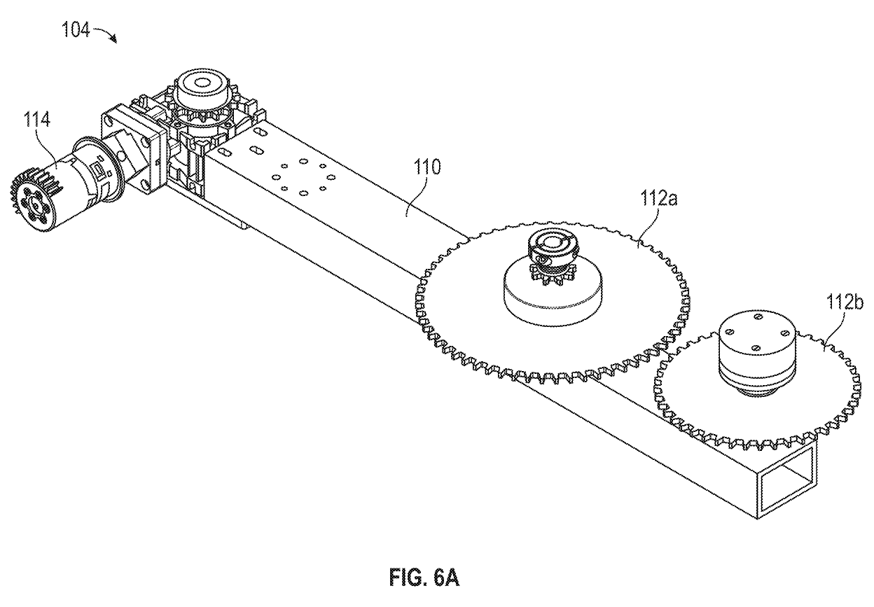

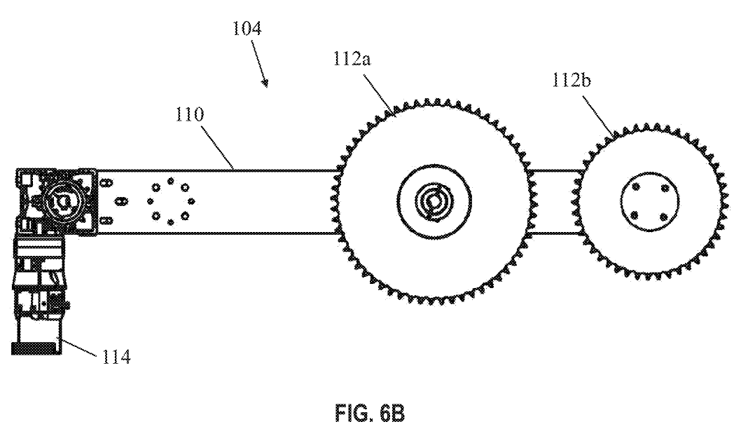

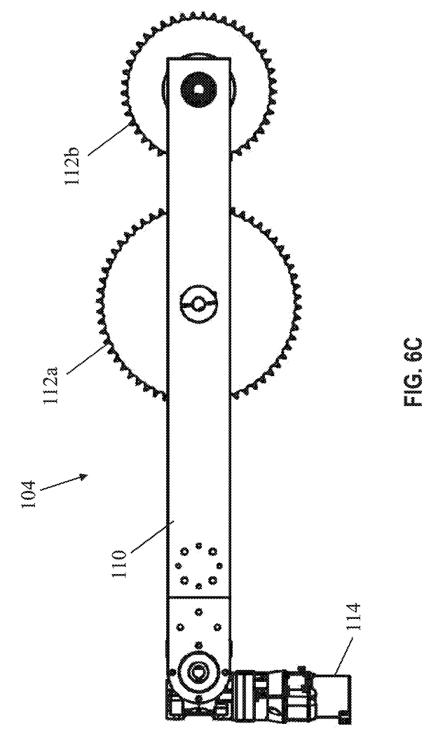

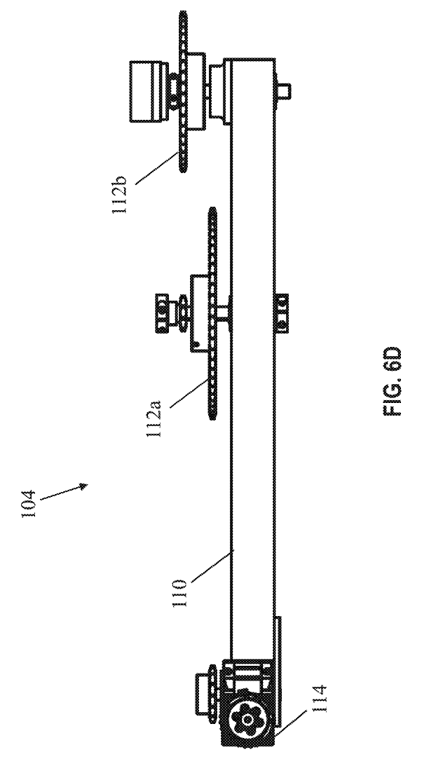

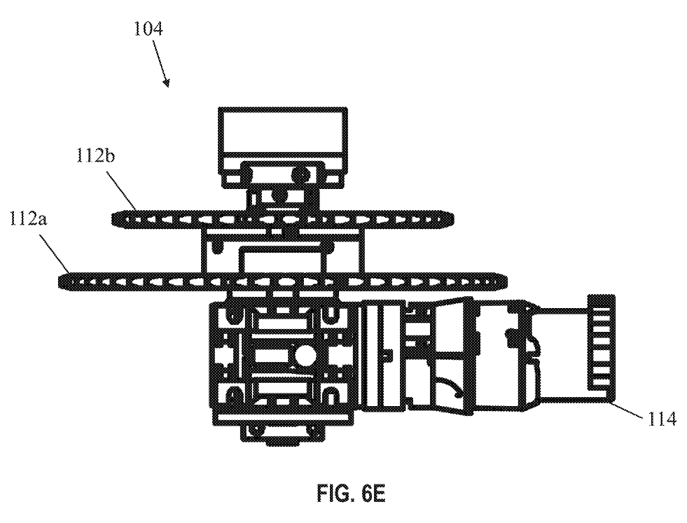

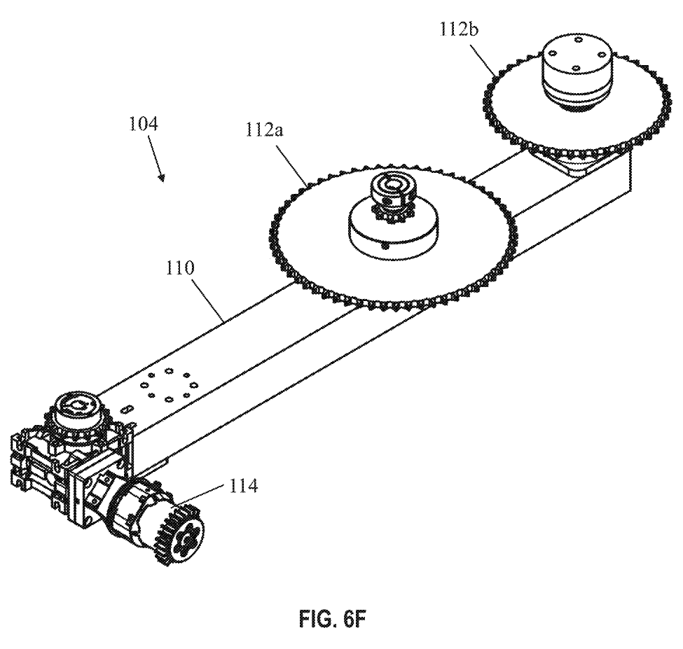

Referring now to FIGS. 6A through 6F , illustrated are various views of a rotational actuation assembly of the gripper assembly 100, in accordance with one or more implementations. The rotational actuation assembly can include the frame mounting structure 104, the member 110, the first gear 112a, the second gear 112b, and the actuator 114. These components can cooperate to provide controlled rotational motion to the frame structure 102 of the gripper assembly 100. The rotational actuation assembly can be a subassembly of the gripper assembly 100 that is preassembled and integrated with the frame structure 102, or the components of the rotational actuation assembly can be individually assembled during the fabrication of the gripper assembly 100.

As shown in FIG. 6A, the frame mounting structure 104 can extend longitudinally and can serve as a base structure for the rotational actuation assembly. The member 110 can be positioned along the length of the frame mounting structure 104 and can serve as a structural spine for the assembly. In some implementations, the member 110 can be a machined or extruded member having a planar upper surface and a planar lower surface, with mounting features such as holes, slots, or threaded inserts disposed along its length. The first gear 112a and the second gear 112b can be mounted on or along the member 110 at spaced positions. The actuator 114 can be positioned at one end of the frame mounting structure 104 and can be mechanically coupled to the gear system to provide rotational driving force. In some implementations, the first gear 112a can have a larger diameter than the second gear 112b, and both gears can include toothed perimeters for meshing engagement. The actuator 114 can include a drive gear or a drive pinion that interfaces with the first gear 112a or with an intermediate gear to transmit rotational motion. This arrangement can enable the actuator 114 to transmit torque through the gear system to cause controlled rotation of the frame structure 102. In some implementations, the first gear 112a can include a central bore or hub that is keyed or splined to a shaft by bearings in the member 110, and the second gear 112b can include a similar central bore or hub that is keyed or splined to the rotational shaft that couples to the frame structure 102. The perspective view of FIG. 6A can illustrate the three-dimensional arrangement of the gear system, including the relative heights and axial positions of the first gear 112a and the second gear 112b along the member 110.

Referring now to FIG. 6B, illustrated is a side elevational view of the rotational actuation assembly, in accordance with one or more implementations. As shown in FIG. 6B, the member 110 can extend horizontally from the actuator 114 toward the first gear 112a and the second gear 112b. The first gear 112a can be larger in diameter than the second gear 112b, and both gears can feature teeth around their respective circumferences. The first gear 112a can mesh with the second gear 112b, such that rotation of one gear causes corresponding rotation of the other gear. The gear ratio defined by the relative diameters of the first gear 112a and the second gear 112b can determine the torque multiplication and speed reduction applied to the rotational output. In some implementations, the actuator 114 can drive the first gear 112a through the member 110, and the second gear 112b can be coupled to the frame structure 102 via a rotational shaft or a coupler. The rotational shaft can extend from the second gear 112b in a direction perpendicular to the plane of the frame structure 102. In some implementations, the rotational shaft can be received by one or more bearings, such as ball bearings, roller bearings, or plain bushings, that are mounted to the member 110 or to the frame mounting structure 104. The bearings can be positioned independently of the actuator 114 such that the bearings carry the structural loads imposed by the weight of the frame structure 102 and any attached solar panel, while the actuator 114 is isolated from these structural loads and provides rotational torque. This load isolation arrangement can prolong the service life of the actuator 114 and can reduce the bearing constraints on the motor output shaft.

In some implementations, the frame structure 102 can be rotatably coupled to the frame mounting structure 104 via a chain-driven or belt-driven gear system. In such implementations, the actuator 114 can drive multiple gears via a belt, chain, or other flexible transmission element. One gear, such as the second gear 112b, can be coupled to the frame structure 102 such that the actuator 114 drives rotation of the frame structure 102 via the gear system and the flexible transmission element. For example, the second gear 112b can be coupled to the frame structure 102 via a coupler, a hub, or a keyed shaft connection that transfers rotational motion from the gear to the frame. In some implementations, the belt can be a toothed timing belt, a flat belt, a V-belt, or a poly-V belt, and the chain can be a roller chain or a silent chain. The belt-driven or chain-driven arrangement can accommodate larger center-to-center distances between the driving and driven shafts, which can provide greater flexibility in the layout of the rotational actuation assembly within the frame mounting structure 104.

In some implementations, the actuator 114 can drive the gear system through the member 110, enabling controlled rotational movement through the gear reduction provided by the different-sized gears. This arrangement can allow for precise control of the rotational speed and torque applied to the gripper assembly 100. The gear reduction can enable the gripper assembly 100 to rotate a heavy solar panel with a controlled angular velocity that permits accurate placement and alignment. In some implementations, the gear reduction can increase the holding torque at the frame structure 102, which can maintain the angular position of the frame when the actuator 114 is not energized or when external forces are applied to the grasped panel during placement.

Referring now to FIG. 6C, illustrated is another side elevational view of the rotational actuation assembly, in accordance with one or more implementations. As depicted in FIG. 6C, the member 110 can extend horizontally across the assembly, and the frame mounting structure 104 can be positioned at one end. The first gear 112a and the second gear 112b can be mounted along the member 110, with the first gear 112a having a larger diameter than the second gear 112b. Both gears can feature toothed perimeters for mechanical engagement. The member 110 can extend through or adjacent to both gears and can provide structural mount for the gear shafts and bearings. The frame mounting structure 104 can serve as a structural connection point for integrating the rotational actuation assembly with other components of the gripper assembly 100 and with the robotic arm. In some implementations, the side elevational view of FIG. 6C can illustrate the gear teeth in profile, showing the tooth geometry and the meshing interface between the first gear 112a and the second gear 112b. The tooth profile can be involute, cycloidal, or another geometry selected to minimize backlash and to provide smooth torque transfer during rotation.

Referring now to FIG. 6D, illustrated is a side elevational view of the rotational actuation assembly, in accordance with one or more implementations. As shown in FIG. 6D, the member 110 can extend horizontally across the structure, and the frame mounting structure 104 can be positioned along the lower portion of the assembly. The first gear 112a and the second gear 112b can be positioned at different locations along the member 110, with the first gear 112a situated between the actuator 114 and the second gear 112b. This view can illustrate how the second gear 112b can include or can be mounted on a hub or shaft extension that projects upward from the member 110 to couple with the frame structure 102. In some implementations, the hub or shaft extension of the second gear 112b can include a flanged plate, a keyed shaft section, or a splined interface that mates with a corresponding feature at the mounting holes 206 of the carbon fiber frame member 202. In some implementations, this arrangement can allow for rotational motion to be transmitted from the actuator 114 through the gear system along the member 110 to the frame structure 102. The arrangement can enable the rotational actuation assembly to provide controlled rotation to the gripper assembly 100, facilitating precise angular positioning of solar panels during installation.

Referring now to FIGS. 6E and 6F , illustrated are additional views of the rotational actuation assembly, in accordance with one or more implementations. As shown in FIG. 6E, the frame mounting structure 104 can be visible in an end view, with the first gear 112a and the second gear 112b arranged in a vertical arrangement. The actuator 114 can extend from the main body of the assembly. This view can illustrate how the first gear 112a and the second gear 112b can be positioned to transfer rotational motion from the actuator 114 through the gear system to the frame structure 102. In some implementations, the end view of FIG. 6E can reveal the internal structure of the frame mounting structure 104, including the mounting positions of the bearings that receive the gear shafts and the rotational shaft. The end view can illustrate the relative sizes of the first gear 112a and the second gear 112b and the vertical spacing between the two gears. As shown in FIG. 6F, a perspective view of the rotational actuation assembly can illustrate the three-dimensional spatial relationships among the member 110, the first gear 112a, the second gear 112b, and the actuator 114. The first gear 112a can be mounted on a shaft by the member 110, and the second gear 112b can include a hub or mounting flange that receives the rotational shaft extending to the frame structure 102. This arrangement can allow the rotational actuation assembly to be integrated with the carbon fiber frame member 202 of the gripper assembly 100. In some implementations, the perspective view of FIG. 6F can illustrate a mounting boss or bearing housing at the top of the second gear 112b that receives the lower end of the rotational shaft, with the upper end of the rotational shaft extending upward through the mounting holes 206 of the carbon fiber frame member 202 and being secured to the frame by a flange, a nut, or a clamp.

The rotational actuation assembly can allow for precise control of the rotational movement of the gripper assembly 100. In some implementations, the actuator 114 can be actuated to rotate the frame structure 102 of the gripper assembly 100 about an axis that passes through the mounting holes 206 of the carbon fiber frame member 202 and that is perpendicular to the plane defined by the frame structure 102. This rotation can allow for repositioning of a solar panel engaged by the plurality of suction cups 108 without requiring a change in the position or orientation of the robotic arm to which the gripper assembly 100 is attached. In some implementations, the rotational actuation assembly can include a controller or driver circuit that receives angular position commands from a supervisory control system and that generates motor drive signals to position the frame structure 102 at the commanded angle. The controller can implement closed-loop position control using feedback from a rotary encoder, a resolver, a potentiometer, or another angular position sensor coupled to the rotational shaft or to the second gear 112b. A controller of the robotic system can transmit a first control signal to a first controller of the articulated arm 500 to position the gripper assembly 100 adjacent to a solar panel, can actuate a vacuum source to couple the plurality of suction cups 108 to the solar panel, can transmit a second control signal to the first controller to position the solar panel proximate to a target location, and can transmit a third control signal to the actuator 114 of the gripper assembly 100 to rotate the solar panel to a target orientation. In some implementations, the first control signal and the third control signal can be transmitted simultaneously, such that the articulated arm 500 is moving while the actuator 114 is simultaneously rotating the panel.

The rotational actuator can rotate the frame structure 102 relative to the frame mounting structure 104 and, by extension, relative to an articulated arm 500 of a robotic system. In some implementations, the rotational actuator can rotate the frame structure 102 through any angle between negative 360 degrees and positive 360 degrees relative to the frame mounting structure 104. Illustrative rotation angles can include, but are not limited to, plus or minus 15 degrees, plus or minus 30 degrees, plus or minus 45 degrees, plus or minus 60 degrees, plus or minus 75 degrees, plus or minus 90 degrees, plus or minus 120 degrees, plus or minus 180 degrees, plus or minus 270 degrees, and plus or minus 360 degrees. In some implementations, the rotational actuator can allow for incremental rotations in less than one-degree increments, such as increments of about 0.1 degrees, about 0.5 degrees, or about 0.25 degrees, among others, providing high-resolution angular positioning. The system can be capable of continuous rotation, allowing the frame structure 102 to rotate through multiple complete revolutions for a given application. The rotational actuator can be adjustable to any angle within its operational range, providing flexibility for precise positioning of solar panels during installation. In some implementations, the rotation angle can be computed based on the orientation of the panel as picked from a pallet, the target orientation at the placement location on the racking, and the kinematic arrangement of the robotic arm. This rotation capability can facilitate aligning a rotated solar panel with a mounting structure during the installation process. In many installation scenarios, a 90-degree rotation can be performed to change the panel orientation between pickup and placement and to orient electrical leads or junction boxes of the panel in the desired direction for subsequent electrical connection. In some implementations, the rotation can be performed at a controlled angular velocity, such as about 10 degrees per second, about 30 degrees per second, about 60 degrees per second, or about 90 degrees per second, among others, depending on the speed and precision constraints of the installation process.

The integration of the rotational actuation assembly with the gripper assembly 100 can enable reorientation maneuvers during solar panel installation. In some implementations, the gripper assembly 100 can be positioned adjacent to a solar panel using an articulated arm 500. The plurality of suction cups 108 can be brought into contact with the panel surface, and the compliant suction cup mounts 152 can independently adjust to engage the solar panel surface. Once the solar panel is engaged and vacuum is established, the actuator 114 can be activated to rotate the frame structure 102, repositioning the solar panel to a desired orientation. This rotational capability can be useful when transporting the solar panel to a mounting location and aligning the panel with the mounting structure. In some implementations, rotation can occur during transport, during approach to the mounting location, or at the mounting location prior to placement. In some implementations, the rotation can be initiated while the robotic arm is simultaneously moving the gripper assembly 100 along a trajectory from the pickup location to the placement location, such that the rotation and the transport occur concurrently, which can reduce the overall cycle time for each panel installation.

The gear system, with its defined gear ratio between the first gear 112a and the second gear 112b, can allow for precise control over the rotation speed and angle of the frame structure 102. In some implementations, this precision can enable the gripper assembly 100 to rotate the frame structure 102 by 90 degrees for solar panel installation arrangements where the panel is to be reoriented between a landscape pickup orientation and a portrait installation orientation, or vice versa. In some implementations, the gear system can provide indexed rotation, in which the frame structure 102 can be rotated to one of a plurality of predefined angular positions, such as 0 degrees, 90 degrees, 180 degrees, and 270 degrees, and can be held at each indexed position by the self-locking characteristics of the gear system or by an electronic brake or detent.

The rotational actuation assembly can be part of a larger robotic system for solar panel installation. This system can include a mobile base and an articulated arm 500, with the gripper assembly 100 coupled to a distal end of the articulated arm 500 as an end effector. The integration of the rotational actuation assembly within this system can provide an additional axis of rotation at the end effector that supplements the rotational degrees of freedom provided by the joints of the articulated arm 500. In some implementations, the additional rotational axis provided by the gripper assembly 100 can relieve one or more joints of the articulated arm 500 from the task of providing final orientation adjustment, which can simplify the inverse kinematics computations and can reduce the joint range constraints of the robotic arm. This can be beneficial in constrained installation environments where the robotic arm has limited freedom of motion due to nearby obstacles, structural elements of the racking system, or adjacent solar panels that have been previously installed.

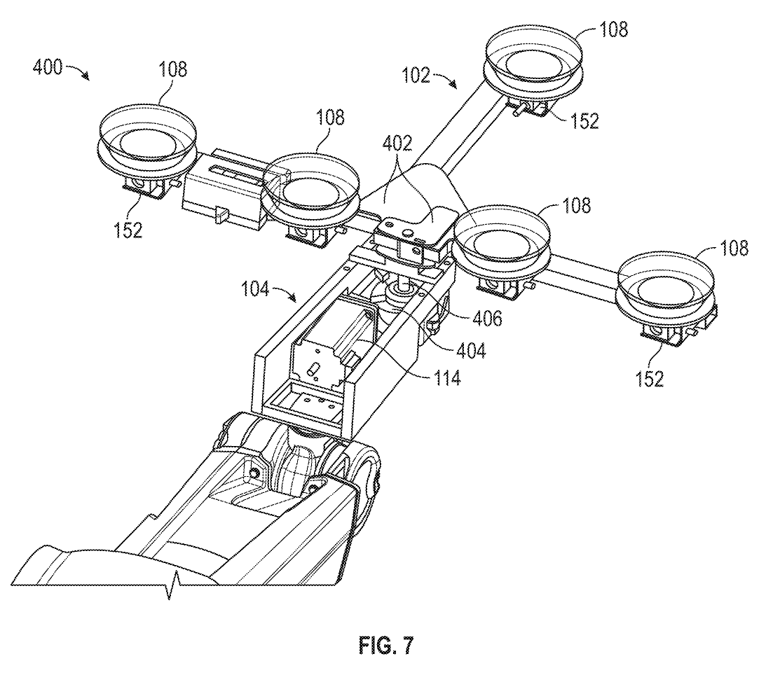

Referring now to FIGS. 7 through 10 , illustrated are various views of a gripper assembly 400 (e.g., a gripper assembly, vacuum end effector, etc.), in accordance with one or more implementations. The gripper assembly 400 can include a frame structure 102 and a frame mounting structure 104. The gripper assembly 400 can be an example of the gripper assembly 1003 and/or the gripper assembly 1003 can include the gripper assembly 400. In some implementations, the frame structure 102 can be rotatably coupled to the frame mounting structure 104. The gripper assembly 400, as well as the gripper assembly 100 and a gripper assembly 800 (e.g., a gripper assembly, vacuum engagement head, suction panel handler, etc.), can be mounted to the end of an articulated arm 500 (e.g., a robotic arm, multi-axis manipulator, etc.), such as a 6-degree-of-freedom or 7-degree-of-freedom robotic arm. In some implementations, the gripper assembly can function as an additional joint or axis at the end effector of the robot, adding extended reach and enabling various orientations that can be used for solar panel installation. By providing a rotational degree of freedom at the gripper itself, the gripper assembly 400 can enable panel reorientation without requiring the robotic arm to reconfigure its joint angles, which can simplify motion planning and can improve cycle times. In some implementations, the additional rotational degree of freedom can allow the robotic system to reach panel placement positions that would otherwise be kinematically inaccessible using the native joints of the articulated arm 500 alone.

As shown in FIG. 7, the gripper assembly 400 can include a plurality of suction cups 108 mounted to the frame structure 102. In some implementations, the plurality of suction cups 108 includes four suction cups 108. In some implementations, the plurality of suction cups 108 includes five suction cups 108. In some implementations, the plurality of suction cups 108 includes six suction cups 108. In some implementations, the plurality of suction cups 108 includes ten suction cups 108. The plurality of suction cups 108 can be arranged in a linear, radial, matrix, rectangular, triangular, or circular arrangement on the frame structure 102. In some implementations, the arrangement of the suction cups 108 can be adjustable on the frame structure 102. For example, the suction cups 108 can be mounted to sliding rails, slotted tracks, or pivoting arms that allow their positions to be modified to accommodate different panel sizes or arrangements. The gripper assembly 400 can further include a gear system and a rotational shaft 404 (e.g., a transmission, gear train, gear set, gear reduction assembly, torque transfer linkage, etc.). The gear system can be operably coupled between the actuator 114 and the rotational shaft 404, and the rotational shaft 404 can be coupled to the frame structure 102 such that rotation of the rotational shaft 404 causes corresponding rotation of the frame structure 102. The suction cup mounts 152 can be used to attach each suction cup 108 to the frame structure 102. Each suction cup mount 152 can include a port fluidly connecting the suction cup 108 to a vacuum source. The rotational shafts 402 (e.g., one or more gusset plates, reinforcing brackets, stiffening plates, triangular braces, etc.) can be coupled to the frame structure 102 to provide additional structural rigidity and alignment. In some implementations, the rotational shafts 402 can include triangular gusset plates, L-shaped brackets, or plate reinforcements that are positioned at the junction of intersecting frame members of the frame structure 102 to resist bending and to maintain the geometric relationships among the frame members under load.

The frame structure 102 can include a plurality of interconnected frame members that form a structural base for the assembly. For example, a first bar member can extend transversely from a midpoint of a second bar member, forming a T-shaped frame arrangement. The plurality of bar members can be coupled in various arrangements, such as a Y-shaped, L-shaped, cross-shaped, or polygonal frame arrangement. In some implementations, the frame structure 102 can be formed of carbon fiber. In some implementations, the frame structure 102 can be formed of aluminum, steel, a composite material, or a combination of materials. In some implementations, one or more rotational shafts 402 can be coupled to the frame structure 102. For example, the rotational shafts 402 can include plates, brackets, gussets, or other reinforcing elements. In some implementations, the rotational shafts 402 can contribute to the overall rigidity and structural alignment of the frame structure 102 with respect to the frame mounting structure 104. In some implementations, the rotational shafts 402 can maintain concentric alignment between the rotating frame structure 102 and the rotational shaft 404 of the rotational assembly. The rotational shafts 402 and the frame structure 102 can include corresponding openings that are axially aligned to receive and position the rotational shaft 404, facilitating rotational coupling and structural alignment between the frame structure 102 and the frame mounting structure 104. The frame structure 102 can be coupled to the rotational shaft 404 such that rotation of the rotational shaft 404 causes rotation of the frame structure 102.

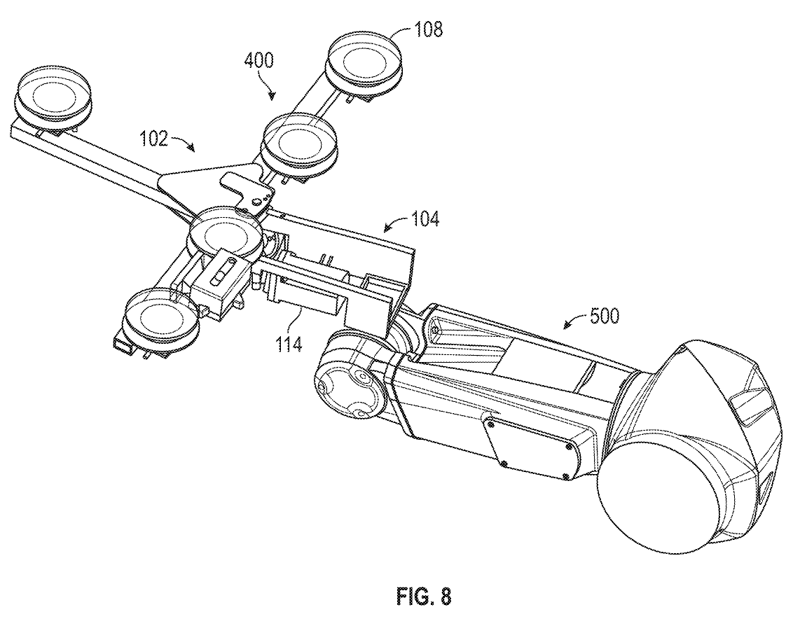

Referring now to FIG. 8, illustrated is a perspective view of the gripper assembly 400 mounted to the articulated arm 500, in accordance with one or more implementations. As shown in FIG. 8, the gripper assembly 400 can be coupled to a distal end of the articulated arm 500 via the frame mounting structure 104. The frame structure 102 can extend from the frame mounting structure 104 and can carry a plurality of suction cups 108. The actuator 114 can be visible at the junction between the frame mounting structure 104 and the articulated arm 500. This view can illustrate how the gripper assembly 400 can function as an end effector that is positioned by the articulated arm 500. The articulated arm 500 can position the gripper assembly 400 in three-dimensional space, while the rotational actuation system of the gripper assembly 400 can provide an additional rotational degree of freedom for reorienting a grasped solar panel. In some implementations, the articulated arm 500 can include six or seven rotational joints arranged in a serial kinematic chain, with the gripper assembly 400 mounted at the distal end of the chain. The combination of the joints of the articulated arm 500 and the rotational actuation system of the gripper assembly 400 can provide the robotic system with seven or eight rotational degrees of freedom in total, which can provide kinematic redundancy that allows the system to reach a given panel position and orientation through multiple joint arrangements.

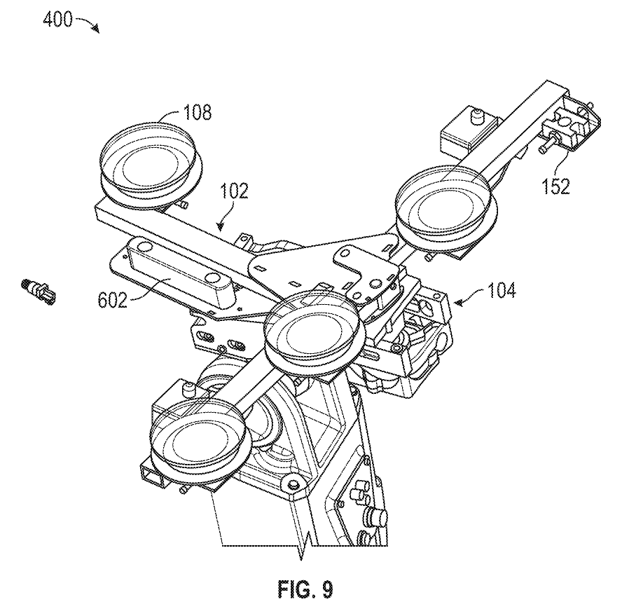

Referring now to FIG. 9, illustrated is a perspective view of the gripper assembly 400 showing sensors 602 (e.g., one or more sensors, cameras, detectors, imagers, proximity sensors, etc.), in accordance with one or more implementations. In some implementations, one or more sensors 602 can be mounted on the frame structure 102. The sensors 602 can detect the location, orientation, or surface features of a solar panel or other object. The sensors 602 can be used to guide the positioning of the gripper assembly 400 for panel pickup, alignment, and installation. In some implementations, a sensor 602 can be a camera, such as a monocular camera, a stereo camera pair, a depth camera, or a time-of-flight camera. Other types of sensors, such as LIDAR, ultrasonic, or infrared sensors, can be mounted to the frame structure 102 or the frame mounting structure 104. The sensors 602 can be used for functions including panel location detection, orientation detection, surface feature detection, crack detection, connector verification, obstacle detection, alignment assistance, and quality validation. In some implementations, the sensors 602 can detect the position and orientation of a panel's electrical leads or junction box, which can be used by a control system to determine the angle of rotation for the frame structure 102 to position the electrical leads in a desired installation orientation. For example, if the sensors 602 detect that the junction box of the panel is located at the left side of the panel as picked from the pallet, and the installation arrangement calls for the junction box to be at the bottom of the panel as placed on the racking, the control system can command the actuator 114 to rotate the frame structure 102 by 90 degrees to reorient the panel accordingly. The suction cup mounts 152 can be visible in this view, coupling the suction cups 108 to the frame structure 102.

In some implementations, the sensors 602 can be communicatively coupled to the controller 1010 via a wired connection, such as a USB, Ethernet, or serial connection, routed through the frame structure 102 and the frame mounting structure 104 to the controller 1010 on the movable base 1002. In some implementations, the sensors 602 can communicate with the controller 1010 via a wireless connection, such as a Wi-Fi, Bluetooth, or Zigbee link. The controller 1010 can process data from the sensors 602 using image recognition algorithms, machine learning models, or template-matching techniques to identify the position and orientation of the junction box and electrical leads on a solar panel.

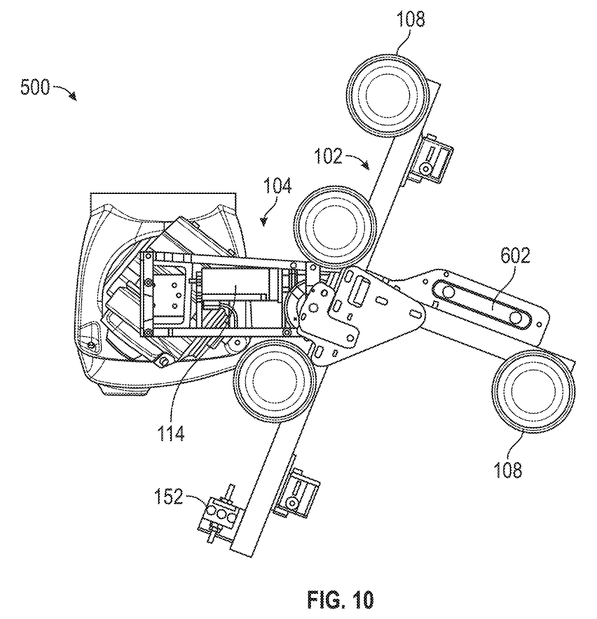

Referring now to FIG. 10, illustrated is a plan view of the gripper assembly 400 mounted to the articulated arm 500, in accordance with one or more implementations. As shown in FIG. 10, the gripper assembly 400 can be visible from above, with the frame structure 102 carrying a plurality of suction cups 108 and the sensors 602 mounted at or near a distal end of the frame structure 102. The frame mounting structure 104 can be visible between the frame structure 102 and the articulated arm 500. The actuator 114 can be positioned within or adjacent to the frame mounting structure 104. The suction cup mounts 152 can be visible at one or more locations along the frame structure 102. This plan view can illustrate the spatial distribution of the suction cups 108 across the frame structure 102 and can show how the sensors 602 can be positioned to have a field of view that faces the panel surface when the gripper assembly 400 is positioned adjacent to a solar panel for pickup. In some implementations, the sensors 602 can be positioned at a distal end of a frame member of the frame structure 102, such that the field of view of the sensors 602 is not obstructed by the suction cups 108 or by the frame mounting structure 104. In some implementations, the sensors 602 can be angled or tilted relative to the plane of the frame structure 102 to direct the sensor field of view toward the panel surface at a predetermined viewing angle.

The plurality of suction cups 108 can be fluidly connected to a vacuum system that includes one or more vacuum lines and one or more vacuum sources. In some implementations, each suction cup 108 can be attached to the frame structure 102 by a suction cup mount 152, with the suction cup 108 disposed on a first side of the frame structure 102 and the suction cup mount 152 positioned on an opposing second side. In some implementations, each suction cup mount 152 can provide a port that fluidly connects the corresponding suction cup 108 to the vacuum system. Tubing can be routed along the exterior of the gripper assembly or at least partially through the frame structure 102 or the frame mounting structure 104. In some implementations, the tubing can be secured to the frame structure 102 using clips, ties, adhesive mounts, or channels formed into the frame members, which can mitigate the tubing from interfering with the rotation of the frame structure 102 relative to the frame mounting structure 104. In some implementations, a first subset of the plurality of suction cups 108 can be fluidly coupled to a first vacuum source through a first vacuum line, and a second subset of the plurality of suction cups 108 can be fluidly coupled to a second vacuum source through a second vacuum line separate from the first vacuum line. The first vacuum line and the second vacuum line can be routed independently through or alongside the articulated arm 500 to maintain separate fluid paths from the movable base to the respective subsets of suction cups 108.

The vacuum source (e.g., vacuum source 1012, etc.) can generate negative pressure at the suction cup 108 interface to enable secure attachment to the surface of a solar panel or other object. In some implementations, the vacuum source can include a vacuum pump, such as a diaphragm pump, a piston pump, or a rotary vane pump. In some implementations, the vacuum source can include a venturi-based vacuum generator that uses compressed air to create vacuum through the Venturi effect. Control valves and pressure sensors can be disposed in-line with the vacuum circuit to regulate suction strength and to monitor for vacuum loss. Vacuum loss can indicate improper engagement of one or more suction cups 108, panel damage, or other anomalous conditions that can warrant corrective action. In some implementations, pressure regulators can be disposed in-line to set a target vacuum level at each suction cup 108 or at each group of suction cups 108, and the pressure sensors can provide real-time feedback to a control system that monitors the vacuum status during panel handling. A positive pressure source, such as a compressed air source, can be fluidly coupled to the plurality of suction cups 108 through the same fluid lines used for vacuum, such that the system can switch between a suction mode and a positive pressure mode for panel release.

In some implementations, the vacuum system can include a plurality of vacuum sources, such as multiple vacuum pumps or multiple venturi generators. Redundant vacuum sources can be used, with each source servicing a subset of the plurality of suction cups 108. In this way, loss of vacuum in one source does not disable the suction capability of the entire gripper assembly. For example, a first vacuum source can be fluidly connected to a first group of suction cups 108 disposed on one side of the frame structure 102, and a second vacuum source can be fluidly connected to a second group of suction cups 108 disposed on the opposite side of the frame structure 102. Each of the first vacuum source and the second vacuum source can be coupled to at least two suction cups 108 of the plurality of suction cups 108. Each vacuum source can be individually sufficient to provide suction to maintain coupling of the solar panel to the gripper via its respective subset of suction cups 108 independent of the other vacuum source. If the first vacuum source experiences a failure, the second vacuum source can continue to maintain vacuum at the second group of suction cups 108, mitigating the solar panel from being dropped. The controller can maintain coupling of the gripper to the solar panel through at least one of the vacuum sources in response to loss of vacuum from another of the vacuum sources. The suction cups 108 can be grouped into independently controllable zones, allowing selective activation of different suction zones based on panel size, shape, or condition. For example, when retaining a smaller panel that does not span all suction cup 108 positions, the vacuum system can activate a subset of the suction cups 108 that contact the panel surface while leaving the remaining suction cups 108 deactivated. In some implementations, three or more independently controllable vacuum zones can be provided, with each zone corresponding to a different region of the frame structure 102.

In some implementations, the frame mounting structure 104 can include an enclosure, such as a rectangular housing, formed by a plurality of sidewalls that define an internal cavity. This internal cavity can accommodate the actuation system and the rotational assembly, and can include attachment features for securing those components and for securing the gripper assembly to the articulated arm 500. The actuator 114 can be mounted to a sidewall of the frame mounting structure 104. In some implementations, the frame mounting structure 104 can include a plurality of sidewalls forming an open structure, with attachment features for mounting components and securing the gripper assembly to the articulated arm 500. The attachment features can include attachment flanges, bolt holes, recessed channels, threaded inserts, or other mechanical interfaces. In some implementations, the enclosure of the frame mounting structure 104 can be sealed or partially sealed to protect the internal components from environmental contaminants such as dust, moisture, and debris that can be present at a solar installation site. In some implementations, the enclosure can include access panels, removable covers, or inspection ports that allow maintenance and service of the internal components without removal of the frame mounting structure 104 from the articulated arm 500. The frame mounting structure 104 can be sized to provide additional height or reach that allows the robotic system to perform panel pick-and-place without overextension of the articulated arm 500.

In some implementations, in a gear-driven arrangement, the actuation system can include an actuator 114, such as a servo motor or a brushless DC motor, that is operably coupled to a gear system. A rotational shaft 404 of the gear system, such as an axle mechanically coupled to the gear output, can be coupled to the frame structure 102, allowing the motor to rotate the frame structure 102 through the gear system. In some implementations, the rotational shaft 404 can extend from the gear system in a direction perpendicular to a horizontal plane defined by the frame structure 102. In some implementations, in an alternative direct-drive arrangement, the actuator 114 can be coupled to the rotational shaft 404 without an intermediate gear system. In some implementations, the shaft of the actuator 114 can itself serve as the rotational shaft 404. In some implementations, the actuator 114 can be a high-torque motor that provides sufficient torque to rotate the frame structure 102 while carrying a solar panel. In some implementations, the actuator 114 can be a direct-drive motor that has a large-diameter rotor and stator that provide high torque at low rotational speeds without requiring an intermediate gear reduction. In the direct-drive arrangement, the elimination of intermediate gears can reduce mechanical backlash and can simplify the mechanical construction of the rotational actuation system.

In some implementations, the actuator shaft can be perpendicular to the rotational shaft 404. In some implementations, the actuator shaft can be parallel to the rotational shaft 404. The relative orientation of the actuator shaft and the rotational shaft 404 can depend on the type of gear system used. For example, a right-angle gearbox can accommodate a perpendicular relationship between the actuator shaft and the rotational shaft 404, while an in-line gearbox or a direct coupling can result in a parallel or collinear relationship. In some implementations, a right-angle gearbox can be selected to allow the actuator 114 to be oriented horizontally within the frame mounting structure 104 while the rotational shaft 404 extends vertically to the frame structure 102, which can reduce the overall height of the assembly and can provide a more compact profile.

The actuator 114 and the gear system can be disposed within the frame mounting structure 104. In some implementations, the gear system can include a worm gear. In some implementations, the actuation system can drive the frame structure 102 through a worm gear arrangement, which can provide a self-locking feature that mitigates the frame structure 102 from rotating under external loads when the actuator 114 is not energized. The self-locking characteristic of a worm gear can be advantageous for maintaining the angular position of the frame structure 102 during panel transport, when external forces such as wind loads or acceleration-induced forces tend to rotate the frame. In some implementations, the gear system can include a spur gear train. In some implementations, the gear system can include harmonic gearing. In some implementations, the gear system can include a gearbox, such as a planetary gearbox, an in-line gearbox, or a right-angle gearbox. The gearbox can be adjacent to or integrated with the actuator 114 and can receive torque from the drive shaft of the actuator 114. The rotational shaft 404 can extend from the gearbox perpendicular to a horizontal plane defined by the frame structure 102, enabling transmission of rotational motion to the frame structure 102 of the gripper assembly. The rotational shaft 404 can be within the frame mounting structure 104 and can be received by one or more bearings 406 (e.g., one or more rolling-element bearings, ball bearings, roller bearings, plain bushings, rotary bearing assemblies, etc.) that are mounted to the frame mounting structure 104 and that can be positioned independently of the actuator 114 and the gear system. In some implementations, this bearing arrangement can allow the bearings 406 to receive the mechanical loads imposed by the rotating frame structure 102, such as cantilevered weight from a mounted solar panel, while isolating the actuator 114 and the gear system from structural loading. The bearings 406 can include one or more of angular contact bearings, deep groove ball bearings, tapered roller bearings, or thrust bearings, selected based on the magnitude and direction of the loads to be received. The rotational shaft 404 can be oriented perpendicular to a plane defined by the frame structure 102 and can rotate the frame structure 102 relative to the frame mounting structure 104.

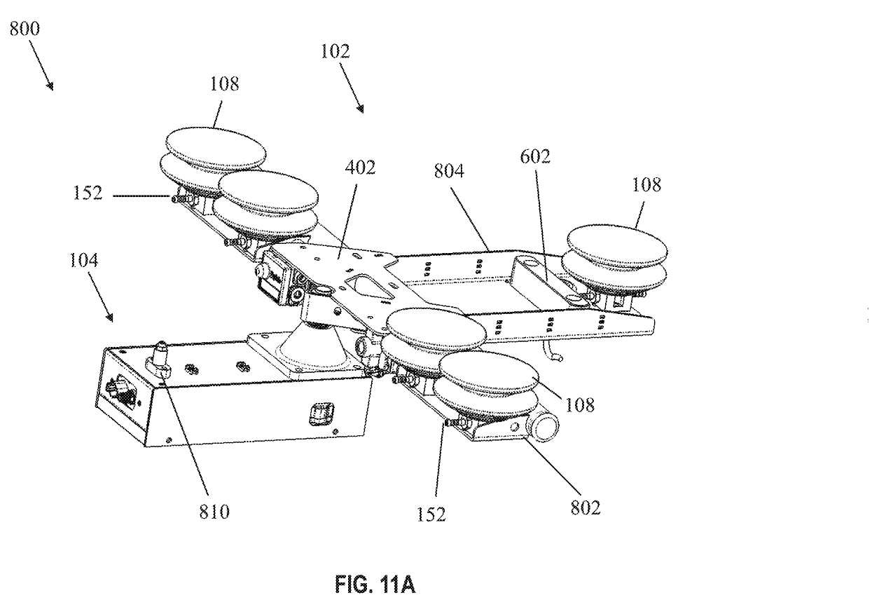

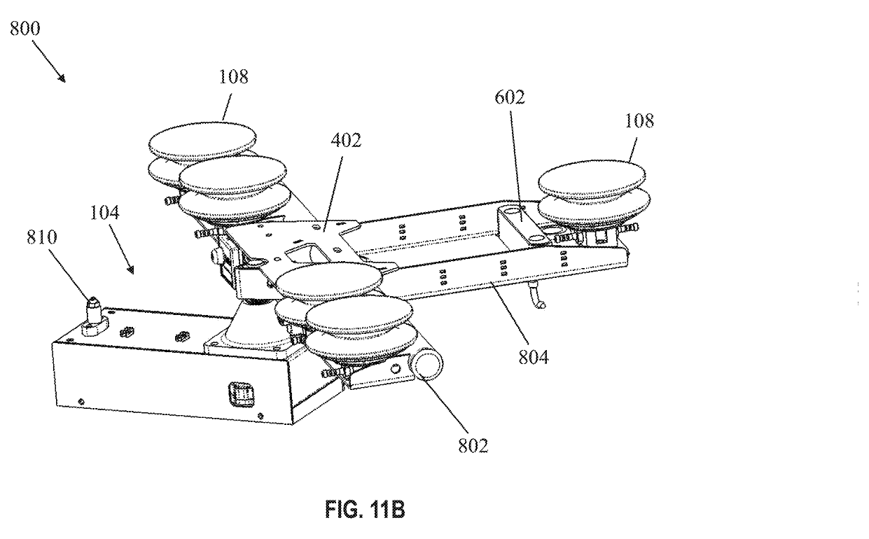

Referring now to FIGS. 11A and 11B , illustrated are perspective views of a gripper assembly 800, in accordance with one or more implementations. The gripper assembly 800 can be similar to the gripper assembly 100 and the gripper assembly 400 described herein and can include the frame structure 102 and the frame mounting structure 104. The gripper assembly 800 can be an example of the gripper assembly 1003 and/or the gripper assembly 1003 can include the gripper assembly 800. The frame structure 102 of the gripper assembly 800 can include a plurality of frame members including a first rotational shaft 802 (e.g., a first bar member, elongate rail, lateral beam, transverse frame element, etc.) and a second frame member 804 (e.g., a second bar member, tray, plate, mounting platform, perpendicular frame element, etc.). In some implementations, the frame members can have similar geometries, such as rectangular cross-sections or tubular profiles. In some implementations, the frame members can be different from one another. For example, the second frame member 804 can be a tray-like structure having a flat plate surface with raised sidewalls or flanges. In some implementations, a tray-like structure can provide a mounting surface for a sensor 602, such as a camera, LIDAR sensor, ultrasonic sensor, or infrared sensor, and can position a suction cup 108. In some implementations, the tray-like structure of the second frame member 804 can include apertures, cutouts, or recesses that receive and position the sensors 602 and the suction cups 108 at predetermined locations and orientations. The first rotational shaft 802 can be an elongate bar member that extends laterally across the gripper assembly 800 and can carry a majority of the suction cups 108, while the second frame member 804 can extend from the first rotational shaft 802 in a perpendicular direction and can carry one or more additional suction cups 108 and the sensors 602.

In some implementations, the suction cups 108 can be arranged in a T-shaped arrangement, with a first plurality of suction cups 108, such as four suction cups 108, disposed along the first rotational shaft 802 and at least one additional suction cup 108 disposed on the second frame member 804 oriented perpendicular to the first rotational shaft 802, such that the arrangement forms a T shape when viewed from above. In some implementations, the diameter of each suction cup 108 can be about 100 mm, about 125 mm, about 150 mm, or about 175 mm, among others. In some implementations, different suction cups 108 within the same gripper assembly can have different diameters, such that smaller suction cups 108 can be used in regions of the panel that have limited flat surface area, and larger suction cups 108 can be used in regions that have broader flat surfaces. The plurality of frame members can be coupled in various arrangements, such as Y-shaped, L-shaped, cross-shaped, or polygonal frame arrangements. The plurality of frame members can be formed as discrete elements coupled together to form a frame, or can be formed as a single, monolithic structure. One or more rotational shafts 402 can be coupled to the frame structure 102 at or near the junction of the first rotational shaft 802 and the second frame member 804 to reinforce the frame structure at this intersection. The suction cup mounts 152 can be visible coupling each suction cup 108 to the respective frame member.

As shown in FIGS. 11A and 11B , one or more sensors 602 can be mounted on or near a distal end of the second frame member 804. The sensors 602 can be oriented to face the panel surface when the gripper assembly 800 is positioned adjacent to a solar panel, and can capture data that is used by a control system to determine the location, orientation, and surface condition of the panel. In some implementations, the sensors 602 can include a camera that captures images of the rear surface of the solar panel, enabling the control system to identify the position and orientation of the junction box and electrical leads. The control system can use this information to determine the rotation angle for the frame structure 102 to orient the panel for installation. In some implementations, the sensors 602 can include a proximity sensor or a distance sensor that measures the distance between the gripper assembly 800 and the solar panel surface, which can be used to control the approach speed and engagement sequence of the suction cups 108. One or more sensors 810 (e.g., one or more limit sensors, position detectors, rotary encoders, magnetic switches, rotation indicators, etc.) can be mounted on the frame mounting structure 104. The sensors 810 can include rotation-limiting sensors, position feedback sensors, rotary encoders, magnetic switches, or other sensing elements that monitor the rotational position and motion of the frame structure 102 relative to the frame mounting structure 104. In some implementations, the sensors 810 can include a limit switch that is triggered when the frame structure 102 reaches a predefined maximum or minimum rotation angle, which can mitigate over-rotation and associated entanglement of vacuum lines or electrical cables.

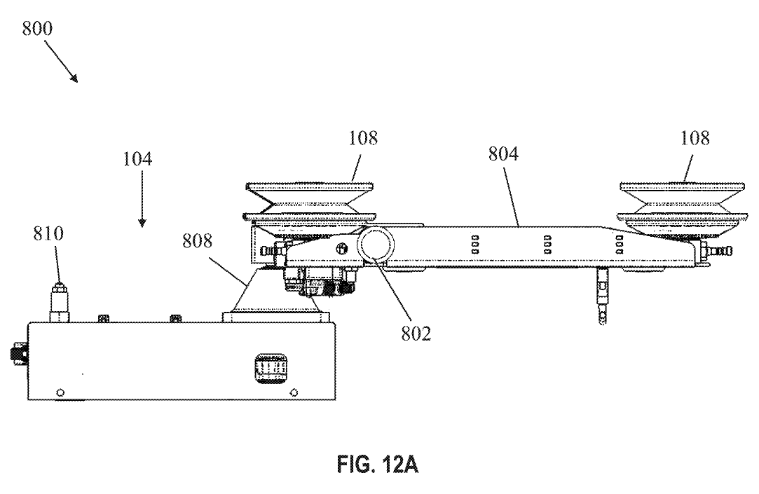

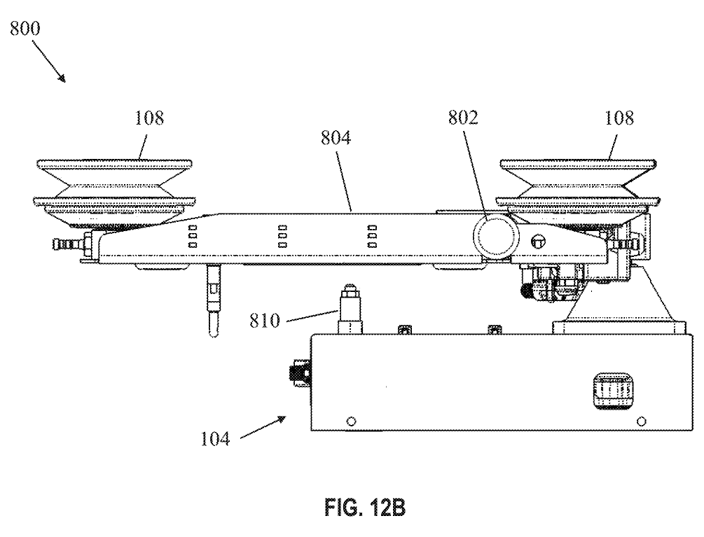

Referring now to FIGS. 12A and 12B , illustrated are side elevational views of the gripper assembly 800, in accordance with one or more implementations. As shown in FIG. 12A, the frame mounting structure 104 can be positioned below the frame structure 102, with a support 808 visible at the interface between the frame mounting structure 104 and the frame structure 102. The support 808 can include a bearing housing, a flange plate, or a rotary coupling that permits the frame structure 102 to rotate relative to the frame mounting structure 104 while maintaining structural transfer between the two assemblies. The first rotational shaft 802 can extend laterally, and the second frame member 804 can extend perpendicular to the first rotational shaft 802. The suction cups 108 can be mounted at spaced positions along the first rotational shaft 802 and the second frame member 804 via the suction cup mounts 152. The sensors 810 can be visible on the frame mounting structure 104. As shown in FIG. 12B, an opposite side view of the gripper assembly 800 can illustrate the first rotational shaft 802 and the second frame member 804 carrying the suction cups 108, with the frame mounting structure 104 providing structural mount from below. The sensors 810 can be visible on the frame mounting structure 104. These side views can illustrate the vertical profile of the gripper assembly 800 and can show how the frame structure 102 is positioned above the frame mounting structure 104 by the rotational coupling. In some implementations, the side views can illustrate the relative positions of the suction cup mounts 152 and the compliant elements that allow each suction cup 108 to self-level relative to the frame members.

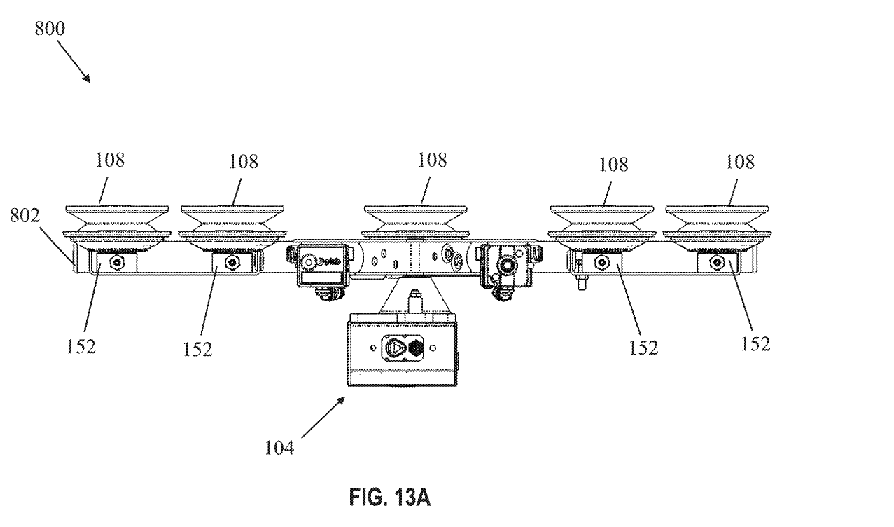

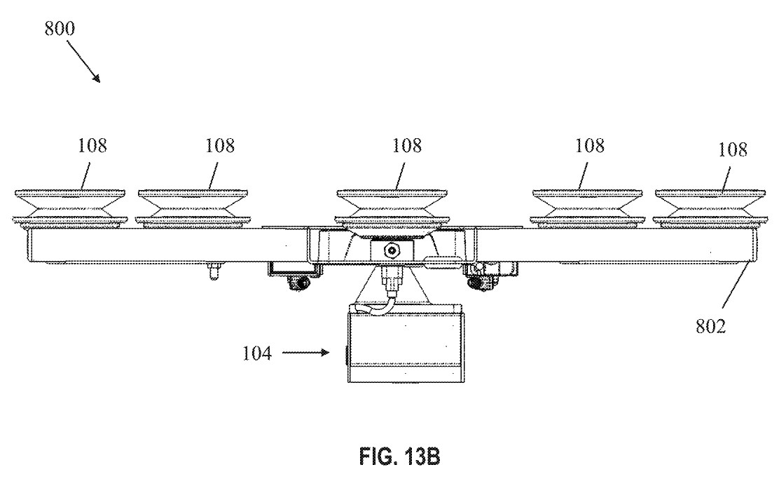

Referring now to FIGS. 13A and 13B , illustrated are front and side elevational views of the gripper assembly 800, in accordance with one or more implementations. As shown in FIG. 13A, the first rotational shaft 802 can extend laterally across the gripper assembly 800, with a plurality of suction cups 108 distributed along its length. The suction cup mounts 152 can couple each suction cup 108 to the first rotational shaft 802. The frame mounting structure 104 can be positioned at the center of the gripper assembly 800 below the first rotational shaft 802. This front view can illustrate how the suction cups 108 are distributed along the span of the first rotational shaft 802 to provide distributed gripping contact across the width of a solar panel. In some implementations, the suction cups 108 can be spaced at intervals of about 100 mm, about 150 mm, about 200 mm, or about 250 mm, among others, along the first rotational shaft 802, depending on the width of the solar panel and the number of suction cups 108 used. As shown in FIG. 13B, a side elevational view of the gripper assembly 800 can illustrate the first rotational shaft 802 extending horizontally with the suction cups 108 mounted thereon, and the frame mounting structure 104 positioned below. These views can illustrate that the gripper assembly 800 can accommodate a greater number of suction cups 108 than the gripper assembly 100 or the gripper assembly 400, which can be advantageous for retaining larger or heavier solar panels that benefit from additional gripping contact points. In some implementations, the gripper assembly 800 can include five, six, seven, eight, nine, or ten suction cups 108, with the number selected based on the panel dimensions, the panel weight, and the gripping force constraints of the application.

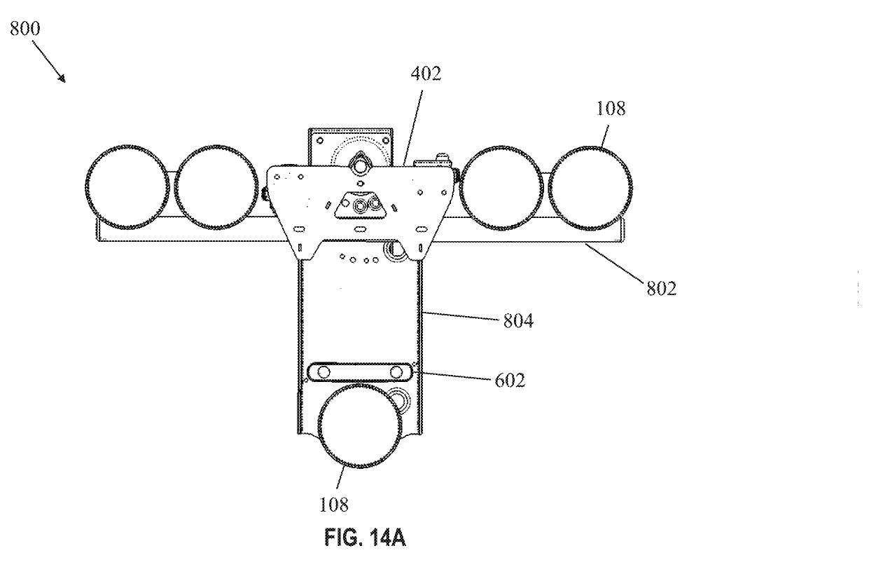

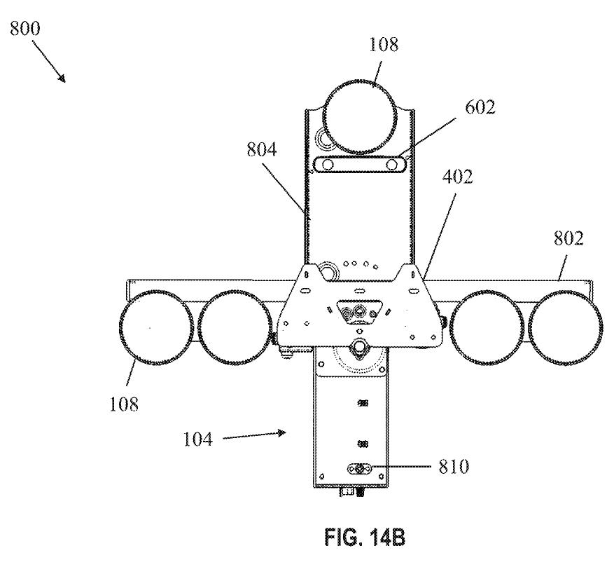

Referring now to FIGS. 14A and 14B , illustrated are plan views of the gripper assembly 800, in accordance with one or more implementations. As shown in FIG. 14A, the gripper assembly 800 can be visible from above, with the first rotational shaft 802 extending horizontally and the second frame member 804 extending downward from the first rotational shaft 802 in a perpendicular direction, forming the T-shaped arrangement. A plurality of suction cups 108 can be distributed along the first rotational shaft 802, and at least one additional suction cup 108 can be positioned on the second frame member 804. The rotational shafts 402 can be visible at the junction of the first rotational shaft 802 and the second frame member 804. The sensors 602 can be visible at or near a distal end of the second frame member 804. As shown in FIG. 14B, another plan view of the gripper assembly 800 can illustrate the first rotational shaft 802 and the second frame member 804 with the suction cups 108, the sensors 602, the rotational shafts 402, and the frame mounting structure 104 visible below the frame structure 102. The sensors 810 can be visible on the frame mounting structure 104. These plan views can illustrate how the T-shaped frame arrangement can position suction cups 108 across both the first rotational shaft 802 and the second frame member 804, providing gripping contact in two perpendicular directions relative to the center of the frame. This T-shaped arrangement can distribute gripping forces across a larger area of the panel surface and can provide improved resistance to rotation or shifting of the panel relative to the frame structure 102 during transport. In some implementations, the T-shaped arrangement can provide gripping contact at positions that are closer to the junction box or electrical lead region of the solar panel via the suction cups 108 mounted on the second frame member 804, which can provide a more stable grip in the vicinity of rear-surface protrusions.

In some implementations, the gripper assembly 800 can orient the electrical leads of a grasped solar panel for installation and electrical connection. For example, the sensors 602 mounted on the frame structure 102 can detect the location, orientation, or surface features of the solar panel, including the position of the junction box and electrical leads. The sensors 602 can be used to guide the positioning of the gripper assembly for panel pickup, alignment, and installation. The rotational actuator can rotate the frame structure 102 to reposition a solar panel engaged by the plurality of suction cups 108, facilitating the orientation of electrical leads during the installation process. In some implementations, actuating the motor can include rotating the frame structure 102 by 90 degrees to orient the electrical leads in a desired arrangement. The rotation capability can enable aligning the solar panel with the mounting structure such that the electrical leads are positioned for subsequent electrical connection. In some implementations, the sensors 602 mounted on the second frame member 804 can be positioned to have a field of view that encompasses the junction box region of the solar panel, enabling the control system to determine the angular position of the electrical leads relative to the frame structure 102 before and after rotation.

One or more sensors 810, such as rotation-limiting sensors, position feedback sensors, rotary encoders, or magnetic switches, can be used to monitor the rotational motion of the frame structure 102 and to detect when the rotating frame approaches a predefined rotational limit. For example, a sensor 810 can be mounted to the frame mounting structure 104 and can generate a signal when the frame structure 102 reaches a predetermined angular position. In some implementations, the sensors 810 can mitigate entanglement of vacuum lines and electrical cabling that extend between the frame structure 102 and the frame mounting structure 104 or between the gripper assembly and the robotic arm. By detecting when the frame structure 102 approaches a rotational limit, the sensors 810 can provide a signal to a control system that causes the actuator 114 to stop or reverse rotation before the vacuum lines or electrical cables become twisted or entangled. In some implementations, the sensors 810 can provide rotational position feedback that can be used by the control system to determine the current angular orientation of the frame structure 102 relative to the frame mounting structure 104, which can be used for closed-loop rotational position control. In some implementations, the sensors 810 can include a rotary encoder coupled to the rotational shaft or to one of the gears of the gear system, providing continuous angular position data with a resolution of about 0.1 degrees or finer. In some implementations, the sensors 810 can include a pair of magnetic switches or Hall effect sensors positioned at predetermined angular positions on the frame mounting structure 104, with corresponding magnets mounted on the frame structure 102 or on the rotational shaft, such that the sensors generate signals when the magnets pass through the sensor detection zones during rotation.

In some implementations, the sensors 810 can transmit a digital or analog signal to the controller 1010 that represents the current angular position of the frame structure 102. The controller 1010 can compare the current angular position to a commanded angular position and can generate a correction signal to, for example, the actuator 114 to reduce the difference between the current angular position and the commanded angular position. This closed-loop feedback arrangement can provide precise angular positioning of the frame structure 102 during panel rotation.

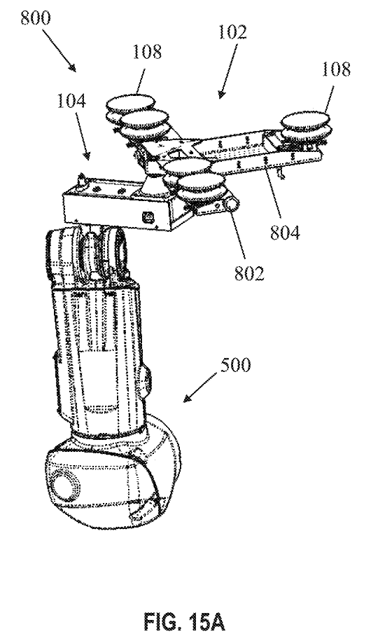

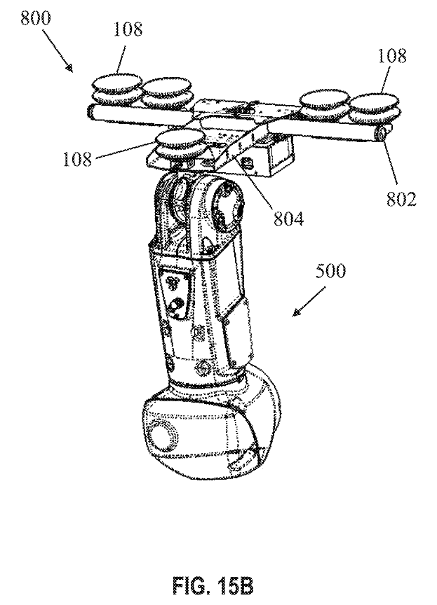

Referring now to FIGS. 15A and 15B , illustrated are perspective views of the gripper assembly 800 mounted to the articulated arm 500, in accordance with one or more implementations. As shown in FIG. 15A, the gripper assembly 800 can be coupled to a distal end of the articulated arm 500 via the frame mounting structure 104. The frame structure 102 can include the first rotational shaft 802 and the second frame member 804, with the suction cups 108 distributed along both frame members. The articulated arm 500 can position the gripper assembly 800 in three-dimensional space during panel pickup and placement operations. As shown in FIG. 15B, another perspective view can illustrate the gripper assembly 800 mounted to the articulated arm 500 from a different vantage point, showing the first rotational shaft 802 carrying the suction cups 108 and the second frame member 804 extending from the junction region. The articulated arm 500 can include multiple rotational joints that collectively provide six or seven degrees of freedom for positioning the gripper assembly 800. The rotational actuation system of the gripper assembly 800 can provide an additional degree of freedom beyond the native joints of the articulated arm 500, which can extend the range of panel orientations that can be achieved at the placement location. In some implementations, the views of FIGS. 15A and 15B can illustrate the gripper assembly 800 in an orientation in which the suction cups 108 face upward, downward, or laterally, demonstrating the ability of the articulated arm 500 to orient the gripper assembly 800 in a variety of poses for approaching and engaging solar panels stored on pallets or positioned on racking structures at various angles.

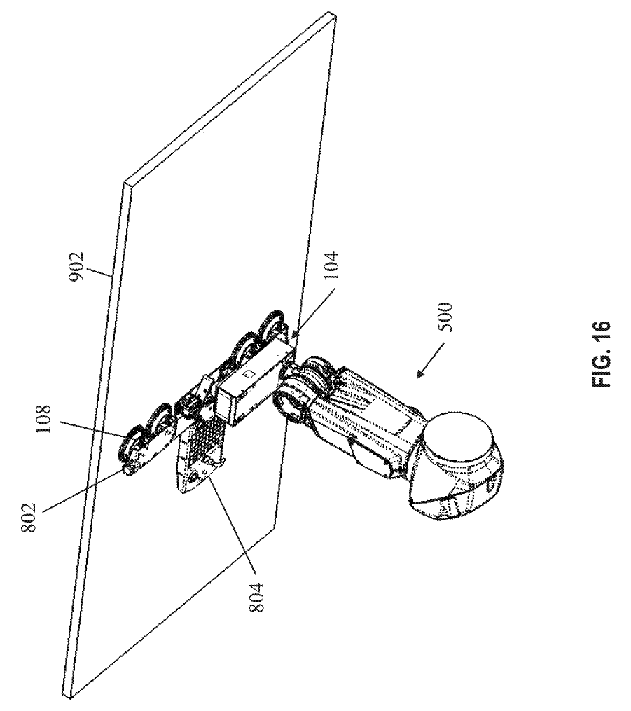

Referring now to FIG. 16, illustrated is a perspective view of the gripper assembly 800 engaged with a solar panel 902, in accordance with one or more implementations. As shown in FIG. 16, the articulated arm 500 can retain the gripper assembly 800, which can include the first rotational shaft 802 and the second frame member 804 carrying a plurality of suction cups 108. The suction cups 108 can be in contact with a surface of the solar panel 902, maintaining a vacuum seal that retains the solar panel 902 against the frame structure 102. The frame mounting structure 104 can be visible at the junction between the frame structure 102 and the articulated arm 500. In some implementations, the gripper assembly 800 can grasp the rear surface (e.g., non-active surface, underside, first surface 1902, etc.) of the solar panel 902 rather than the front photovoltaic surface. Grasping the rear surface can avoid contact with the photovoltaic cells, which can reduce the risk of contamination, scratching, or micro-damage to the active light-receiving surface.

This view illustrates how the solar panel 902 can be held at an angle relative to vertical, demonstrating the ability of the gripper assembly and the articulated arm 500 to retain and transport the solar panel 902 in various orientations during installation. The articulated arm 500 can position the gripper assembly and the engaged solar panel 902 adjacent to a mounting structure, and the rotational actuation system of the gripper assembly can rotate the frame structure 102 to achieve the desired angular orientation of the solar panel 902 prior to placement. In some implementations, the solar panel 902 can be rotated during transport from the pickup location to the placement location, such that the solar panel 902 arrives at the placement location in the desired orientation and can be placed without additional rotation. In some implementations, the compliant suction cup mounts 152 can maintain secure engagement with the rear surface of the solar panel 902 despite rear-surface irregularities such as junction boxes, electrical leads, connectors, label stickers, or uneven back sheet textures.

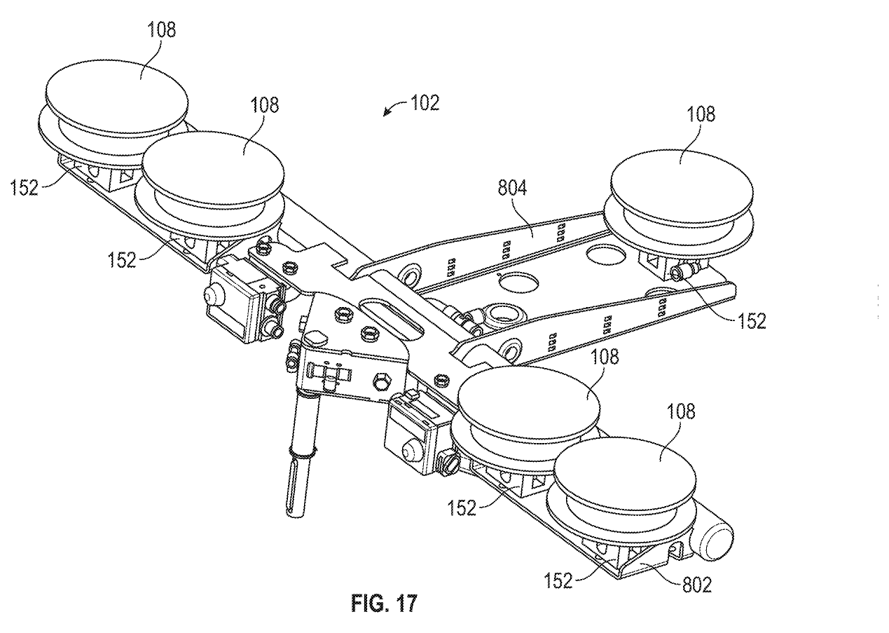

Referring now to FIG. 17, illustrated is a perspective view of a gripper assembly (e.g., gripper assembly 1003, 100, 400, and/or 800), in accordance with one or more implementations. As shown in FIG. 17, the frame structure 102 can include the first rotational shaft 802 and the second frame member 804 in a T-shaped arrangement. A plurality of suction cups 108 can be distributed across the first rotational shaft 802 and the second frame member 804, with each suction cup 108 coupled to the respective frame member via a suction cup mount 152. This view can illustrate additional detail of the suction cup mounts 152 and the mechanical interface between each suction cup 108 and the frame structure 102. In some implementations, the suction cup mounts 152 can include vertical posts, spring-loaded mounts, ball-joint connectors, or other compliant structures that allow each suction cup 108 to independently adjust its orientation and height relative to the frame structure 102. In some implementations, each suction cup mount 152 can include a vacuum fitting or port that provides a sealed fluid connection between the suction cup 108 and a vacuum line routed along the frame structure 102. The T-shaped frame arrangement shown in FIG. 17 can distribute the suction cups 108 across two perpendicular axes, which can provide improved gripping stability and can resist tilting of the grasped panel during rotation and transport. In some implementations, the perspective view of FIG. 17 can illustrate five suction cups 108, with three suction cups 108 disposed along the first rotational shaft 802 and two suction cups 108 disposed along the second frame member 804. In some implementations, the suction cups 108 on the second frame member 804 can be positioned at locations that correspond to regions of the solar panel that are offset from the junction box, such that the suction cups 108 maintain a secure grip without interfering with the junction box or its electrical leads.

In some implementations, the gripper assembly can perform offset picking of solar panels. Offset picking can refer to grasping a solar panel at a position that is offset from the geometric center or center of mass of the panel. By grasping the solar panel at an off-center location, the gripper assembly can achieve a greater effective reach for the robotic arm, can improve the kinematic feasibility of certain pick-and-place trajectories, can facilitate extraction of panels from pallets, can provide a wider placement envelope, and can enable improved approach and release trajectories at the mounting location. The offset picking capability can be useful when the robotic arm has limited reach or when panels are arranged on a pallet in an arrangement that constrains the accessible gripping locations. In some implementations, offset picking can allow the gripper assembly to pick a panel from a pallet position that is near the edge of the pallet, where a centered grip would require the robotic arm to extend beyond its reachable workspace. In some implementations, the offset between the center of the gripper assembly and the center of the panel can be about 50 mm, about 100 mm, about 200 mm, about 300 mm, or about 500 mm, among others, depending on the panel dimensions and the operational constraints of the robotic system.

In some implementations, the gripper assembly can grasp the back surface of a solar panel for installation. The front surface of the solar panel can include the photovoltaic cells that capture sunlight and convert it into electrical energy, and can be covered by a protective glass or transparent layer to maximize light absorption. The back surface of the solar panel, in contrast, can include a protective back sheet, a junction box, and electrical leads or connectors for routing the generated electrical current. Because the front surface is the active energy-generating side of the panel, it can be desirable to avoid contact with the front surface during handling to mitigate damage, soiling, or obstruction that could reduce the panel's efficiency. Grasping the back of the solar panel can avoid contact with the photovoltaic surface, can reduce the risk of contamination or scratching, can preserve panel efficiency, and can allow the front surface to remain exposed during the placement operation. In some implementations, grasping the back surface can allow visual inspection sensors mounted on the gripper assembly to view the front surface of the panel during or after placement, which can enable quality verification without additional handling steps.

The suction cup mounts 152 can incorporate a degree of flexibility or adjustability, allowing the suction cups 108 to move and adjust their positions relative to the frame structure 102. This adjustability can allow the suction cups 108 to accommodate variations in the back surface of solar panels being gripped. In some implementations, the suction cup mounts 152 can include articulation points or flexible joints that permit limited movement in multiple directions, allowing each suction cup 108 to independently adjust its level and orientation when engaging the back of the panel. This adaptability can be beneficial when retaining solar panels that do not have flat or uniform rear surfaces due to the presence of junction boxes, electrical leads, adhesive pads, or other protrusions. The independent adjustment of each suction cup 108 can distribute the gripping force across the back panel surface, which can reduce the risk of damage to sensitive solar panel components during grasping and installation. Because the rear surface can include junction boxes and electrical leads, the adjustable and compliant suction cup mounts 152 can maintain distributed gripping force without damaging panel components by allowing each suction cup 108 to conform to the local surface topology at its respective mounting location. In some implementations, the compliance range of the suction cup mounts 152 can be sufficient to accommodate rear-surface protrusions of up to about 10 mm, about 20 mm, about 30 mm, or about 40 mm, among others, in height, depending on the type and arrangement of the junction box and other rear-surface features of the panel.

In some implementations, the gripper assembly can validate a solar panel prior to or during grasping for installation. For example, one or more sensors can detect surface features of the solar panel, including detecting cracks, verifying connector integrity, and assessing overall panel condition. In some implementations, the sensor can be a camera that captures images of the panel surface for visual inspection and validation. Other types of sensors, such as LIDAR, ultrasonic, or infrared sensors, can be employed for obstacle detection and avoidance, as well as for assessing panel surface conditions during the grasping operation. Control valves and pressure sensors disposed in-line with the vacuum circuit can be used to monitor for vacuum loss, which can indicate panel damage, cracks, or improper engagement by the suction cups 108. The suction cups 108 can be grouped into independently controllable zones, allowing selective activation of different suction zones based on panel size, shape, or condition detected during validation. For example, if a sensor detects a crack or damage to a portion of the panel surface, the corresponding suction zone can be deactivated to avoid contact with the damaged area, while the remaining zones can maintain engagement with the undamaged portions of the panel. In some implementations, the validation can include verifying that the vacuum level at each active suction zone meets a minimum threshold, which can confirm that each suction cup 108 has achieved a proper seal against the panel surface. In some implementations, if the vacuum level at one or more suction cups 108 falls below the threshold, the control system can generate an alert, can adjust the position of the gripper assembly to reestablish the seal, or can abort the pick operation to mitigate panel damage or dropping.

Although suction cups 108 are shown and described in the various embodiments herein, the gripper assembly is not limited to suction-based gripping. Other means of gripping can be implemented. For example, the gripper assembly can include mechanical clamping elements, such as toggle clamps, spring-loaded grippers, or pneumatic clamps, that mechanically grip the edges or surface of a solar panel. In some implementations, the gripper assembly can include adhesive pads or gecko-inspired adhesive surfaces that provide adhesion to the panel surface without requiring vacuum. In some implementations, the gripper assembly can include a combination of suction cups 108 and mechanical clamps, such that the suction cups 108 provide primary gripping force and the mechanical clamps provide supplemental retention. These and other object engagement structures can be suitable for retaining a solar panel or other planar object against the frame structure 102 during manipulation and transport.

Although the gripper assembly is described herein with reference to solar panel handling and installation, the assembly can be used for a variety of other applications involving handling of other objects. For example, the gripper assembly can accommodate varying object geometries, weights, or surface materials. The gripper assembly can be used in the installation or handling of glass panes, architectural panels, composite sheets, insulating panels, sheet metal, electronic display panels, large planar manufactured parts, and fragile construction materials. The rotational actuation system, the compliant suction cup mounts 152, and the lightweight frame construction described herein can be adapted for use with these and other objects that benefit from distributed, low-stress gripping and precise rotational repositioning during automated handling operations. In some implementations, the gripper assembly can be used in manufacturing environments for transferring sheet goods between production stations, in warehousing environments for palletizing and depalletizing planar objects, or in construction environments for positioning facade panels, curtain wall elements, or roofing materials. The rotational capability of the gripper assembly can provide an additional degree of manipulation freedom that can simplify the handling of planar objects that are to be reoriented during transfer from one location to another.

### C.Solar Panel Mounting and Installation

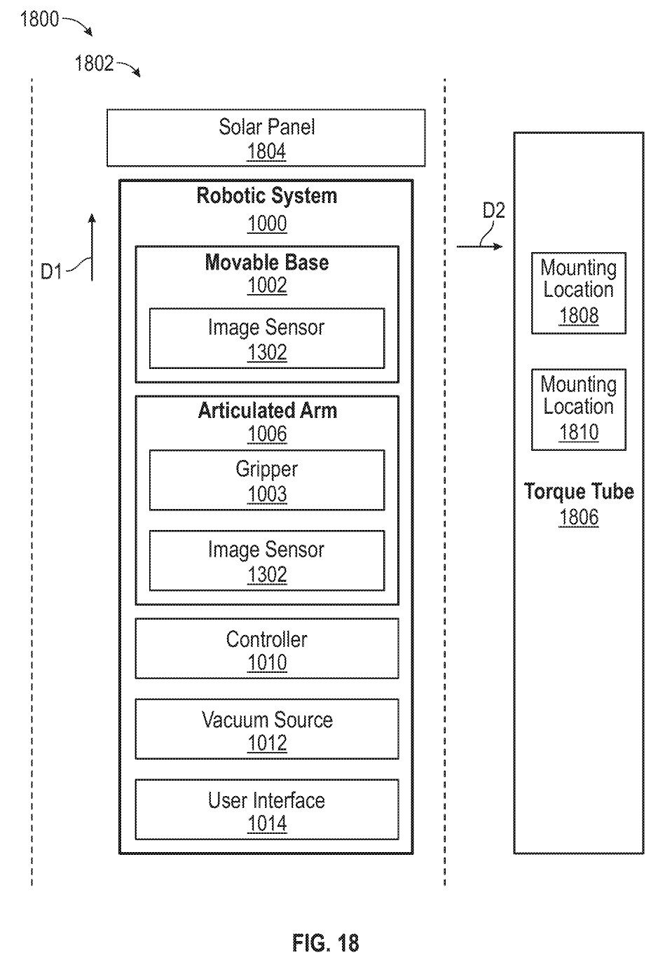

Referring now to FIGS. 18-23,18, illustrates a schematic diagram of the robotic system 1000 operating within an environment 1800 (e.g., a solar installation site, field, array zone, deployment area, etc.) for solar panel installation, in accordance with one or more implementations. FIG. 18 can depict the spatial relationships among the robotic system 1000, a solar panel 1804 (e.g., a photovoltaic panel, solar module, solar cell laminate, photovoltaic sheet, etc.), a torque tube 1806 (e.g., a racking tube, structural tube, cylindrical rail, longitudinal racking member, etc.), and a plurality of mounting locations on the torque tube 1806, as well as the directions of travel and lateral placement that characterize the pick-and-place operations performed by the robotic system 1000. As shown in FIG. 18, the environment 1800 can include a row 1802 (e.g., a lane, corridor, passage, travel path between racking structures, etc.) through which the robotic system 1000 travels, the torque tube 1806 positioned lateral to (e.g., along, etc.) the row 1802, a first mounting location 1808 (e.g., a first panel seat, first placement position, first receiving station, first racking slot, etc.) on the torque tube 1806, and a second mounting location 1810 (e.g., a second panel seat, second placement position, second receiving station, second racking slot, etc.) on the torque tube 1806 proximate to the first mounting location 1808. A first direction D1 can represent the travel direction of the movable base 1002 along the row 1802, and a second direction D2 can represent a lateral placement direction that is transverse to the first direction D1.

The movable base 1002 can navigate along the first direction D1 through the row 1802 of the environment 1800 to position the robotic system 1000 relative to successive solar panels 1804 that are staged ahead of the robotic system 1000 in the row 1802. The first direction D1 can correspond to a longitudinal axis of the row 1802, such as a south-to-north direction or a north-to-south direction. The movable base 1002 can remain oriented along the first direction D1 during coupling of the gripper assembly 1003 to the solar panel 1804 and during movement of the solar panel 1804 to the mounting location 1808 or the mounting location 1810 on the torque tube 1806. That is, the movable base 1002 does not turn left or right during a pick-and-place cycle, and the body of the movable base 1002 can extend along the first direction D1 throughout the cycle (e.g., traveling down and placing solar panels 1804 along the row 1802, etc.).

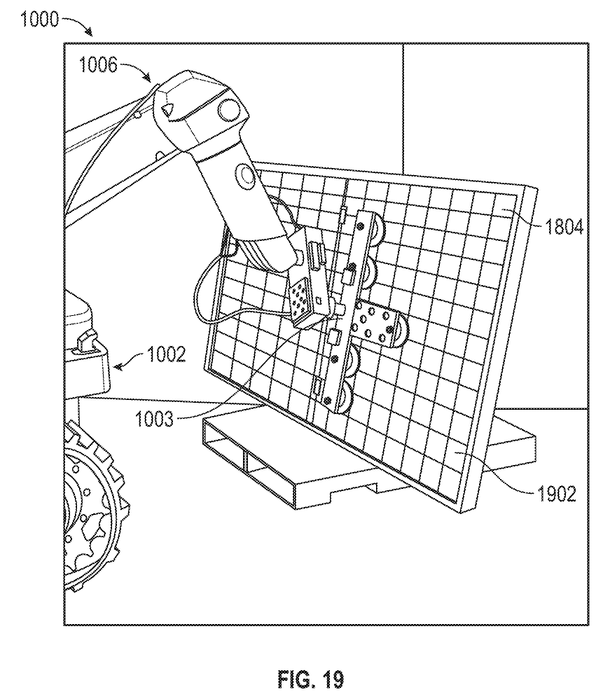

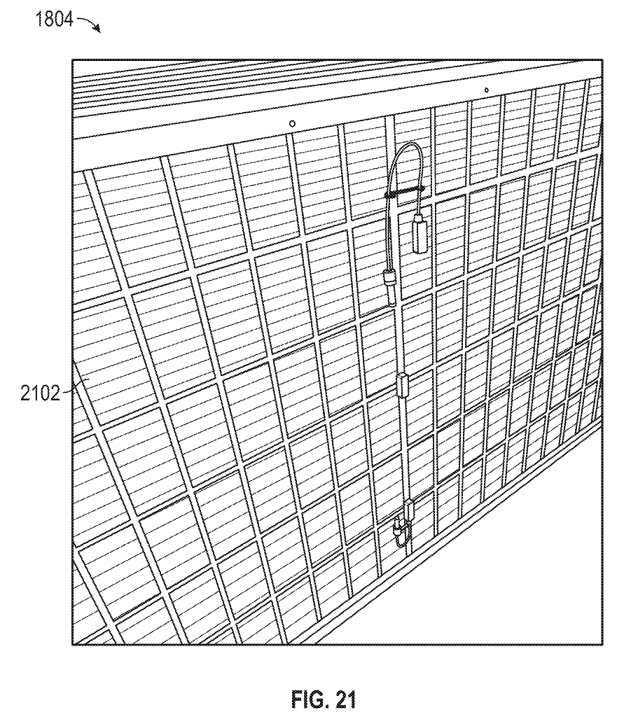

The articulated arm 1006 can be mounted toward a front portion of the chassis 1301 of the movable base 1002, which can position the articulated arm 1006 to reach forward along the first direction D1 and to engage solar panels 1804 that are staged ahead of the robotic system 1000 in the row 1802. As shown in FIG. 19, the gripper assembly 1003 can engage a first surface 1902 (e.g., an underside face, rear surface, non-active surface, back sheet surface, bottom surface, etc.) of the solar panel 1804. The first surface 1902 of the solar panel 1804 can be an underside of the solar panel 1804, which can be a non-active surface of the solar panel 1804. Referring now to FIG. 21, the solar panel 1804 can include a second surface 2102 (e.g., a topside face, front surface, active surface, photovoltaic surface, light-receiving surface, etc.) opposite the first surface 1902. The second surface 2102 can be an active surface or photovoltaic surface of the solar panel 1804 that receives sunlight. The second surface 2102 can include photovoltaic cells covered by a protective glass or transparent layer.

Coupling to the first surface 1902, as depicted in FIG. 19, can avoid physical contact between the suction cups of the gripper assembly 1003 and the second surface 2102 of the solar panel 1804. Contact with the second surface 2102 during gripping and transport can introduce surface contamination such as dust, oils, or residue from the suction cup material, which can reduce the light transmittance of the protective layer and decrease the energy conversion efficiency of the photovoltaic cells. Contact with the second surface 2102 can introduce scratching or microcracking of the protective glass layer, which can degrade the structural integrity of the panel and reduce the operational lifespan of the photovoltaic cells. By engaging the first surface 1902, as shown in FIG. 19, the gripper assembly 1003 can retain the solar panel 1804 without contacting or occluding the second surface 2102 throughout the pick, transport, and placement phases of the installation cycle.

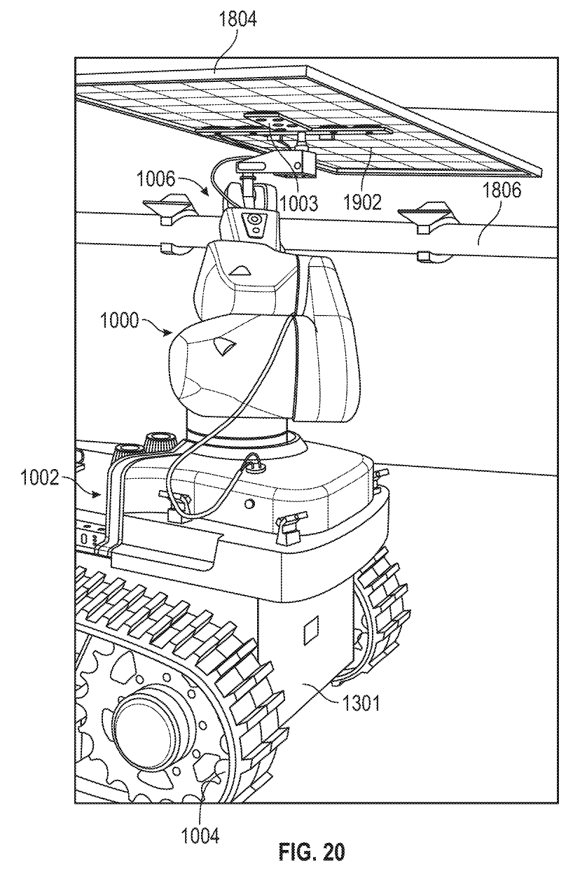

In some implementations, the first surface 1902 can include rear-surface features such as a junction box, electrical leads, adhesive pads, or label stickers, and the compliant suction cup mounts of the gripper assembly 1003 can independently conform to these rear-surface features to distribute gripping force across the first surface 1902 and reduce localized stress concentrations on the solar panel 1804. As shown in FIG. 20, the solar panel 1804 can ride above the gripper assembly 1003 during transport from the staging location to the mounting location 1808 or the mounting location 1810 on the torque tube 1806. FIG. 20 can depict the robotic system 1000 carrying the solar panel 1804 with the gripper assembly 1003 positioned beneath the solar panel 1804 and the articulated arm 1006 extending upward from the movable base 1002 toward the torque tube 1806. This arrangement, in which the solar panel 1804 is positioned above the gripper assembly 1003, can permit the articulated arm 1006 to swing the solar panel 1804 to a left side (e.g., first side, etc.) or a right side (e.g., second side opposite first side, etc.) of the movable base 1002 and lower the solar panel 1804 onto the torque tube 1806 without the gripper assembly 1003 passing over or above the solar panel 1804 during the lateral movement.

The underhand engagement can expose the second surface 2102 of the solar panel 1804 to the image sensors 1320 and/or the image sensors 1302 during transport in at least one pose of the articulated arm 1006, which can allow the controller 1010 to obtain image data of the second surface 2102 for visual inspection or quality verification while the solar panel 1804 is coupled to the gripper assembly 1003, without additional handling steps or repositioning of the solar panel 1804. In some implementations, the underhand engagement can provide a gravitational bias in which the weight of the solar panel 1804 acts downward against the suction cups of the gripper assembly 1003, which can augment the vacuum-based coupling force and reduce the vacuum level that the vacuum source 1012 provides to maintain secure retention of the solar panel 1804 during transport.

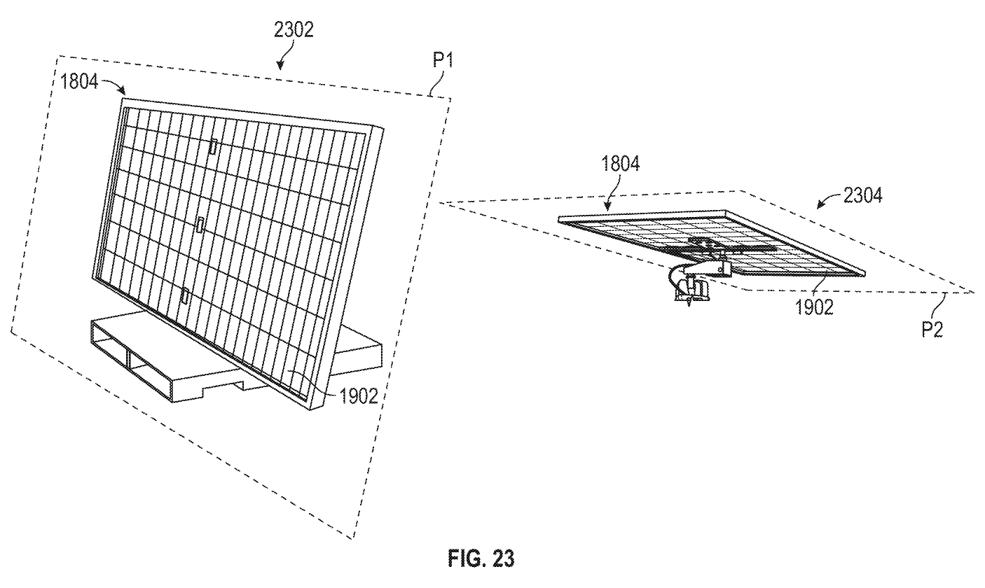

Referring now to FIG. 23, the solar panel 1804 can be staged ahead of the robotic system 1000 in the row 1802 along the first direction D1. The solar panel 1804 can be in a first orientation 2302 (e.g., a staged pose, initial angular position, pickup orientation, pre-engagement pose, etc.) relative to the body of the movable base 1002 when staged. As shown in FIG. 23, the first orientation 2302 can correspond to the solar panel 1804 extending along a first plane P1, such as a semi-vertical or upright plane that is substantially perpendicular to the first direction D1. That is, the first surface 1902 of the solar panel 1804 can face the robotic system 1000 as the robotic system 1000 approaches along the first direction D1. The controller 1010 can control the articulated arm 1006 and the gripper assembly 1003 to move toward the first surface 1902 of the solar panel 1804.

The controller 1010 can actuate the vacuum source 1012 to couple the gripper assembly 1003 to the first surface 1902 of the solar panel 1804 while the solar panel 1804 is in the first orientation 2302 relative to the body of the movable base 1002. The controller 1010 can control the articulated arm 1006 to move the solar panel 1804 to the mounting location 1808 or the mounting location 1810 on the torque tube 1806 at a second orientation 2304 (e.g., a mounted pose, installed angular position, placement orientation, post-rotation position, etc.) relative to the body of the movable base 1002, with the articulated arm 1006 moving the solar panel 1804 in the second direction D2 transverse to the first direction D1. As depicted in FIG. 23, in the second orientation 2304, the solar panel 1804 can extend along a second plane P2 that is angled relative to the first plane P1, such as a generally horizontal plane corresponding to a mounted orientation on the torque tube 1806. The transition from the first orientation 2302 to the second orientation 2304 can include rotation and translation of the solar panel 1804 by the articulated arm 1006 and the rotational actuator of the gripper assembly 1003 as the solar panel 1804 is carried laterally in the second direction D2. FIG. 23 can depict the solar panel 1804 in the first orientation 2302 extending along the first plane P1 and the solar panel 1804 in the second orientation 2304 extending along the second plane P2, illustrating the angular relationship between the two orientations across the pick-and-place cycle. The solar panel 1804 can be in substantially the second orientation 2304 while traveling along the second direction D2 towards a mounting location on the torque tube 1806, and towards the torque tube 1806.

The torque tube 1806 can be positioned lateral to the row 1802 in the environment 1800 and can extend along a direction that is parallel to or aligned with the first direction D1. The torque tube 1806 can include hat rails or other racking features onto which solar panels 1804 are mounted. The first mounting location 1808 and the second mounting location 1810 can be positions on the torque tube 1806 at which respective solar panels 1804 are to be installed. As shown in FIG. 18, the first mounting location 1808 can be proximate to the second mounting location 1810, such that successive solar panels 1804 are placed at adjacent positions along the torque tube 1806. In some implementations, the first mounting location 1808 is positioned further from the second mounting location 1810 such that solar panels 1804 are spaced further apart, such as by a distance of equal to or greater than width of a solar panel 1804.

In some implementations, the controller 1010 can identify the first mounting location 1808 of a first solar panel 1804 that has been placed on the torque tube 1806. The first solar panel 1804 can have been placed by the robotic system 1000 in a prior pick-and-place cycle, or the first solar panel 1804 can have been placed by another means. The first mounting location 1808 can serve as a reference anchor from which the controller 1010 determines the position of subsequent mounting locations along the torque tube 1806. In some implementations, the controller 1010 can have placed the first solar panel 1804 at the first mounting location 1808 on the torque tube 1806 at a first mounting orientation in a prior cycle. That is, prior to identifying the first mounting location 1808 as a reference, the controller 1010 can have controlled the articulated arm 1006 to move the first solar panel 1804 to the first mounting location 1808 on the torque tube 1806 at the first mounting orientation. The controller 1010 can identify the first mounting location 1808 based on the known location at which the first solar panel 1804 was placed, or based on image data depicting the first solar panel 1804 on the torque tube 1806.

In some implementations, the controller 1010 can identify the mounting location 1808 when no solar panels 1804 are yet mounted to the torque tube 1806. The controller 1010 can obtain image data from at least one of the one or more image sensors 1302 coupled to the movable base 1002 or the one or more image sensors 1320 coupled to the articulated arm 1006 depicting the torque tube 1806 and adjacent racking infrastructure. The controller 1010 can detect an end of the torque tube 1806, such as a terminal end cap, a bearing assembly, or a longitudinal terminus of the torque tube 1806, within the image data. In some implementations, the controller 1010 can detect an initial racking feature on the torque tube 1806, such as a first hat rail, a first mounting clip, a first bracket, or a first edge stop positioned at a starting position along the torque tube 1806. The controller 1010 can apply a semantic segmentation model or an object detection model to the image data to identify the detected end or the initial racking feature and to determine the position of the detected end or the initial racking feature in a coordinate frame of the movable base 1002.

Based on the detected end or the initial racking feature, the controller 1010 can calculate the mounting location 1808 as a position on the torque tube 1806 that is offset from the detected end or the initial racking feature by a predetermined distance corresponding to a panel edge setback or a first panel placement offset stored by the controller 1010. In some implementations, the controller 1010 can identify the positions of two or more hat rails along the torque tube 1806 from the image data and can determine the mounting location 1808 as a region between the two hat rails at which a first solar panel 1804 is to be placed. In some implementations, the controller 1010 can receive, via the user interface 1014, an operator input indicating the mounting location 1808 on the torque tube 1806, and the controller 1010 can store the indicated mounting location 1808 as the reference anchor for subsequent placement determinations.

The controller 1010 can obtain image data depicting the environment 1800 including the torque tube 1806. The image data can be obtained from at least one of the one or more image sensors 1320 coupled to the articulated arm 1006 or the one or more image sensors 1302 coupled to the movable base 1002. The image sensors 1320 can capture image data from a vantage point at the distal end of the articulated arm 1006, and the image sensors 1302 can capture image data from fixed positions on the chassis 1301 of the movable base 1002. The controller 1010 can select which of the image sensors 1302 or the image sensors 1320 to use based on viewing conditions affecting one or more of the image sensors, such as sun angle or glare that may degrade the image quality from a particular image sensor at a given time of day. For example, if a west-facing image sensor 1302 is affected by glare near sunset, the controller 1010 can select a different image sensor 1302 or one of the image sensors 1320 that is not affected by the glare condition. This camera selection capability can allow the robotic system 1000 to maintain placement accuracy across varying lighting conditions throughout an operational shift. The image data can depict the torque tube 1806, the first solar panel 1804 at the first mounting location 1808, the hat rails, and the surrounding terrain of the environment 1800.

Based on the image data and the first mounting location 1808, the controller 1010 can determine the second mounting location 1810 for a second solar panel 1804. The second mounting location 1810 can be proximate to the first mounting location 1808 on the torque tube 1806. The controller 1010 can store dimensional data corresponding to the solar panel 1804, such as a panel width, a panel length, and/or a panel thickness. In some implementations, the dimensional data can be received via the user interface 1014 as operator-entered values prior to a pick-and-place operation. In some implementations, the dimensional data can be retrieved from a data structure stored in a memory of the controller 1010 that maps panel model identifiers to corresponding panel dimensions. In some implementations, the controller 1010 can determine one or more dimensions of the solar panel 1804 from the image data obtained by the image sensors 1302 and/or the image sensors 1320, for example, by measuring a pixel extent of the solar panel 1804 within a captured image and converting the pixel extent to a physical dimension using the calibration data structure for the image sensor that captured the image.

The controller 1010 can calculate an offset from the first mounting location 1808 to the second mounting location 1810 based on the stored or determined dimensions of the first solar panel 1804 and a gap distance between adjacent panel positions on the torque tube 1806. For example, the controller 1010 can calculate the offset as a sum of a dimension of the first solar panel 1804 along the direction of the torque tube 1806 and the gap distance. The gap distance can be a predetermined spacing value stored by the controller 1010 that corresponds to a target inter-panel gap specified for the installation site (e.g., environment 1800, etc.). In some implementations, the controller 1010 can determine the gap distance from the image data by detecting the positions of adjacent hat rails along the torque tube 1806 within the semantically segmented image and calculating a spacing between the hat rails that corresponds to a panel placement region. The controller 1010 can apply the calculated offset to a known coordinate of the first mounting location 1808 in the coordinate frame of the movable base 1002 to generate the coordinate of the second mounting location 1810. By referencing the first mounting location 1808 as an anchor, the controller 1010 can determine the second mounting location 1810 without relying on absolute positioning information, which can reduce placement errors that may accumulate over the length of the torque tube 1806. This reference-based placement determination can maintain accuracy across successive pick-and-place cycles by grounding each new placement decision on the most recently placed panel.

The controller 1010 can control the articulated arm 1006 to move the second solar panel 1804 toward the second mounting location 1810 on the torque tube 1806 proximate to the first solar panel 1804. Prior to moving the second solar panel 1804 toward the second mounting location 1810, the controller 1010 can control the articulated arm 1006 to couple the gripper assembly 1003 to the second solar panel 1804. The gripper assembly 1003 can couple to the second solar panel 1804 via the vacuum source 1012. The controller 1010 can actuate the vacuum source 1012 to generate negative pressure at the plurality of suction cups of the gripper assembly 1003, and the suction cups can engage a surface of the second solar panel 1804. In some implementations, the controller 1010 can actuate the vacuum source 1012 while the gripper assembly 1003 is approaching the second solar panel 1804, such that the vacuum is at operating capacity by the time physical contact is made between the suction cups and the panel surface. In some implementations, the controller 1010 can actuate the vacuum source 1012 in response to the gripper assembly 1003 being within a threshold distance from the second solar panel 1804.

In some implementations, the controller 1010 can determine, based on the image data, that the second solar panel 1804 is within a threshold distance of the second mounting location 1810. The threshold distance can be, for example, about 5 mm, about 10 mm, about 15 mm, about 20 mm, about 25 mm, about 50 mm, or about 100 mm, among others, depending on, for example, but not limited to, the placement accuracy and the dimensional tolerances of the hat rails on the torque tube 1806. In some implementations, the threshold distance is less than about 5 or greater than about 100 mm. The controller 1010 can withhold a release operation until the second solar panel 1804 is within the threshold distance of the second mounting location 1810. This threshold-based release approach can reduce the risk of placing the second solar panel 1804 at an incorrect position on the torque tube 1806. The controller 1010 can release the second solar panel 1804 in response to determining that the second solar panel 1804 is within the threshold distance of the second mounting location 1810. The release can include deactivating the vacuum source 1012 and activating a positive pressure source to break residual stiction between the suction cups and the panel surface, as described herein. For example, the robotic system 1000 includes the positive pressure source.

In some implementations, the positive pressure source can be activated for a predetermined time period and can be deactivated after the predetermined time period elapses. In some implementations, the controller 1010 can apply a slight oscillation motion to the articulated arm 1006 during release to overcome stiction between the suction cups and the panel surface. During lateral movement of the second solar panel 1804 in the second direction D2 toward the torque tube 1806, the gripper assembly 1003 can remain positioned beneath the solar panel 1804, such that the first surface 1902 of the solar panel 1804 faces the gripper assembly 1003 and the solar panel 1804 rides above the gripper assembly 1003 throughout the lateral transport. As the articulated arm 1006 positions the solar panel 1804 at the second mounting location 1810 on the torque tube 1806, the gripper assembly 1003 can remain beneath the first surface 1902 of the solar panel 1804 while the solar panel 1804 is lowered onto the hat rails of the torque tube 1806. The gripper assembly 1003 can retain this position beneath the solar panel 1804 during the mounting operation, with the plurality of suction cups 108 engaged against the first surface 1902 until the controller 1010 initiates the release sequence.

After release of the solar panel 1804 at the second mounting location 1810 or any other mounting location, the controller 1010 can control the articulated arm 1006 to retract from the torque tube 1806 by moving the gripper assembly 1003 in a third direction away from the first surface 1902 of the second solar panel 1804. The third direction can be transverse to the first direction D1 along the row 1802 and transverse to the second direction D2 toward the torque tube 1806. For example, the third direction can be a downward direction relative to the movable base 1002, such that the articulated arm 1006 lowers the gripper assembly 1003 away from the first surface 1902 of the solar panel 1804 that has been placed at the second mounting location 1810 on the torque tube 1806. Because the gripper assembly 1003 was positioned beneath the second solar panel 1804 during the lateral transport and mounting phases, the downward movement in the third direction can withdraw the gripper assembly 1003 from beneath the second solar panel 1804 and the torque tube 1806, and can provide clearance between the gripper assembly 1003 and solar panels 1804 that have been placed on the torque tube 1806, which can reduce the risk of the gripper assembly 1003 or the articulated arm 1006 contacting the placed solar panels 1804 or the torque tube 1806 during retraction.

After moving in the third direction, the controller 1010 can control the articulated arm 1006 to move back toward the movable base 1002 along a direction opposite the second direction D2, returning the gripper assembly 1003 to a neutral position proximate to the movable base 1002. In this neutral position, the gripper assembly 1003 can be positioned for a subsequent pick-and-place cycle in which the controller 1010 controls the movable base 1002 to advance along the first direction D1 through the row 1802 toward a next staged solar panel 1804. In some implementations, the controller 1010 can control the articulated arm 1006 to move in the third direction and back toward the movable base 1002 while the positive pressure source remains active, such that the positive pressure continues to be supplied to the suction cups during the initial retraction movement and assists in separation of the suction cups from the panel surface. In some implementations, the retraction path of the articulated arm 1006 can include a combined motion in which the articulated arm 1006 moves downward in the third direction and laterally back toward the movable base 1002 in a single continuous motion, rather than moving downward and laterally in two discrete sequential movements.

In some implementations, controlling the articulated arm 1006 to move the second solar panel 1804 toward the second mounting location 1810 can include adjusting a position of the movable base 1002 while the second solar panel 1804 is coupled to the gripper assembly 1003. If the movable base 1002 is too far from the torque tube 1806 in the second direction D2 for the articulated arm 1006 to reach the second mounting location 1810, the controller 1010 can control the movable base 1002 to move toward the torque tube 1806 while the second solar panel 1804 remains coupled to the gripper assembly 1003. In some implementations, the movable base 1002 can laterally move towards the torque tube 1806 along the second direction D2. In some implementations, the movable base 1002 moves in a direction offset from the second direction D2 and the first direction D1 towards the torque tube 1806 and back to alignment with the first direction D1 following solar panel 1804 placement. In some implementations, the movable base 1002 moves in any direction to pick and place the solar panels 1804.

The controller 1010 can control the articulated arm 1006 to move the second solar panel 1804 toward the second mounting location 1810 in response to the movable base 1002 being within a second threshold distance of the torque tube 1806. This coordinated movement of the movable base 1002 and the articulated arm 1006 can allow the robotic system 1000 to accommodate varying lateral distances between the row 1802 and the torque tube 1806 across different regions of the environment 1800.

In some implementations, the robotic system 1000 can include a user interface, and the controller 1010 can cause the user interface to display one or more graphical indicators representing at least one of: the first mounting location 1808, the second mounting location 1810, a distance between the movable base 1002 and the torque tube 1806, or a distance between the second solar panel 1804 and the second mounting location 1810. In some implementations, the graphical indicators can include color-coded visual cues, such as red, yellow, and green indicators that represent proximity and alignment of the second solar panel 1804 to the second mounting location 1810. The red indicator can indicate that the second solar panel 1804 is beyond a threshold distance from the second mounting location 1810, the yellow indicator can indicate that the second solar panel 1804 is approaching the threshold distance, and the green indicator can indicate that the second solar panel 1804 is within the threshold distance and is aligned for release. The graphical indicators can provide an operator with real-time feedback during placement operations, which can facilitate accurate positioning of the second solar panel 1804 at the second mounting location 1810. In some implementations, the same camera-based placement determination can be used in an autonomous mode in which the controller 1010 calculates the offset from the reference panel and executes placement without operator mediation through the user interface.

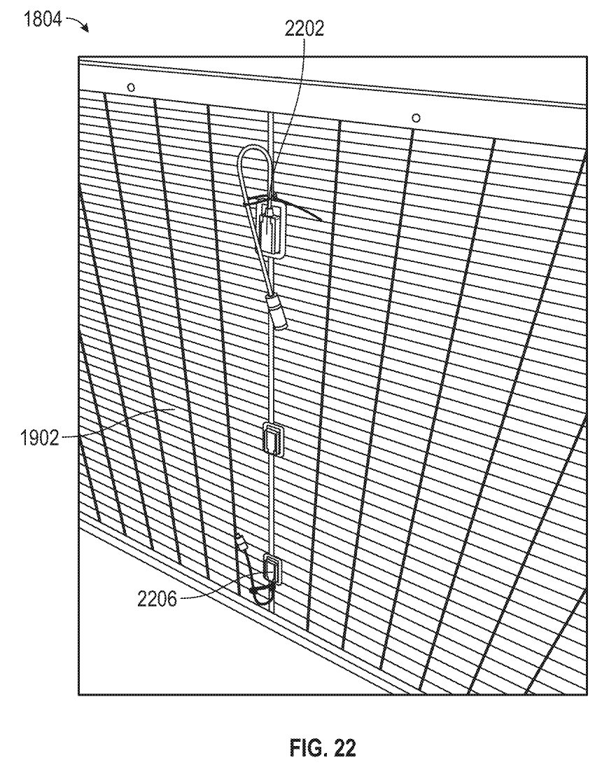

Referring now to FIG. 22, the solar panel 1804 can include one or more electrical lead terminals coupled to the solar panel 1804. As shown in FIG. 22, the solar panel 1804 can include a first electrical lead terminal 2202 (e.g., a first connector, first lead, first cable terminal, first wiring terminal, etc.) and a second electrical lead terminal 2206 (e.g., a second connector, second lead, second cable terminal, second wiring terminal, etc.) disposed on the first surface 1902 of the solar panel 1804. The first electrical lead terminal 2202 and the second electrical lead terminal 2206 can have predetermined locations on the solar panel 1804. For example, the controller 1010 can receive and store locations of the first electrical lead terminal 2202 and the second electrical lead terminal 2206. In some implementations, the controller 1010 determines locations of the first electrical lead terminal 2202 and the second electrical lead terminal 2206 based on image data received from the image sensors 1302 and/or 1320. In some implementations, the first electrical lead terminal 2202 and the second electrical lead terminal 2206 can be at opposite edges of the solar panel 1804, with one terminal being a positive terminal and the other being a negative terminal. The controller 1010 can determine which of the first electrical lead terminal 2202 and second electrical lead terminal 2206 is a positive terminal and which is a negative terminal. In some implementations, the first electrical lead terminal 2202 can be a male connector and the second electrical lead terminal 2206 can be a female connector, or vice versa.

The first electrical lead terminal 2202 and the second electrical lead terminal 2206 can have distinguishing visual features, such as different connector shapes, different colors, or different housing geometries. For example, one of the first electrical lead terminal 2202 or the second electrical lead terminal 2206 can include a colored tip, such as a blue tip, and the other can include a housing with a different color or form factor. The controller 1010 can use image data from the image sensors 1320 on the articulated arm 1006 or from the image sensors 1302 on the movable base 1002 to determine the position of at least one of the first electrical lead terminal 2202 or the second electrical lead terminal 2206 relative to the gripper assembly 1003. The determination can identify which edge of the solar panel 1804 has the negative terminal and which edge has the positive terminal. In some implementations, the controller 1010 can distinguish between the first electrical lead terminal 2202 and the second electrical lead terminal 2206 based on visual features of the connectors depicted in the image data, such as connector shape, color, housing geometry, or relative position on the solar panel 1804.

Based on the position of the electrical lead terminal (e.g., first and second electrical lead terminals 2202 and 2206), the controller 1010 can select a coupling location on the solar panel 1804 and a mounting orientation for the solar panel 1804. The controller 1010 can determine the position of at least one of the first electrical lead terminal 2202 or the second electrical lead terminal 2206 relative to the gripper assembly 1003 or relative to the solar panel 1804. For example, the controller 1010 can determine that the first electrical lead terminal 2202 is positioned at a first edge of the solar panel 1804 and the second electrical lead terminal 2206 is positioned at a second edge of the solar panel 1804 opposite the first edge. The controller 1010 can identify which of the first electrical lead terminal 2202 or the second electrical lead terminal 2206 corresponds to a negative terminal and which corresponds to a positive terminal based on the determined position and the predetermined locations of the first electrical lead terminal 2202 and the second electrical lead terminal 2206 on the solar panel 1804. Based on the identified terminal positions, the controller 1010 can select the coupling location on the first surface 1902 of the solar panel 1804 at which the gripper assembly 1003 engages the solar panel 1804.

The coupling location can correspond to a region of the first surface 1902, such as a left side (e.g., first portion, first side, first edge, etc.) or a right side (e.g., second portion, second side opposite first side, second edge opposite first edge, etc.) of the solar panel 1804, that positions the gripper assembly 1003 relative to the solar panel 1804 such that the articulated arm 1006 can rotate and translate the solar panel 1804 along a rotation path that places the identified negative terminal or positive terminal at a target edge of the solar panel 1804 upon arrival at the mounting location 1808 or the mounting location 1810. The mounting orientation can correspond to the angular orientation at which the solar panel 1804 is to be placed on the torque tube 1806, such that the electrical lead terminals face a target direction upon release. The controller 1010 can select at least one of the coupling location on the solar panel 1804 or a movement trajectory of the articulated arm 1006 based at least in part on a travel direction of the movable base 1002 when approaching the solar panel 1804. The travel direction can correspond to the first direction D1 along the row 1802. The controller 1010 can select at least one of the coupling location on the solar panel 1804 or the mounting orientation for the solar panel 1804 based at least in part on a direction at which the articulated arm 1006 moves the solar panel 1804 proximate to the mounting location 1808 or the mounting location 1810 on the torque tube 1806. This direction can correspond to the second direction D2 transverse to the first direction D1.

The relationship between the coupling location and the mounting orientation can be understood in that the coupling location determines which portion of the first surface 1902 the gripper assembly 100 engages, and the mounting orientation determines the final angular position of the solar panel 1804 on the torque tube 1806 at which the first electrical lead terminal 2202 and the second electrical lead terminal 2206 face the target direction. The coupling location constrains which rotation paths are kinematically achievable by the articulated arm 1006 and the rotational actuator of the gripper assembly 100 during transport from the staging location to the mounting location 1808 or the mounting location 1810. For example, engaging the first surface 1902 at a left-side coupling location can position the gripper assembly 100 such that a clockwise rotation path places the second electrical lead terminal 2206 at a target edge of the solar panel 1804 that faces north upon arrival at the torque tube 1806, whereas engaging the first surface 1902 at a right-side coupling location can position the gripper assembly 100 such that a counterclockwise rotation path achieves the same terminal orientation at the torque tube 1806.

The controller 1010 can determine the coupling location and the mounting orientation jointly, such that the selected coupling location provides a kinematic path for the articulated arm 1006 and the rotational actuator of the gripper assembly 100 to arrive at the selected mounting orientation with the first electrical lead terminal 2202 and the second electrical lead terminal 2206 positioned at their respective target edges of the solar panel 1804. If the controller 1010 selects a coupling location that is incompatible with a particular rotation path, the resulting mounting orientation at the mounting location 1808 or the mounting location 1810 can position the electrical lead terminals at an incorrect edge of the solar panel 1804, which can result in reversed polarity relative to a target connector coupled to the torque tube 1806. The controller 1010 can mitigate this condition by jointly evaluating the position of the first electrical lead terminal 2202 and the second electrical lead terminal 2206 on the solar panel 1804, the travel direction of the movable base 1002, and the deployment side of the articulated arm 1006 before selecting the coupling location and the corresponding rotation path.

The travel direction of the movable base 1002 affects the relative orientation between the gripper assembly 100 and the solar panel 1804 at the moment of engagement, because the articulated arm 1006 extends forward from the movable base 1002 along the first direction D1 to reach the first surface 1902 of the staged solar panel 1804. When the movable base 1002 approaches the solar panel 1804 from a first direction, the left side and the right side of the first surface 1902 correspond to first respective positions of the first electrical lead terminal 2202 and the second electrical lead terminal 2206 relative to the gripper assembly 100. When the movable base 1002 approaches the solar panel 1804 from a direction opposite the first direction, the left side and the right side of the first surface 1902 correspond to reversed positions of the first electrical lead terminal 2202 and the second electrical lead terminal 2206 relative to the gripper assembly 100. The controller 1010 can account for this reversal by selecting a different coupling location and a different rotation path in response to the reversed travel direction.

The controller 1010 can select at least one of the coupling location on the solar panel 1804 or the mounting orientation for the solar panel 1804 based at least in part on a direction at which the articulated arm 1006 moves the solar panel 1804 proximate to the mounting location 1808 or the mounting location 1810 on the torque tube 1806. This direction can correspond to the second direction D2 transverse to the first direction D1. The deployment side in the second direction D2 determines whether the articulated arm 1006 swings the solar panel 1804 to the left or to the right of the movable base 1002 during the lateral transport phase, and the direction of the lateral swing affects which edge of the solar panel 1804 faces the torque tube 1806 upon arrival at the mounting location 1808 or the mounting location 1810. If the articulated arm 1006 deploys the solar panel 1804 to a right side of the movable base 1002 in the second direction D2, a first edge of the solar panel 1804 faces the torque tube 1806 during placement, and the rotation path can be selected to position the target terminal at that first edge. If the articulated arm 1006 deploys the solar panel 1804 to a left side of the movable base 1002, a second edge of the solar panel 1804 opposite the first edge faces the torque tube 1806 during placement, and the controller 1010 can select a different rotation path that positions the target terminal at the second edge. In this way, the controller 1010 can coordinate the coupling location, the rotation path, and the mounting orientation such that the first electrical lead terminal 2202 and the second electrical lead terminal 2206 arrive at their target positions on the solar panel 1804 relative to the torque tube 1806 regardless of the travel direction of the movable base 1002 and regardless of the deployment side of the articulated arm 1006.

The controller 1010 can use the combined factors of the terminal position, the travel direction of the movable base 1002 along the first direction D1, and the deployment side in the second direction D2 to select a rotation path for the solar panel 1804. For example, if the controller 1010 determines that the second electrical lead terminal 2206 corresponding to the negative terminal is at an upper portion of the solar panel 1804 as staged, and the torque tube 1806 extends along a north-south direction, the controller 1010 can select the coupling location and the rotation path such that, after the articulated arm 1006 swings the solar panel 1804 laterally in the second direction D2 to the torque tube 1806, the negative terminal faces north. The rotation paths can be predetermined alternatives, such as a clockwise rotation path and a counterclockwise rotation path, from which the controller 1010 selects based on these factors. In some implementations, if the movable base 1002 is traveling in the first direction D1 and the articulated arm 1006 is to deploy the solar panel 1804 to the right side of the movable base 1002 in the second direction D2, and the negative terminal is at the upper portion of the staged solar panel 1804, the controller 1010 can select a clockwise rotation path and a coupling location on a corresponding side of the first surface 1902.

In some implementations, if the movable base 1002 is traveling in a direction opposite the first direction D1 and the articulated arm 1006 is to deploy the solar panel 1804 to the left side of the movable base 1002, and the negative terminal is at the upper portion of the staged solar panel 1804, the controller 1010 can select a counterclockwise rotation path and a different coupling location on the first surface 1902. The controller 1010 can select among the predetermined rotation paths rather than computing a novel trajectory in real time, such that the selection is based on a lookup or mapping of the three factors to corresponding predetermined rotation paths stored by the controller 1010.

The controller 1010 can control the articulated arm 1006 and the gripper assembly 1003 to move toward the coupling location on the first surface 1902 of the solar panel 1804. The controller 1010 can cause the gripper assembly 1003 to couple to the solar panel 1804 at the coupling location. In some implementations, the controller 1010 can actuate the vacuum source 1012 to cause the gripper assembly 1003 to couple to the solar panel 1804 at the coupling location. The gripper assembly 1003 can include a plurality of suction cups 108 that engage the first surface 1902 of the solar panel 1804 in response to the vacuum source 1012 being actuated. The controller 1010 can control the articulated arm 1006 to move the solar panel 1804 to the mounting location 1808 or the mounting location 1810 on the torque tube 1806 in the mounting orientation. The controller 1010 can control the articulated arm 1006 to position the selected electrical lead terminal such that, upon release of the solar panel 1804, the electrical lead terminal is positioned proximate to a target connector coupled to the torque tube 1806.

This positioning can allow solar panels 1804 along the row 1802 to be installed with consistent electrical polarity orientation, which can simplify subsequent wiring operations. The controller 1010 can select the mounting orientation based on a direction at which the torque tube 1806 extends along. For example, if the torque tube 1806 extends along a north-south direction, the controller 1010 can select the mounting orientation such that the negative terminal of each solar panel 1804 faces north upon placement. The controller 1010 can release the solar panel 1804 proximate to the mounting location 1808 or the mounting location 1810 on the torque tube 1806.

The controller 1010 can control the articulated arm 1006 and the gripper assembly 1003 to move toward the first surface 1902 of the solar panel 1804 during a pick phase, as depicted in FIG. 19. The controller 1010 can actuate the vacuum source 1012 to couple the gripper assembly 1003 to the first surface 1902 of the solar panel 1804, with the solar panel 1804 having the first orientation 2302 relative to the body of the movable base 1002 as shown in FIG. 23. The controller 1010 can control the articulated arm 1006 to move the solar panel 1804 to the mounting location 1808 or the mounting location 1810 in the environment 1800 at the second orientation 2304 relative to the body of the movable base 1002, with the articulated arm 1006 moving the solar panel 1804 in the second direction D2 transverse to the first direction D1. Because the gripper assembly 1003 holds the underside of the solar panel 1804, the solar panel 1804 rides above the gripper assembly 1003 during this lateral movement, as depicted in FIG. 20, and the articulated arm 1006 can swing the solar panel 1804 to the left or right side of the movable base 1002 and lower the solar panel 1804 onto the torque tube 1806 at the mounting location 1808 or the mounting location 1810.

In some implementations, after disposing the solar panel 1804 at the mounting location 1808 or the mounting location 1810 and deactivating the vacuum source 1012 to decouple the gripper assembly 1003 from the first surface 1902, the controller 1010 can control the articulated arm 1006 to move in a third direction transverse to the first direction D1 and the second direction D2, and back toward the movable base 1002 along the second direction D2. The third direction can be an upward direction, such that the articulated arm 1006 retracts upward from the torque tube 1806 before returning toward the movable base 1002. This return path can provide clearance for the articulated arm 1006 to avoid contact with the torque tube 1806 and with solar panels 1804 that have been placed on the torque tube 1806.

In some implementations, the controller 1010 can operate in a first operating mode and a second operating mode. In the first operating mode, the controller 1010 can control the movable base 1002 to travel in the first direction D1 along a first row 1802 of the environment 1800, such as from south to north. In the second operating mode, the controller 1010 can control the movable base 1002 to travel in a direction opposite the first direction D1 along a second row 1802 of the environment 1800, such as from north to south. In the second operating mode, the controller 1010 can determine a second coupling location on the next solar panel 1804 that is different from the coupling location used in the first operating mode, and can determine a second mounting location in the environment 1800 that is different from the mounting location used in the first operating mode, based on the reversed travel direction. The controller 1010 can control the articulated arm 1006 and the gripper assembly 1003 to couple to the solar panel 1804 at the second coupling location in the second operating mode, and can control the articulated arm 1006 to move the solar panel 1804 to the second mounting location in the second operating mode.

For example, upon completing installation of solar panels 1804 along the first row 1802 while operating in the first operating mode, the controller 1010 can control the movable base 1002 to transition from the first row 1802 to the second row 1802. The controller 1010 can control the movable base 1002 to travel from a terminal end of the first row 1802 to an entry end of the second row 1802 by traversing a lateral path between the first row 1802 and the second row 1802. The lateral path can extend in the second direction D2 or in a direction that is substantially transverse to the first direction D1 to reposition the movable base 1002 from the first row 1802 into the second row 1802. During the transition, the movable base 1002 can arrive at the second row 1802 at a position that is at or proximate to the terminal end of the second row 1802 relative to the first direction D1. Because the movable base 1002 arrives at the end of the second row 1802 that is opposite from the starting end used in the first operating mode, the controller 1010 can transition from the first operating mode to the second operating mode and can control the movable base 1002 to travel along the second row 1802 in the direction opposite the first direction D1.

In the second operating mode, the articulated arm 1006 can be mounted toward the front portion of the chassis 1301 of the movable base 1002 relative to the reversed travel direction, such that the articulated arm 1006 can reach forward in the direction opposite the first direction D1 to engage solar panels 1804 staged ahead of the robotic system 1000 in the second row 1802. The controller 1010 can obtain image data from the image sensors 1302 and/or the image sensors 1320 to detect the position and orientation of each staged solar panel 1804 in the second row 1802, and can determine the second coupling location on the solar panel 1804 based on the reversed travel direction and the position of the first electrical lead terminal 2202 and the second electrical lead terminal 2206 on the solar panel 1804. The controller 1010 can select a different rotation path from among the predetermined rotation paths stored by the controller 1010 to position the electrical lead terminals at the target orientation upon arrival at the second mounting location on the torque tube 1806. In some implementations, the controller 1010 can select between a clockwise rotation path and a counterclockwise rotation path based on the reversed travel direction, the deployment side of the articulated arm 1006 in the second direction D2, and the position of the electrical lead terminals on the solar panel 1804.

The articulated arm 1006 can move the solar panel 1804 laterally in the second direction D2 to the second mounting location on the torque tube 1806 adjacent to the second row 1802 while the movable base 1002 remains oriented along the direction opposite the first direction D1. The movable base 1002 does not turn left or right during the pick-and-place cycle in the second operating mode, and the body of the movable base 1002 can extend along the direction opposite the first direction D1 throughout the cycle. The robotic system 1000 can continue installing solar panels 1804 along the second row 1802 while traveling in the direction opposite the first direction D1 until each mounting location along the second row 1802 has received a solar panel 1804. Upon completing installation along the second row 1802, the controller 1010 can control the movable base 1002 to transition to a third row 1802 and can revert to the first operating mode for travel in the first direction D1, or can continue in the second operating mode for the third row 1802 depending on the layout of the environment 1800. This bidirectional capability can allow the robotic system 1000 to install solar panels 1804 in both travel directions without repositioning at the end of each row 1802, which can reduce non-productive travel time between rows and can increase throughput of the robotic system 1000 across an operational shift.

The spatial arrangement as shown in at least FIG. 18 allows the robotic system 1000 to perform pick-and-place operations in a row-native manner, in which the movable base 1002 travels along the row 1802 and the articulated arm 1006 deploys solar panels 1804 laterally to the torque tube 1806 without the movable base 1002 departing from the row 1802 or reorienting relative to the first direction D1.

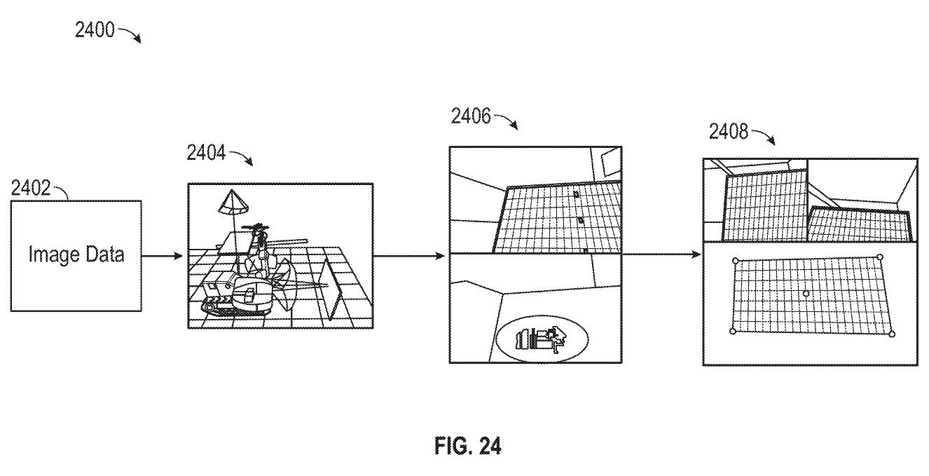

Referring now to FIG. 24, illustrated is a diagram of a process 2400 for determining a pick pose of a solar panel ahead of the robotic system 1000, in accordance with one or more implementations. The process 2400 can be performed by the controller 1010 during a pick phase of a pick-and-place cycle in which the robotic system 1000 is traveling along the first direction D1 through the row 1802 of the environment 1800 and is approaching a solar panel 1804 staged ahead of the robotic system 1000. The process 2400 can receive image data 2402 as an input and can produce a pick pose of the solar panel 1804 as an output. The image data 2402 can be obtained from the one or more image sensors 1302 coupled to the movable base 1002 and/or the one or more image sensors 1320 coupled to the articulated arm 1006. In some implementations, the image data 2402 can include red, green, blue (RGB) image data, depth image data, or red, green, blue, depth (RGB-D) image data captured by the image sensors 1302 and/or the image sensors 1320 as the robotic system 1000 approaches the solar panel 1804 along the first direction D1.

At block 2404, the controller 1010 can fuse the image data 2402 from front-facing cameras (e.g., cameras facing the first direction D1, etc.) of the image sensors 1302 to construct a point cloud. The front-facing cameras can be the image sensors 1302 positioned at the front portion of the chassis 1301 of the movable base 1002, as described with respect to FIG. 3. The controller 1010 can receive the image data 2402 from two or more front-facing image sensors 1302 and can fuse the image data 2402 into a three-dimensional point cloud representation of the scene ahead of the robotic system 1000. The point cloud can represent the spatial geometry of the solar panel 1804, the torque tube 1806, and other structures in the environment 1800 ahead of the robotic system 1000 along the first direction D1. In some implementations, the controller 1010 can fuse depth data from the front-facing image sensors 1302 by registering the depth maps from the respective image sensors 1302 into a common coordinate frame of the movable base 1002.

At block 2406, the controller 1010 can apply a semantic mask and a plane-fit operation to fill in missing depth regions in the point cloud. The controller 1010 can apply a semantic segmentation model to the image data 2402 to identify regions of the image corresponding to the solar panel 1804. The semantic mask can delineate the boundary of the solar panel 1804 within the image data 2402 and can distinguish the solar panel 1804 from background structures such as the torque tube 1806, terrain, racking infrastructure, and other objects in the environment 1800. In some implementations, the point cloud constructed at block 2404 can include regions where depth data is missing or unreliable, such as regions of specular reflection on the surface of the solar panel 1804, regions at the edges of the solar panel 1804 where depth discontinuities occur, or regions where the solar panel 1804 surface is at a steep angle relative to the front-facing image sensors 1302. The controller 1010 can apply a plane-fit operation within the semantically masked region to estimate a planar surface that corresponds to the solar panel 1804. The plane-fit operation can fit a plane to the available depth data points within the masked region and can extrapolate the fitted plane to fill in the missing depth regions. This combination of semantic masking and plane-fitting can produce a complete surface representation of the solar panel 1804 within the point cloud, which can provide the controller 1010 with the spatial information for determining the position and orientation of the solar panel 1804 relative to the robotic system 1000.

At block 2408, the controller 1010 can return the pick pose of the solar panel 1804 ahead of the robotic system 1000. The pick pose can include a position and an orientation of the solar panel 1804 in the coordinate frame of the movable base 1002 or in a global coordinate frame. The controller 1010 can determine the pick pose based on the completed surface representation of the solar panel 1804 produced at block 2406. As shown in FIG. 24, the pick pose can be represented as a bounded region on the solar panel 1804 indicating the position and angular orientation at which the gripper assembly 1003 is to engage the first surface 1902 of the solar panel 1804. In some implementations, the pick pose can correspond to a six-degree-of-freedom pose that defines the target position and orientation of the gripper assembly 1003 relative to the solar panel 1804 for coupling the plurality of suction cups of the gripper assembly 1003 to the first surface 1902. The controller 1010 can transmit a control signal to the arm controller of the articulated arm 1006 to move the gripper assembly 1003 to the determined pick pose and to engage the first surface 1902 of the solar panel 1804 as described with respect to FIG. 19. In some implementations, the controller 1010 can select the pick pose based on the position of one or more electrical lead terminals on the solar panel 1804, such as the first electrical lead terminal 2202 and the second electrical lead terminal 2206 described with respect to FIG. 22, such that the coupling location positions the gripper assembly 1003 for a rotation path that places the electrical lead terminals at a target orientation upon arrival at the mounting location 1808 or the mounting location 1810 on the torque tube 1806.

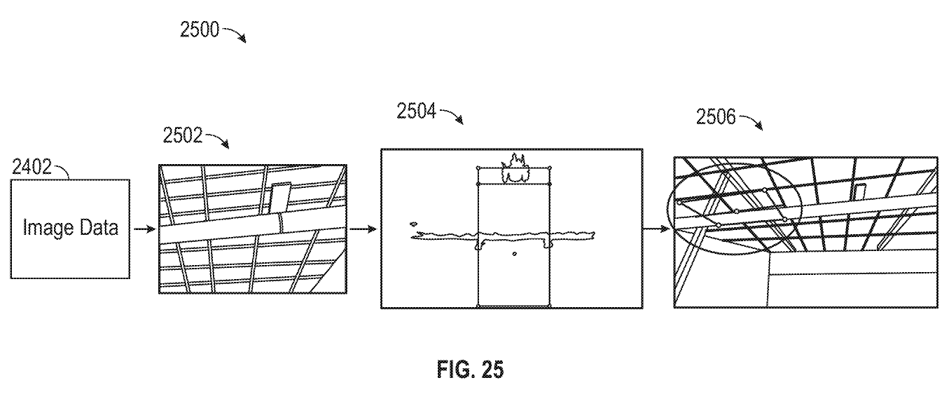

Referring now to FIG. 25, illustrated is a diagram of a process 2500 for determining a place pose on the torque tube 1806 for a solar panel 1804, in accordance with one or more implementations. The process 2500 can be performed by the controller 1010 during a placement phase of a pick-and-place cycle in which the robotic system 1000 is positioning a solar panel 1804 at the mounting location 1808 or the mounting location 1810 on the torque tube 1806. As described with respect to FIG. 24, the process 2500 can receive image data 2402 as an input and can produce a place pose on the torque tube 1806 as an output. The image data 2402 can be obtained from the one or more image sensors 1302 coupled to the movable base 1002 and/or the one or more image sensors 1320 coupled to the articulated arm 1006. In some implementations, the image data 2402 can include RGB image data, depth image data, or RGB-D image data captured by the image sensors 1302 and/or the image sensors 1320 depicting the torque tube 1806 and adjacent racking infrastructure in the environment 1800. The controller 1010 can select which of the image sensors 1302 or the image sensors 1320 to use for the image data 2402 based on viewing conditions affecting one or more of the image sensors, such as sun angle or glare that may degrade the image quality from a particular image sensor at a given time of day, as described with respect to FIG. 18.

At block 2502, the controller 1010 can apply a semantic mask to the image data 2402 to identify salient regions corresponding to the torque tube 1806 and hat rails within the environment 1800. The controller 1010 can apply a semantic segmentation model to the image data 2402 to distinguish the torque tube 1806 from background structures such as terrain, previously placed solar panels 1804, racking posts, and other objects in the environment 1800. The semantic mask can delineate the boundary of the torque tube 1806 and the hat rails within the image data 2402. In some implementations, the controller 1010 can use the semantic mask to determine a height of the torque tube 1806 relative to the movable base 1002 or relative to a ground plane. The height determination can be based on depth data within the semantically masked region corresponding to the torque tube 1806. The semantic mask can isolate the torque tube 1806 from surrounding structures in the point cloud, such that subsequent point cloud processing operates on the salient regions corresponding to the torque tube 1806 and hat rails rather than on the full scene.

At block 2504, the controller 1010 can process the point cloud within the salient regions identified at block 2502 to locate the torque tube 1806 and the hat rails. The controller 1010 can extract point cloud data within the semantically masked regions and can apply geometric fitting operations to identify the position and orientation of the torque tube 1806 and the hat rails in the coordinate frame of the movable base 1002. In some implementations, the controller 1010 can apply a cylindrical fit to the point cloud data within the masked region corresponding to the torque tube 1806 to determine the centerline position and orientation of the torque tube 1806. In some implementations, the controller 1010 can apply planar or edge-fitting operations to the point cloud data within the masked regions corresponding to the hat rails to determine the positions and spacing of the hat rails along the torque tube 1806. The controller 1010 can identify the region between adjacent hat rails as a candidate placement region for the solar panel 1804. In some implementations, the controller 1010 can use bounding box detection within the salient regions to delineate the extent of the torque tube 1806 and the hat rails, as depicted in FIG. 25. The bounding boxes can indicate the spatial extent of the detected structures within the point cloud and can provide the controller 1010 with the dimensional information for determining the placement region between the hat rails.

At block 2506, the controller 1010 can return the place pose on the torque tube 1806 between the hat rails. The place pose can include a position and an orientation at which the solar panel 1804 is to be released onto the torque tube 1806 at the mounting location 1808 or the mounting location 1810. The controller 1010 can determine the place pose based on the positions of the torque tube 1806 and the hat rails identified at block 2504 and based on the mounting location 1808 or the mounting location 1810 determined from the image data 2402 and the first mounting location 1808 of a previously placed solar panel 1804, as described with respect to FIG. 18. As shown in FIG. 25, the place pose can be represented as a bounded region on the torque tube 1806 between the hat rails, indicating the target position and angular orientation at which the gripper assembly 1003 is to release the solar panel 1804 onto the hat rails. In some implementations, the place pose can correspond to a six-degree-of-freedom pose that defines the target position and orientation of the gripper assembly 1003 relative to the torque tube 1806 for releasing the solar panel 1804 at the mounting location 1808 or the mounting location 1810. The controller 1010 can transmit a control signal to the arm controller of the articulated arm 1006 to move the gripper assembly 1003 and the coupled solar panel 1804 to the determined place pose and to release the solar panel 1804 at the mounting location 1808 or the mounting location 1810 on the torque tube 1806 as described with respect to FIGS. 18 and 23 . In some implementations, the controller 1010 can determine that the solar panel 1804 is within a threshold distance of the place pose before releasing the solar panel 1804, as described with respect to FIG. 18. In some implementations, the controller 1010 can cause the user interface 1014 to display one or more graphical indicators representing the place pose, a distance between the solar panel 1804 and the place pose, or a distance between the movable base 1002 and the torque tube 1806, such as color-coded visual cues indicating proximity and alignment of the solar panel 1804 to the mounting location 1808 or the mounting location 1810.

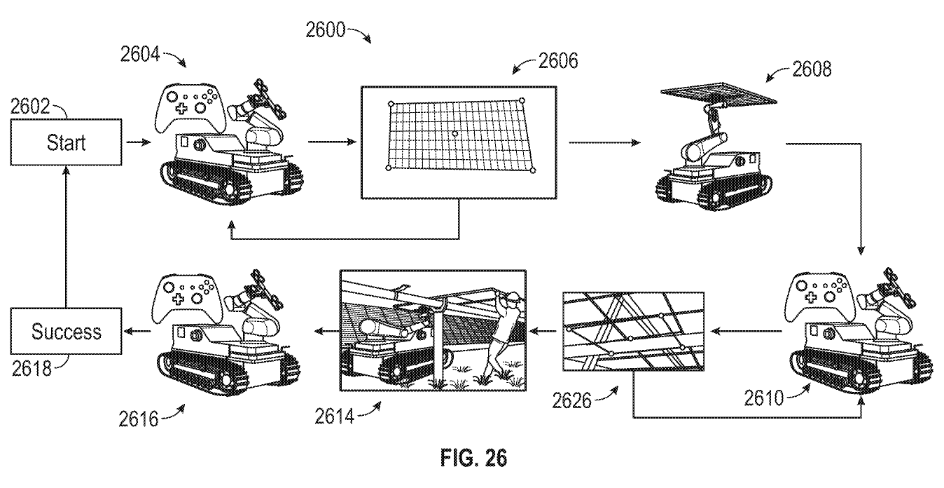

Referring now to FIG. 26, illustrated is a flow chart of a process 2600 for an operational sequence of the robotic system 1000 for detecting pick and place poses while transporting a solar panel 1804 from a staging location to the torque tube 1806, in accordance with one or more implementations. The process 2600 can be performed by the controller 1010 in coordination with the articulated arm 1006, the gripper assembly 1003, and the vacuum source 1012 during a pick-and-place cycle in which the robotic system 1000 picks a solar panel 1804 from a staging location in the row 1802 of the environment 1800 and places the solar panel 1804 at the mounting location 1808 or the mounting location 1810 on the torque tube 1806. The process 2600 can incorporate the pick pose determination described with respect to FIG. 24 and the place pose determination described with respect to FIG. 25 as sub-processes within a complete operational cycle. The process 2600 can be repeated for successive solar panels 1804 staged along the row 1802 as the robotic system 1000 travels along the first direction D1.

At block 2602, the process 2600 can begin. The controller 1010 can initiate the process 2600 in response to a command received via the user interface 1014 or in response to an autonomous determination that a next solar panel 1804 is available for installation along the row 1802.

At block 2604, the controller 1010 can control the movable base 1002 to navigate along the first direction D1 through the row 1802 toward a next solar panel 1804 staged ahead of the robotic system 1000. The controller 1010 can control the movable base 1002 to travel along the first direction D1 using the tracks 1004 of the movable base 1002, as described with respect to FIGS. 1 and 3 . The controller 1010 can receive operator input via the user interface 1014 to guide the movable base 1002 toward the solar panel 1804, or the controller 1010 can autonomously navigate the movable base 1002 toward the solar panel 1804 based on image data from the image sensors 1302 and/or the image sensors 1320. The movable base 1002 can remain oriented along the first direction D1 during navigation, as described with respect to FIG. 18.

At block 2606, the controller 1010 can detect a pick pose of the solar panel 1804 ahead of the robotic system 1000. The controller 1010 can obtain image data 2402 from the image sensors 1302 coupled to the movable base 1002 and/or the image sensors 1320 coupled to the articulated arm 1006. The controller 1010 can perform the pick pose detection as described with respect to FIG. 24, including fusing the image data 2402 from front-facing cameras of the image sensors 1302 to construct a point cloud at block 2404, applying a semantic mask and a plane-fit operation to fill in missing depth regions at block 2406, and returning the pick pose at block 2408. As shown in FIG. 26, the pick pose detection at block 2606 can include a retry operation in which the controller 1010 reattempts the pick pose detection in response to an error condition. The error condition can include a failure to detect the solar panel 1804 within the image data 2402, a failure of the semantic segmentation model to identify a region corresponding to the solar panel 1804, a failure of the plane-fit operation to produce a valid planar surface, or an insufficient number of depth data points within the masked region. In response to the error condition, the controller 1010 can obtain updated image data 2402 from the image sensors 1302 and/or the image sensors 1320 and can reattempt the pick pose detection. In some implementations, the controller 1010 can adjust the position of the movable base 1002 or the articulated arm 1006 before reattempting the pick pose detection, such as by moving the movable base 1002 closer to the solar panel 1804 along the first direction D1 to obtain image data 2402 at a different range. In some implementations, the controller 1010 can select a different one of the image sensors 1302 or the image sensors 1320 for the reattempt based on viewing conditions affecting one or more of the image sensors, as described with respect to FIG. 18.

At block 2608, the controller 1010 can control the articulated arm 1006 and the gripper assembly 1003 to pick the solar panel 1804 from the staging location. The controller 1010 can transmit a control signal to the arm controller of the articulated arm 1006 to move the gripper assembly 1003 to the pick pose determined at block 2606. The controller 1010 can control the articulated arm 1006 and the gripper assembly 1003 to move toward the first surface 1902 of the solar panel 1804, as described with respect to FIG. 19. The controller 1010 can actuate the vacuum source 1012 to couple the plurality of suction cups of the gripper assembly 1003 to the first surface 1902 of the solar panel 1804. In some implementations, the controller 1010 can actuate the vacuum source 1012 while the gripper assembly 1003 is approaching the solar panel 1804, such that the vacuum is at operating capacity by the time physical contact is made between the suction cups and the first surface 1902, as described with respect to FIG. 3. The solar panel 1804 can have the first orientation 2302 relative to the body of the movable base 1002 when coupled to the gripper assembly 1003, as described with respect to FIG. 23. In some implementations, the controller 1010 can select the pick pose based on the position of the first electrical lead terminal 2202 and the second electrical lead terminal 2206 on the solar panel 1804, as described with respect to FIG. 22, such that the coupling location positions the gripper assembly 1003 for a rotation path that places the electrical lead terminals at a target orientation upon arrival at the mounting location 1808 or the mounting location 1810 on the torque tube 1806.

At block 2610, the controller 1010 can control the movable base 1002 to navigate toward the torque tube 1806. The controller 1010 can control the movable base 1002 to continue traveling along the first direction D1 through the row 1802 while the solar panel 1804 remains coupled to the gripper assembly 1003. In some implementations, the controller 1010 can control the movable base 1002 to adjust position in the second direction D2 toward the torque tube 1806 while the solar panel 1804 is coupled to the gripper assembly 1003, as described with respect to FIG. 18. The solar panel 1804 can ride above the gripper assembly 1003 during transport, as described with respect to FIG. 20. The vacuum source 1012 can maintain vacuum in an active state throughout the transport from the staging location toward the torque tube 1806, as described with respect to FIG. 3.

At place pose detection step 2612, the controller 1010 can detect a place pose on the torque tube 1806. The controller 1010 can obtain image data 2402 from the image sensors 1302 and/or the image sensors 1320 depicting the torque tube 1806 and adjacent racking infrastructure. The controller 1010 can perform the place pose detection as described with respect to FIG. 25, including applying a semantic mask to identify salient regions corresponding to the torque tube 1806 and hat rails at block 2502, processing the point cloud within the salient regions to locate the torque tube 1806 and the hat rails at block 2504, and returning the place pose on the torque tube 1806 between the hat rails at block 2506. In some implementations, the controller 1010 can identify the mounting location 1808 of a previously placed solar panel 1804 on the torque tube 1806 and can determine the mounting location 1810 for the current solar panel 1804 based on the image data 2402 and the mounting location 1808, as described with respect to FIG. 18. As shown in FIG. 26, the place pose detection at place pose detection step 2612 can include a retry operation in which the controller 1010 reattempts the place pose detection in response to an error condition. The error condition can include a failure to detect the torque tube 1806 within the image data 2402, a failure to identify the hat rails, or an insufficient number of depth data points within the masked region corresponding to the torque tube 1806, among others. In response to the error condition, the controller 1010 can obtain updated image data 2402 and can reattempt the place pose detection. In some implementations, the controller 1010 can select a different one of the image sensors 1302 or the image sensors 1320 for the reattempt based on viewing conditions, as described with respect to FIGS. 18 and 25 .

At block 2614, the controller 1010 can control the articulated arm 1006 to place the solar panel 1804 on the torque tube 1806 at the place pose determined at place pose detection step 2612. The controller 1010 can transmit control signals to the arm controller of the articulated arm 1006 to move the solar panel 1804 in the second direction D2 transverse to the first direction D1 toward the mounting location 1808 or the mounting location 1810 on the torque tube 1806. The controller 1010 can transmit a control signal to the rotational actuator of the gripper assembly 1003 to rotate the solar panel 1804 to a mounting orientation. In some implementations, the controller 1010 can transmit the arm movement control signal and the gripper rotation control signal simultaneously, such that the articulated arm 1006 is moving while the rotational actuator of the gripper assembly 1003 is simultaneously rotating the solar panel 1804, as described with respect to FIGS. 18 and 23 . The solar panel 1804 can arrive at the mounting location 1808 or the mounting location 1810 in the second orientation 2304 relative to the body of the movable base 1002, as described with respect to FIG. 23. The controller 1010 can determine that the solar panel 1804 is within a threshold distance of the mounting location 1808 or the mounting location 1810 before releasing the solar panel 1804, as described with respect to FIG. 18. The controller 1010 can deactivate the vacuum source 1012 and can activate a positive pressure source to break residual stiction between the suction cups and the first surface 1902 of the solar panel 1804, as described with respect to FIG. 3.

At block 2616, the controller 1010 can control the movable base 1002 to navigate to a next solar panel 1804 along the row 1802. The controller 1010 can control the articulated arm 1006 to retract in a third direction transverse to the first direction D1 and the second direction D2, and back toward the movable base 1002, as described with respect to FIG. 18. The controller 1010 can control the movable base 1002 to advance along the first direction D1 through the row 1802 toward the next staged solar panel 1804. The controller 1010 can receive operator input via the user interface 1014 to guide the movable base 1002 toward the next solar panel 1804, or the controller 1010 can autonomously navigate the movable base 1002 toward the next solar panel 1804.

At block 2618, the process 2600 can conclude the current pick-and-place cycle. Upon reaching block 2618, the controller 1010 can return to block 2602 to begin a subsequent pick-and-place cycle for the next solar panel 1804 staged in the row 1802. In some implementations, the controller 1010 can operate in the first operating mode or the second operating mode, as described with respect to FIG. 18, such that the process 2600 can be performed while the movable base 1002 travels in the first direction D1 or in a direction opposite the first direction D1 along the row 1802. In the second operating mode, the controller 1010 can determine a different coupling location on the next solar panel 1804 and a different mounting location based on the reversed travel direction, as described with respect to FIG. 18. The process 2600 can repeat for successive solar panels 1804 staged along the row 1802 until all solar panels 1804 in the row 1802 have been placed on the torque tube 1806 or until the controller 1010 receives a command to cease operations.

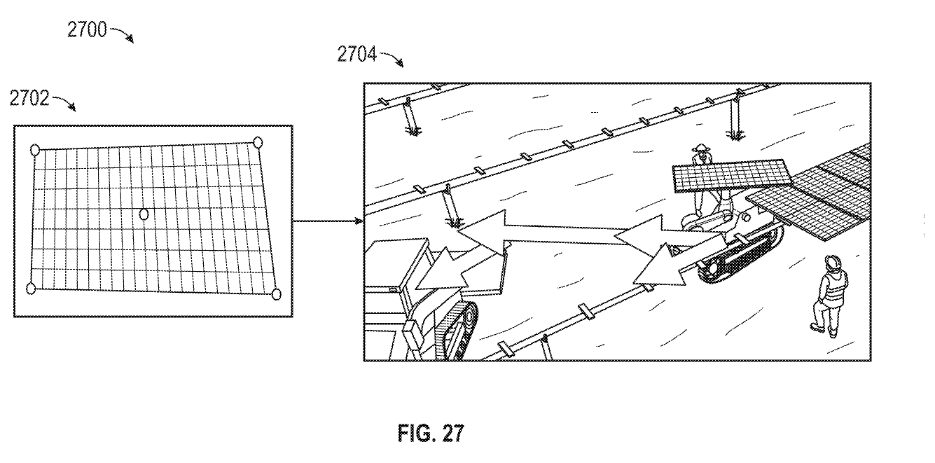

Referring now to FIG. 27, illustrated is a diagram of a process 2700 for pick-and-place trajectory planning using a detected module pose ahead of the robotic system 1000, in accordance with one or more implementations. The process 2700 can be performed by the controller 1010 during a pick-and-place cycle and can use the pose of a solar panel 1804 detected ahead of the robotic system 1000 as a navigation goal for the movable base 1002. The process 2700 can generate a trajectory for the movable base 1002 and the articulated arm 1006 that transitions through a sequence of phases to transport the solar panel 1804 from a staging location to the mounting location 1808 or the mounting location 1810 on the torque tube 1806.

At block 2702, the controller 1010 can detect the pose of the solar panel 1804 ahead of the robotic system 1000 and can use the detected module pose as a navigation goal with a predetermined offset. As shown in FIG. 27, the controller 1010 can obtain image data from the image sensors 1302 coupled to the movable base 1002 and/or the image sensors 1320 coupled to the articulated arm 1006 and can determine the position and orientation of the solar panel 1804 staged ahead of the robotic system 1000 along the first direction D1. The controller 1010 can perform the pick pose detection as described with respect to FIG. 24, including fusing image data from front-facing cameras of the image sensors 1302 to construct a point cloud at block 2404, applying a semantic mask and a plane-fit operation at block 2406, and returning the pick pose at block 2408. The controller 1010 can establish the detected module pose as a goal position for the movable base 1002 and can apply an offset distance from the detected pose, such as an offset of approximately one meter, as a target stopping position for the movable base 1002 along the first direction D1. The offset distance can position the movable base 1002 at a distance from the solar panel 1804 at which the articulated arm 1006 can reach the first surface 1902 of the solar panel 1804 for coupling. The controller 1010 can control the movable base 1002 to navigate along the first direction D1 through the row 1802 toward the goal position with the applied offset. In some implementations, the offset distance can be about 0.5 meters, about 0.75 meters, about 1.0 meter, about 1.25 meters, or about 1.5 meters, among others, depending on the reach of the articulated arm 1006 and the dimensions of the robotic system 1000.

At block 2704, the controller 1010 can generate a pick-and-place trajectory for the articulated arm 1006 and the movable base 1002 based on the detected module pose. As shown in FIG. 27, the trajectory can include a sequence of phases represented by directional indicators. The trajectory can include a start phase, an orient phase, a drive phase, and a final orient phase. In the start phase, the articulated arm 1006 can be positioned in an initial configuration relative to the movable base 1002, and the gripper assembly 1003 can be oriented to approach the first surface 1902 of the solar panel 1804. In the orient phase, the controller 1010 can control the articulated arm 1006 to orient the gripper assembly 1003 relative to the solar panel 1804 for coupling. In the drive phase, the controller 1010 can control the movable base 1002 to translate along the first direction D1 and/or the second direction D2 while the solar panel 1804 is coupled to the gripper assembly 1003, transporting the solar panel 1804 from the staging location toward the torque tube 1806. In the final orient phase, the controller 1010 can control the articulated arm 1006 and the rotational actuator of the gripper assembly 1003 to rotate and position the solar panel 1804 at the second orientation 2304 relative to the body of the movable base 1002 for placement at the mounting location 1808 or the mounting location 1810 on the torque tube 1806.

Throughout the trajectory, the movable base 1002 can remain oriented along the first direction D1, as described with respect to FIG. 18. In some implementations, the controller 1010 can transmit arm movement control signals and gripper rotation control signals simultaneously during the final orient phase, such that the articulated arm 1006 is moving the solar panel 1804 laterally in the second direction D2 while the rotational actuator of the gripper assembly 1003 is simultaneously rotating the solar panel 1804 to the mounting orientation, as described with respect to FIG. 23. The sequential phasing of the trajectory from start through orient, drive, and final orient can reduce the complexity of motion planning for the controller 1010 by decomposing the pick-and-place cycle into discrete phases, each of which involves a reduced set of simultaneous motion commands compared to a single continuous trajectory that would span the full pick-and-place cycle. In some implementations, the controller 1010 can select among predetermined trajectories or trajectory templates based on the travel direction of the movable base 1002 along the first direction D1, the deployment side of the articulated arm 1006 in the second direction D2, and the position of the first electrical lead terminal 2202 and the second electrical lead terminal 2206 on the solar panel 1804, as described with respect to FIG. 22. In some implementations, the controller 1010 can select from predetermined rotation paths, such as clockwise or counterclockwise rotation paths, during the final orient phase based on the terminal position, the travel direction, and the deployment side, as described with respect to FIG. 18.

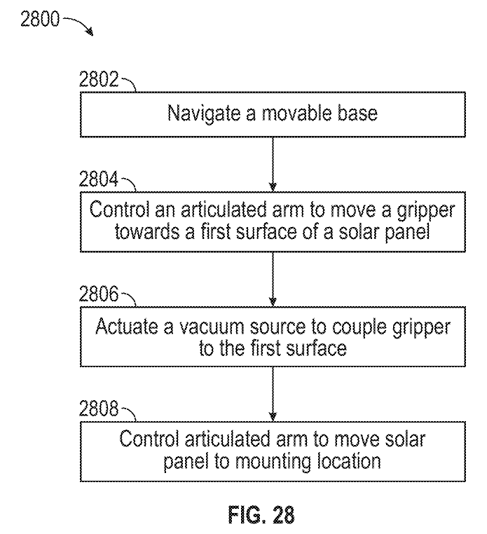

Referring now to FIG. 28, illustrated is a flow chart of a method 2800 for navigating a movable base, coupling a gripper to a solar panel, and moving the solar panel to a mounting location, in accordance with one or more implementations. The method 2800 can be performed by a controller (e.g., the controller 1010) of a robotic system (e.g., the robotic system 1000) that includes the movable base, an articulated arm (e.g., the articulated arm 1006) disposed on the movable base, the gripper (e.g., the gripper assembly 1003) coupled to a distal end of the articulated arm, and a vacuum source (e.g., the vacuum source 1012) housed on the movable base. The method 2800 can be performed during pick-and-place operations in which the robotic system transports solar panels from a staging location to a mounting location on racking infrastructure, such as a torque tube (e.g., the torque tube 1806) with hat rails, in an environment for solar panel installation (e.g., the installation environment 1800).

At block 2802, the controller can navigate the movable base along a first direction (e.g., the first direction D1) of a row (e.g., the row 1802) of the environment. The controller can transmit drive commands to a tracked drivetrain of the movable base to propel the movable base along the first direction through the row. The first direction can correspond to a longitudinal axis of the row, such as a south-to-north direction or a north-to-south direction. The movable base can remain oriented along the first direction during navigation. In some implementations, the movable base can include a pair of tracks (e.g., the tracks 1004) disposed on opposing lateral sides of a chassis of the movable base, and the controller can control the tracks to propel the movable base along the row toward a solar panel (e.g., the solar panel 1804) staged ahead of the robotic system in the row. In some implementations, the controller can receive operator input via a user interface (e.g., the user interface 1014) to guide the movable base toward the solar panel. In some implementations, the controller can autonomously navigate the movable base toward the solar panel based on image data from one or more chassis cameras (e.g., image sensors 1302) coupled to the movable base and/or one or more arm cameras (e.g., image sensors 1320) coupled to the articulated arm.

At block 2804, the controller can control the articulated arm disposed on the movable base to move the gripper toward a first surface of the solar panel. The first surface can be an underside of the solar panel, such as a non-active surface of the solar panel opposite a photovoltaic surface. The controller can transmit a control signal to an arm controller of the articulated arm to extend the articulated arm forward from the movable base and to position the gripper adjacent to the first surface of the solar panel. The solar panel can be in a first orientation relative to a body of the movable base when staged ahead of the robotic system in the row. In some implementations, the first orientation can correspond to the solar panel extending along a first plane, such as a semi-vertical or upright plane. In some implementations, the first surface of the solar panel can be substantially perpendicular to the first direction.

At block 2806, the controller can actuate the vacuum source to couple the gripper to the first surface of the solar panel. The controller can transmit a control signal to the vacuum source to generate negative pressure at a plurality of suction cups (e.g., the suction cups 108) of the gripper. The negative pressure can draw the suction cups against the first surface of the solar panel and couple the gripper to the solar panel.

At block 2808, the controller can control the articulated arm to move the solar panel to the mounting location in the environment at a second orientation relative to the body of the movable base. The controller can transmit control signals to the arm controller of the articulated arm to rotate and translate the solar panel in a second direction (e.g., the second direction D2) transverse to the first direction toward the mounting location on the torque tube. Because the gripper holds the first surface of the solar panel, the solar panel can ride above the gripper during the lateral movement, and the articulated arm can swing the solar panel to a left side or a right side of the movable base and lower the solar panel onto the torque tube at the mounting location. In the second orientation, the solar panel can extend along a second plane angled relative to a first plane along which the solar panel extended in the first orientation. The movable base can remain oriented along the first direction during coupling of the gripper to the solar panel and movement of the solar panel to the mounting location.

In some implementations, the controller can deactivate the vacuum source to decouple the gripper from the first surface after disposing the solar panel at the mounting location. The controller can control the articulated arm to move in a third direction transverse to the first direction and the second direction, and back toward the movable base along the second direction. The controller can control the movable base to advance along the first direction through the row toward a next solar panel staged ahead of the robotic system.

In some implementations, the solar panel can be a first solar panel moved according to a first operating mode of the controller, the mounting location can be a first mounting location, and the row can be a first row of the environment. The controller can operate in a second operating mode in which the movable base moves along a second direction opposite the first direction of a second row of the environment. In the second operating mode, the controller can determine a second coupling location on a next solar panel different from the coupling location used in the first operating mode. The controller can control the articulated arm and the gripper to couple to the next solar panel at the second coupling location. The controller can control the articulated arm to move the next solar panel to a second mounting location in the environment different from the first mounting location.

In some implementations, navigating the movable base can include moving the movable base along the row using a track. In some implementations, coupling the gripper to the first surface can include actuating, by the controller, the vacuum source to draw suction through the plurality of suction cups of the gripper to engage the first surface of the solar panel.

The method 2800 can be repeated for successive solar panels staged along the row as the robotic system travels along the first direction. In some implementations, the blocks of the method 2800 can be performed in a different order, can be performed in parallel, or one or more blocks can be omitted, depending on the particular implementation and the operational conditions at the installation site.

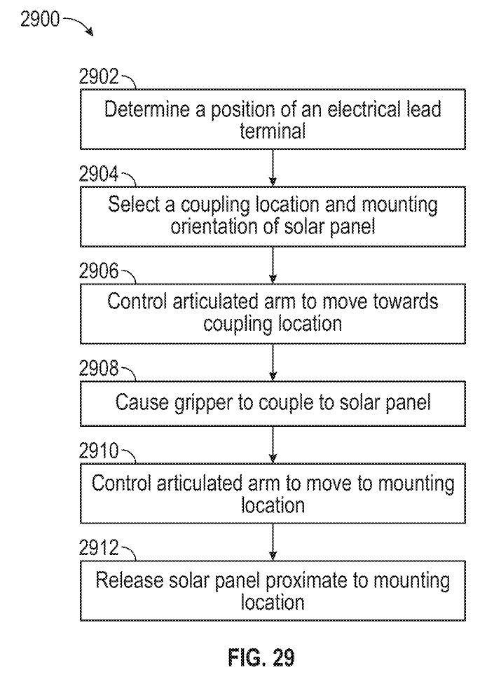

Referring now to FIG. 29, illustrated is a flow chart of a method 2900 for determining a position of an electrical lead terminal, selecting a coupling location and a mounting orientation, and installing a solar panel on a torque tube, in accordance with one or more implementations. The method 2900 can be performed by a controller (e.g., the controller 1010) of a robotic system (e.g., the robotic system 1000) that includes a movable base (e.g., the movable base 1002), an articulated arm (e.g., the articulated arm 1006) disposed on the movable base, a gripper (e.g., the gripper assembly 1003) coupled to a distal end of the articulated arm, and a vacuum source (e.g., the vacuum source 1012) housed on the movable base. The method 2900 can be performed during pick-and-place operations in which the robotic system transports solar panels from a staging location to a mounting location on racking infrastructure, such as a torque tube (e.g., the torque tube 1806) with hat rails, in an environment for solar panel installation (e.g., the installation environment 1800).

At block 2902, the controller can determine a position of an electrical lead terminal coupled to the solar panel. The controller can obtain image data from one or more arm cameras (e.g., image sensors 1320) coupled to the articulated arm and/or one or more chassis cameras (e.g., image sensors 1302) coupled to the movable base. The controller can identify, based on the image data, a position of at least one of a first electrical lead terminal (e.g., the first electrical lead terminal 2202) or a second electrical lead terminal (e.g., the second electrical lead terminal 2206) relative to the gripper. The first electrical lead terminal and the second electrical lead terminal can have predetermined locations on the solar panel stored by the controller. In some implementations, the first electrical lead terminal and the second electrical lead terminal can be at opposite edges of the solar panel, with one terminal being a positive terminal and the other being a negative terminal. The controller can distinguish between the first electrical lead terminal and the second electrical lead terminal based on visual features of the connectors depicted in the image data, such as connector shape, color, housing geometry, or relative position on the solar panel, as described with respect to FIG. 22.

At block 2904, the controller can select a coupling location on the solar panel and a mounting orientation for the solar panel based on the position of the electrical lead terminal. The coupling location can correspond to a region of a first surface (e.g., the first surface 1902) of the solar panel, such as a left side or a right side of the solar panel, at which the gripper engages the solar panel. The mounting orientation can correspond to an angular orientation at which the solar panel is to be placed on the torque tube such that the electrical lead terminal faces a target direction upon release. In some implementations, selecting the coupling location or a movement trajectory of the articulated arm can be based at least in part on a travel direction of the movable base when approaching the solar panel. The travel direction can correspond to the first direction D1 along a row (e.g., the row 1802) of the installation environment, as described with respect to FIG. 18. In some implementations, selecting the coupling location or the mounting orientation can be based at least in part on a direction at which the articulated arm moves the solar panel proximate to the mounting location on the torque tube. This direction can correspond to the second direction D2 transverse to the first direction D1. The controller can use the combined factors of the terminal position, the travel direction of the movable base, and the deployment side of the articulated arm to select among predetermined rotation paths, such as a clockwise rotation path and a counterclockwise rotation path, as described with respect to FIG. 18. In some implementations, selecting the mounting orientation can be based at least in part on a direction along which the torque tube extends. For example, if the torque tube extends along a north-south direction, the controller can select the mounting orientation such that the negative terminal of the solar panel faces north upon placement.

At block 2906, the controller can control the articulated arm to move the gripper toward the coupling location on the first surface of the solar panel. The controller can transmit a control signal to an arm controller of the articulated arm to extend the articulated arm forward from the movable base and to position the gripper adjacent to the first surface of the solar panel at the coupling location selected at block 2904. The first surface can be an underside or non-active surface of the solar panel opposite a photovoltaic surface, as described with respect to FIG. 19.

At block 2908, the controller can cause the gripper to couple to the solar panel at the coupling location, can control the articulated arm to move the solar panel to the mounting location on the torque tube in the mounting orientation, and can release the solar panel proximate to the mounting location on the torque tube. The controller can actuate the vacuum source to cause the gripper to couple to the solar panel at the coupling location. In some implementations, actuating the vacuum source can include generating negative pressure at a plurality of suction cups (e.g., the suction cups 108) of the gripper to engage the first surface of the solar panel. In some implementations, actuating the vacuum source can include actuating a plurality of vacuum sources such that a first subset of the plurality of suction cups is fluidly connected to a first vacuum source and a second subset of the plurality of suction cups is fluidly connected to a second vacuum source. In some implementations, the plurality of suction cups can include four suction cups arranged in a rectangular configuration, as described with respect to FIGS. 4A through 4G .

At block 2910, the controller can transmit control signals to the arm controller of the articulated arm to move the solar panel in the second direction D2 transverse to the first direction D1 toward the mounting location on the torque tube. The controller can transmit a control signal to the rotational actuator of the gripper to rotate the solar panel to the mounting orientation selected at block 2904. In some implementations, the controller can transmit the arm movement control signal and the gripper rotation control signal simultaneously, such that the articulated arm is moving while the rotational actuator of the gripper is simultaneously rotating the solar panel, as described with respect to FIG. 23. The controller can control the articulated arm to move the solar panel to the mounting location by positioning the electrical lead terminal such that, upon release of the solar panel, the electrical lead terminal is positioned proximate to a target connector coupled to the torque tube. This positioning can allow all solar panels along the row to be installed with consistent electrical polarity orientation.

At block 2912, the controller can release the solar panel proximate to the mounting location on the torque tube. The release can include deactivating the vacuum source and activating a positive pressure source to blow compressed air through the suction cups and break residual stiction between the suction cups and the first surface of the solar panel, as described with respect to FIG. 3. In some implementations, the controller can activate the positive pressure source for a predetermined time period and can deactivate the positive pressure source after the predetermined time period. In some implementations, the controller can command the articulated arm to retract toward the movable base while the positive pressure source is active, which can assist in physically separating the suction cups from the panel surface. In some implementations, the controller can apply a slight oscillation motion to the articulated arm during release to overcome stiction between the suction cups and the panel surface.

In some implementations, the blocks of the method 2900 can be performed in a different order, can be performed in parallel, or one or more blocks can be omitted, depending on the particular implementation and the operational conditions at the installation site. The method 2900 can be repeated for successive solar panels staged along the row as the robotic system travels along the first direction D1 as well as for additional rows.

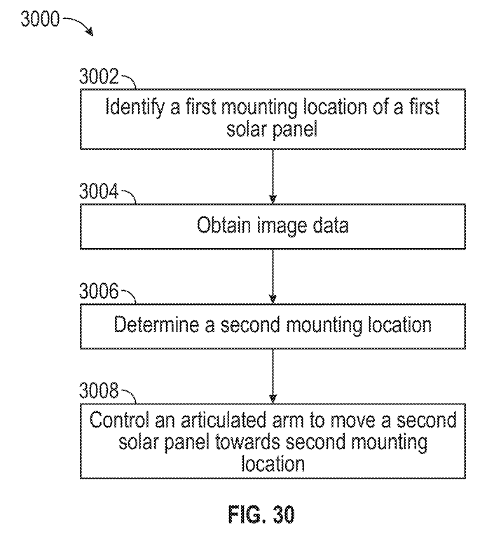

Referring now to FIG. 30, illustrated is a flow chart of a method 3000 for determining a mounting location for placement of a solar panel using image data and prior placement information, in accordance with one or more implementations. The method 3000 can be performed by a controller (e.g., the controller 1010) of a robotic system (e.g., the robotic system 1000) that includes a movable base (e.g., the movable base 1002), an articulated arm (e.g., the articulated arm 1006) disposed on the movable base, a gripper (e.g., the gripper assembly 1003) coupled to a distal end of the articulated arm, and a vacuum source (e.g., the vacuum source 1012) housed on the movable base. The method 3000 can be performed during pick-and-place operations in which the robotic system transports solar panels from a staging location to a mounting location on racking infrastructure, such as a torque tube (e.g., the torque tube 1806) with hat rails, in an environment for solar panel installation (e.g., the installation environment 1800).

At block 3002, the controller can identify a first mounting location of a first solar panel on a torque tube. The first solar panel can be a solar panel (e.g., the solar panel 1804) that has been placed on the torque tube at the first mounting location (e.g., the first mounting location 1808) in a prior pick-and-place cycle by the robotic system, or the first solar panel can have been placed by another means. The first mounting location can serve as a reference anchor from which the controller determines the position of subsequent mounting locations along the torque tube. In some implementations, prior to identifying the first mounting location, the controller can control the articulated arm to move the first solar panel to the first mounting location on the torque tube at a first mounting orientation. The controller can identify the first mounting location based on the known location at which the first solar panel was placed, or based on image data depicting the first solar panel on the torque tube, as described with respect to FIG. 18.

At block 3004, the controller can obtain image data depicting an environment including the torque tube. The image data can be obtained from at least one of a first set of cameras coupled to the articulated arm (e.g., image sensors 1320) or a second set of cameras coupled to the movable base (e.g., image sensors 1302). The arm cameras can capture image data from a vantage point at the distal end of the articulated arm, and the chassis cameras can capture image data from fixed positions on the chassis of the movable base. The controller can select which of the chassis cameras or the arm cameras to use based on viewing conditions affecting one or more of the image sensors, such as sun angle or glare that may degrade the image quality from a particular image sensor at a given time of day, as described with respect to FIG. 18. The image data can depict the torque tube, the first solar panel at the first mounting location, the hat rails, and the surrounding terrain of the installation environment.

At block 3006, the controller can determine, based on the image data and the first mounting location, a second mounting location for a second solar panel. The second mounting location (e.g., the second mounting location 1810) can be proximate to the first mounting location on the torque tube. The controller can calculate an offset from the first mounting location based on the known dimensions of the first solar panel, the spacing between adjacent panel positions on the torque tube, and the position of the hat rails along the torque tube as depicted in the image data. By referencing the first mounting location as an anchor, the controller can determine the second mounting location without relying on absolute positioning information, as described with respect to FIG. 18. In some implementations, the controller can determine, based on the image data, that the second solar panel is within a threshold distance of the second mounting location. The threshold distance can be, for example, about 5 mm, about 10 mm, about 15 mm, about 20 mm, about 25 mm, about 50 mm, or about 100 mm, among others. The controller can release the second solar panel in response to determining that the second solar panel is within the threshold distance of the second mounting location. The controller can withhold a release operation until the second solar panel is within the threshold distance of the second mounting location.

At block 3008, the controller can control the articulated arm to move the second solar panel toward the second mounting location on the torque tube proximate to the first solar panel. Prior to moving the second solar panel toward the second mounting location, the controller can control the articulated arm to couple the gripper to the second solar panel. The gripper can couple to the second solar panel via the vacuum source. The controller can actuate the vacuum source to generate negative pressure at a plurality of suction cups (e.g., the suction cups 108) of the gripper, and the suction cups can engage a surface of the second solar panel. In some implementations, the vacuum source can include a plurality of vacuum sources, and a first subset of the plurality of suction cups can be fluidly connected to a first vacuum source and a second subset of the plurality of suction cups can be fluidly connected to a second vacuum source, as described with respect to FIG. 3.

In some implementations, controlling the articulated arm to move the second solar panel toward the second mounting location can include adjusting a position of the movable base while the second solar panel is coupled to the gripper. If the movable base is too far from the torque tube for the articulated arm to reach the second mounting location, the controller can control the movable base to move toward the torque tube while the second solar panel is coupled to the gripper. The controller can control the articulated arm to move the second solar panel toward the second mounting location in response to the movable base being within a second threshold distance of the torque tube. This coordinated movement of the movable base and the articulated arm can allow the robotic system to accommodate varying lateral distances between the row (e.g., the row 1802) and the torque tube across different regions of the installation environment, as described with respect to FIG. 18.

In some implementations, the controller can cause a user interface (e.g., the user interface 1014) to display one or more graphical indicators representing at least one of: the first mounting location, the second mounting location, a distance between the movable base and the torque tube, or a distance between the second solar panel and the second mounting location. The graphical indicators can include color-coded visual cues, such as red, yellow, and green indicators that represent proximity and alignment of the second solar panel to the second mounting location, as described with respect to FIG. 18. In some implementations, the same camera-based placement determination can be used in an autonomous mode in which the controller calculates the offset from the reference panel and executes placement without operator mediation through the user interface.

In some implementations, the blocks of the method 3000 can be performed in a different order, can be performed in parallel, or one or more blocks can be omitted, depending on the particular implementation and the operational conditions at the installation site. The method 3000 can be repeated for successive solar panels staged along the row as the robotic system travels along the first direction D1 and additional rows.

### D.Image Sensor Calibration

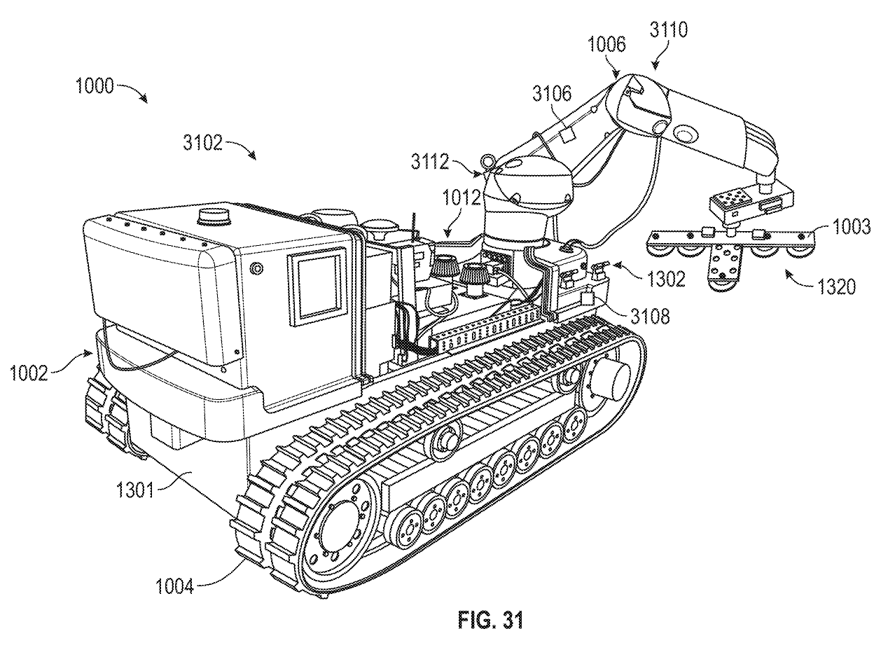

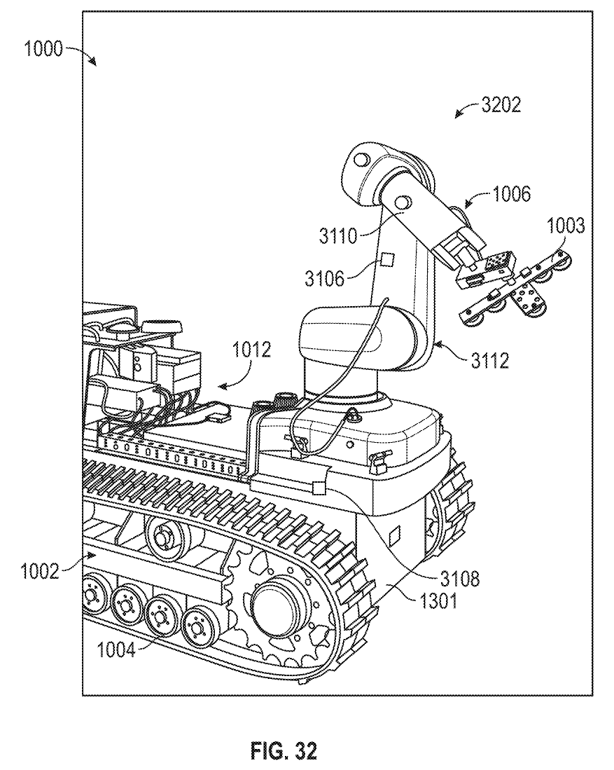

Referring now to FIG. 31 and FIG. 32, illustrated are perspective views of the robotic system 1000 depicting calibration marker positions and articulated arm poses for camera calibration, in accordance with one or more implementations. FIG. 31 can depict the articulated arm 1006 in a first pose 3102 relative to the movable base 1002, and FIG. 32 can depict the articulated arm 1006 in a second pose 3202 relative to the movable base 1002. As described with respect to FIG. 1 through FIG. 3, the robotic system 1000 can include the movable base 1002, the articulated arm 1006 disposed on the movable base 1002, the gripper assembly 1003 coupled to a distal end of the articulated arm 1006, the controller 1010, the vacuum source 1012, one or more image sensors 1302 coupled to the movable base 1002, and one or more image sensors 1320 coupled to the articulated arm 1006.

As shown in FIG. 31, the articulated arm 1006 can include a proximal portion 3110 coupled to the movable base 1002 and a distal portion 3112 opposite the proximal portion 3110. The proximal portion 3110 can be a base segment of the articulated arm 1006 that is mounted to the chassis 1301 of the movable base 1002 and that serves as the attachment point between the articulated arm 1006 and the movable base 1002. The distal portion 3112 can be the segment of the articulated arm 1006 at which the gripper assembly 1003 is coupled, opposite the proximal portion 3110 in the serial kinematic chain of the articulated arm 1006. The one or more image sensors 1320 can be coupled to the articulated arm 1006 proximate to the distal portion 3112, as described with respect to FIG. 3. At least one of a pose or position of each of the image sensors 1302 can be fixed relative to the movable base 1002, such that each image sensor 1302 maintains a constant position and orientation in the coordinate frame of the movable base 1002 regardless of the configuration of the articulated arm 1006. At least one of a pose or position of each of the image sensors 1320 can be fixed relative to the articulated arm 1006, such that each image sensor 1320 moves with the articulated arm 1006 as the articulated arm 1006 changes position and orientation during operation.

As shown in FIG. 31, the robotic system 1000 can include a first marker 3106 (e.g., a calibration target, checkerboard, fiducial pattern, ArUco tag, visually detectable reference, etc.) positioned on the articulated arm 1006 and a second marker 3108 (e.g., a calibration target, checkerboard, fiducial pattern, ArUco tag, visually detectable reference, etc.) positioned on the movable base 1002. The first marker 3106 can be a calibration marker, such as a checkerboard pattern, a fiducial target, a circular dot pattern, or another visually detectable pattern, that is positioned on the articulated arm 1006 proximate to the distal portion 3112 (e.g., a distal segment, end segment, terminal link, outermost arm section, etc.). The first marker 3106 can be positioned on a surface of the articulated arm 1006 that faces the image sensors 1302 on the chassis 1301 of the movable base 1002 when the articulated arm 1006 is in one or more calibration poses. In some implementations, the first marker 3106 can be removably attached to the articulated arm 1006, such as by adhesive, a magnetic mount, a clip, or a bracket, and can be attached to the articulated arm 1006 prior to a calibration procedure and removed after calibration is complete. In some implementations, the first marker 3106 can be permanently affixed to the articulated arm 1006. As depicted in FIG. 31, the first marker 3106 can be visible as a patterned element positioned proximate to the distal portion 3112 of the articulated arm 1006, on a surface that is viewable by the image sensors 1302 when the articulated arm 1006 is in the first pose 3102. The first marker 3106 can be used to calibrate the image sensors 1302 on the movable base 1002 by providing a visually detectable reference target that appears at known positions within the fields of view of the image sensors 1302 as the articulated arm 1006 moves between different poses.

The second marker 3108 can be a calibration marker positioned on the movable base 1002 on a surface that can be observed by the image sensors 1320 coupled to the articulated arm 1006. The second marker 3108 can be a checkerboard pattern, a fiducial target, a circular dot pattern, or another visually detectable pattern. As shown in FIG. 31, the second marker 3108 can be positioned on a lateral surface or an upper surface of the chassis 1301 of the movable base 1002, at a location that is within the field of view of the image sensors 1320 when the articulated arm 1006 is moved to one or more calibration poses for arm-camera calibration. The second marker 3108 can be positioned such that the second marker 3108 is outside the field of view of the image sensors 1320 during at least the first pose 3102 and the second pose 3202 used for calibrating the image sensors 1302. That is, when the controller 1010 causes the articulated arm 1006 to move to the first pose 3102 and the second pose 3202 for calibrating the image sensors 1302, the second marker 3108 on the movable base 1002 can be outside the field of view of the image sensors 1320, such that the second marker 3108 does not appear in images captured by the image sensors 1320 during those poses. This positioning can allow the controller 1010 to select the first pose 3102 and the second pose 3202 such that the first marker 3106 is depicted in images captured by the image sensors 1302 and is not depicted in images captured by the image sensors 1320, which can isolate the calibration of the image sensors 1302 from the calibration of the image sensors 1320 when separate calibration routines are performed.

As depicted in FIG. 31, the articulated arm 1006 can be in the first pose 3102 in which the first marker 3106 is within the field of view of at least one of the image sensors 1302 on the movable base 1002. The first pose 3102 can correspond to a particular joint configuration of the articulated arm 1006 in which the distal portion 3112 is oriented such that the surface of the articulated arm 1006 carrying the first marker 3106 faces toward the image sensors 1302. The controller 1010 can cause the articulated arm 1006 to move to the first pose 3102 by transmitting a control signal to the arm controller of the articulated arm 1006. The articulated arm 1006 can report precise pose information, including XYZ coordinates and orientation, at the first pose 3102 based on encoder data and internal kinematics of the articulated arm 1006. The controller 1010 can capture a first image using the image sensor 1302 while the articulated arm 1006 is in the first pose 3102. The first image can depict the first marker 3106 at a first position within the image frame of the image sensor 1302.

As depicted in FIG. 32, the articulated arm 1006 can be in the second pose 3202 in which the first marker 3106 is within the field of view of the same image sensor 1302 but at a different position within the image frame compared to the first pose 3102. The second pose 3202 can correspond to a different joint configuration of the articulated arm 1006 from the first pose 3102, such that the distal portion 3112 is positioned at a different spatial location relative to the movable base 1002 and the first marker 3106 appears at different pixel coordinates in the image captured by the image sensor 1302. The controller 1010 can cause the articulated arm 1006 to move from the first pose 3102 to the second pose 3202 by transmitting a control signal to the arm controller. The articulated arm 1006 can report precise pose information at the second pose 3202, including XYZ coordinates and orientation of the distal portion 3112, based on encoder data and internal kinematics of the articulated arm 1006.

The controller 1010 can capture a second image using the image sensor 1302 while the articulated arm 1006 is in the second pose 3202. The second image can depict the first marker 3106 at a second position within the image frame that is different from the first position. As depicted in FIG. 32, the articulated arm 1006 can carry the gripper assembly 1003 at a distal end of the articulated arm 1006, and the first marker 3106 can remain visible on the articulated arm 1006 proximate to (e.g., on, etc.) the distal portion 3112 in the second pose 3202, with the surface carrying the first marker 3106 facing toward the image sensors 1302.

The second marker 3108 can be visible on the chassis 1301 of the movable base 1002 at the same position as depicted in FIG. 31, because the second marker 3108 is fixed to the movable base 1002 and does not change position as the articulated arm 1006 moves between poses. The first pose 3102 and the second pose 3202 may not be predetermined positions, and the controller 1010 can use any two or more poses of the articulated arm 1006 at which the first marker 3106 is within the field of view of the image sensor 1302, so long as the pose of the articulated arm 1006 is known at each position. For example, the first pose 3102 and the second pose 3202 depicted in FIGS. 31 and 32 are example poses, and the controller 1010 can cause the articulated arm 1006 to transition to any number of poses for calibration.

The controller 1010 can determine first pixel coordinates of the first marker 3106 depicted in the first image and second pixel coordinates of the first marker 3106 depicted in the second image. The pixel coordinates can represent the location of the first marker 3106 within the image frame of the image sensor 1302 in each respective image. In some implementations, the controller 1010 can apply a pattern detection algorithm to each image to identify the first marker 3106 and to determine the pixel coordinates of the center, corners, or other feature points of the first marker 3106 within the image. For example, if the first marker 3106 is a checkerboard pattern, the controller 1010 can detect the intersections of the checkerboard squares within each image and can determine the pixel coordinates of each detected intersection point. If the first marker 3106 is an ArUco marker or a fiducial target, the controller 1010 can detect the corner points and/or the centroid of the marker within each image and can determine the pixel coordinates of the detected corner points and/or centroid.

The controller 1010 can update a calibration data structure for the image sensor 1302 based on the first pixel coordinates, the second pixel coordinates, the first pose 3102, and the second pose 3202. The calibration data structure can include intrinsic parameters, extrinsic parameters, distortion coefficients, or a combination thereof for the image sensor 1302. The intrinsic parameters can include a focal length of the image sensor 1302 along a horizontal axis and a vertical axis of the image frame, a principal point that represents the optical center of the image sensor 1302 in pixel coordinates, and/or a skew coefficient that represents the non-orthogonality between the horizontal axis and the vertical axis of the image sensor. The extrinsic parameters can include a rotation matrix and a translation vector that relate the coordinate frame of the image sensor 1302 to the coordinate frame of the movable base 1002. The distortion coefficients can include radial distortion coefficients and/or tangential distortion coefficients that model lens distortion effects of the image sensor 1302. In some implementations, the calibration data structure can include a camera matrix that encodes the intrinsic parameters as a three-by-three matrix, and/or a distortion vector that stores the distortion coefficients as an ordered array.

To update the calibration data structure, the controller 1010 can calculate a three-dimensional position of the first marker 3106 in the coordinate frame of the movable base 1002 at the first pose 3102 and at the second pose 3202 based on the pose information reported by the articulated arm 1006 at each respective pose. The pose information reported by the articulated arm 1006 can include the position and orientation of the distal portion 3112 in the coordinate frame of the movable base 1002, based on encoder data from rotary encoders at the joints of the articulated arm 1006 and forward kinematics computations performed by the arm controller. Because the first marker 3106 is positioned at a known offset relative to the distal portion 3112, the controller 1010 can transform the reported pose of the distal portion 3112 by the known offset to obtain the three-dimensional position and orientation of the first marker 3106 in the coordinate frame of the movable base 1002 at the first pose 3102 and the second pose 3202. In some implementations, the articulated arm 1006 can include a proximal portion 3112 (e.g., a proximal segment, base segment, root link, innermost arm section, etc.) coupled to the movable base 1002.

The controller 1010 can establish a set of correspondences between the three-dimensional positions of the first marker 3106 in the coordinate frame of the movable base 1002 and the respective pixel coordinates of the first marker 3106 in the first image and the second image. Each correspondence can pair a three-dimensional point in the coordinate frame of the movable base 1002 with a two-dimensional point in the image frame of the image sensor 1302. The controller 1010 can use the set of correspondences to solve for the calibration parameters by minimizing a reprojection error. The reprojection error can be defined as a difference between the determined pixel coordinates of the first marker 3106 in each captured image and predicted pixel coordinates that are generated by projecting the three-dimensional position of the first marker 3106 through a camera model parameterized by the intrinsic parameters, extrinsic parameters, and distortion coefficients. The controller 1010 can apply a non-linear least-squares solver, such as a Levenberg-Marquardt algorithm or a Gauss-Newton algorithm, to iteratively adjust the intrinsic parameters, the extrinsic parameters, and/or the distortion coefficients until the reprojection error across the set of correspondences is minimized or falls below a predetermined error threshold. The controller 1010 can then store the output of the solver as updated calibration parameters. In some implementations, the controller 1010 can apply a Perspective-n-Point (PnP) algorithm to the set of correspondences to solve for the extrinsic parameters given known or previously stored intrinsic parameters, and can refine the extrinsic parameters using the non-linear least-squares solver. In some implementations, the controller 1010 can solve for the intrinsic parameters and the extrinsic parameters jointly when both parameter sets are to be updated.

The controller 1010 can store the updated calibration parameters in the calibration data structure. In some implementations, the calibration data structure can be stored in a memory device of the controller 1010 or in a memory device of the movable base 1002. The controller 1010 can retrieve the stored calibration data structure during subsequent pick-and-place operations and can apply the stored intrinsic parameters, extrinsic parameters, and/or distortion coefficients to image data received from the image sensor 1302 to map pixel coordinates in the image data to three-dimensional positions in the coordinate frame of the movable base 1002.

In some implementations, the controller 1010 can cause the articulated arm 1006 to move to additional poses beyond the first pose 3102 and the second pose 3202 to capture additional images, which can increase the number of three-dimensional-to-two-dimensional correspondences available for the calibration computation and can reduce the residual reprojection error of the updated calibration data structure. For example, the controller 1010 can cause the articulated arm 1006 to move to three or more poses at which the first marker 3106 is within the field of view of the image sensor 1302, and the controller 1010 can capture a respective image at each pose and can include the pixel coordinates from each captured image in the set of correspondences used by the solver. Increasing the number of correspondences can over-constrain the calibration problem and can reduce susceptibility of the solution to noise in the pixel coordinate determinations or in the pose information reported by the articulated arm 1006.In some implementations, the controller 1010 can calibrate the image sensors 1320 on the articulated arm 1006 using the second marker 3108 on the movable base 1002.

The second marker 3108 can be a visually detectable pattern that is fixed to the chassis 1301 of the movable base 1002 at a known position in the coordinate frame of the movable base 1002. Because the second marker 3108 is stationary relative to the movable base 1002 while the articulated arm 1006 moves between poses, the controller 1010 can correlate changes in the pixel position of the second marker 3108 within images captured by the image sensor 1320 with changes in the pose of the articulated arm 1006 as reported by the arm encoders and internal kinematics. The controller 1010 can cause the articulated arm 1006 to move to a third pose such that the second marker 3108 enters a field of view of the image sensor 1320. The third pose can orient the articulated arm 1006 such that the image sensor 1320 faces toward the chassis 1301 of the movable base 1002 where the second marker 3108 is located. The controller 1010 can capture a third image using the image sensor 1320 while the articulated arm 1006 is in the third pose. The third image can depict the second marker 3108 at a first position within the image frame of the image sensor 1320.

The controller 1010 can cause the articulated arm 1006 to move to a fourth pose such that the second marker 3108 enters the field of view of the image sensor 1320 at a different position within the image frame. The fourth pose can correspond to a different joint configuration of the articulated arm 1006 from the third pose, such that the image sensor 1320 views the second marker 3108 from a different vantage point relative to the chassis 1301. The controller 1010 can capture a fourth image using the image sensor 1320 while the articulated arm 1006 is in the fourth pose. The controller 1010 can determine third pixel coordinates of the second marker 3108 depicted in the third image and fourth pixel coordinates of the second marker 3108 depicted in the fourth image. In some implementations, the controller 1010 can apply a pattern detection algorithm to each of the third image and the fourth image to identify corner points, edge intersections, or centroid locations of the second marker 3108 and to determine the pixel coordinates of those feature points within the respective image frames.

The controller 1010 can update a calibration data structure for the image sensor 1320 based on the third pixel coordinates, the fourth pixel coordinates, the third pose, and the fourth pose. The calibration data structure for the image sensor 1320 can include intrinsic parameters such as focal length, principal point, and distortion coefficients, and/or extrinsic parameters that relate the coordinate frame of the image sensor 1320 to the coordinate frame of the articulated arm 1006 at the distal portion 3112. To update the calibration data structure, the controller 1010 can compute a mapping between the pixel coordinates of the second marker 3108 in the captured images and the known three-dimensional position of the second marker 3108 in the coordinate frame of the movable base 1002. Because the controller 1010 has the pose of the articulated arm 1006 at the third pose and the fourth pose from the arm encoders and internal kinematics, and because the position of the second marker 3108 on the movable base 1002 is known, the controller 1010 can compute the three-dimensional position of the second marker 3108 in the coordinate frame of the image sensor 1320 at each pose. The controller 1010 can compare the computed three-dimensional positions with the corresponding pixel coordinates in the third image and the fourth image and can solve for updated intrinsic and/or extrinsic calibration parameters that minimize a reprojection error between the predicted pixel coordinates and the determined pixel coordinates. In some implementations, the controller 1010 can cause the articulated arm 1006 to move to additional poses beyond the third pose and the fourth pose in which the second marker 3108 is within the field of view of the image sensor 1320, which can increase the number of data points available for the calibration computation and can improve the accuracy of the updated calibration data structure.

The use of separate markers on the articulated arm 1006 and the movable base 1002 can provide independent calibration targets for the image sensors 1302 and the image sensors 1320, respectively. The first marker 3106 on the articulated arm 1006 moves with the articulated arm 1006 and appears at varying positions within the fields of view of the image sensors 1302 that are fixed to the chassis 1301, which can allow the controller 1010 to calibrate the image sensors 1302 by varying the position of the first marker 3106 through arm movement. The second marker 3108 on the movable base 1002 is stationary relative to the chassis 1301 and appears at varying positions within the field of view of the image sensor 1320 as the articulated arm 1006 changes pose, which can allow the controller 1010 to calibrate the image sensor 1320 by varying the vantage point of the image sensor 1320 through arm movement. This arrangement can allow the controller 1010 to calibrate both image sensor sets using the same actuation resource, the articulated arm 1006, without external calibration fixtures or targets external to the robotic system 1000.

In some implementations, the separate marker arrangement can allow the controller 1010 to isolate the calibration of the image sensors 1302 from the calibration of the image sensors 1320 when independent calibration routines are performed for each image sensor set. In some implementations, the separate marker arrangement can allow the controller 1010 to perform field recalibration at the solar installation site without dismounting the articulated arm 1006, the image sensors 1302, or the image sensors 1320 from the robotic system 1000, which can address calibration degradation that may occur due to vibrations, thermal cycling, and/or environmental exposure during operation. In some implementations, through the user interface 1014, an operator can select one or more of the image sensors 1302 or the image sensors 1320 for calibration. The controller 1010 can receive, via the user interface, a selection of at least one of the image sensors 1302 or the image sensors 1320 for calibration. In response to receiving the selection, the controller 1010 can initiate the calibration procedure for the selected image sensors. In some implementations, the operator can select a single image sensor 1302, a subset of the image sensors 1302, the image sensors 1320, or all of the image sensors 1302 and the image sensors 1320 for calibration via the user interface 1014.

In some implementations, in response to receiving a selection of both the image sensors 1302 and the image sensors 1320 for calibration, the controller 1010 can perform simultaneous calibration of the image sensors 1302 and the image sensors 1320. The controller 1010 can select the first pose 3102 and the second pose 3202 such that the first marker 3106 on the articulated arm 1006 enters the field of view of the image sensors 1302 and the second marker 3108 on the movable base 1002 enters the field of view of the image sensors 1320 simultaneously. In such poses, the first image and the second image captured by the image sensors 1302 can depict the first marker 3106, and images captured by the image sensors 1320 at the same poses can depict the second marker 3108. The controller 1010 can update the calibration data structure for the image sensors 1302 and the image sensors 1320 based on the first pose 3102 and the second pose 3202. Simultaneous calibration can reduce the number of poses traversed by the articulated arm 1006 compared to performing separate calibration routines for the image sensors 1302 and the image sensors 1320, which can reduce the time for the calibration procedure. In some implementations, the controller 1010 can select poses for simultaneous calibration that orient the articulated arm 1006 such that the first marker 3106 faces the image sensors 1302 on the chassis 1301 while the image sensor 1320 on the articulated arm 1006 faces the second marker 3108 on the chassis 1301, such that both markers are within the respective fields of view of their target image sensors at the same arm configuration.

The calibration procedure depicted in FIGS. 31 and 32 can allow the robotic system 1000 to recalibrate the image sensors 1302 and the image sensors 1320 in the field without external calibration fixtures. The articulated arm 1006 can provide precise pose information at each calibration position from its encoders and internal kinematics, and the controller 1010 can use the known arm poses and the pixel coordinates of the first marker 3106 and the second marker 3108 in the captured images to update the calibration data structures for the respective image sensors. This calibration approach can address degradation of camera calibration that may occur over time due to vibrations, thermal cycling, and environmental exposure during operation at solar installation sites.

In some implementations, the controller 1010 can repeat the calibration procedure for each of the image sensors 1302 on the movable base 1002 by causing the articulated arm 1006 to move to additional poses in which the first marker 3106 enters the field of view of each respective image sensor 1302. For example, if the movable base 1002 includes four image sensors 1302 as described with respect to FIG. 3, the controller 1010 can cause the articulated arm 1006 to move to a series of poses in which the first marker 3106 sequentially enters the field of view of each of the four image sensors 1302, and the controller 1010 can capture images and determine pixel coordinates for each image sensor 1302 independently. In some implementations, the controller 1010 can cause the articulated arm 1006 to move to more than two poses for a given image sensor 1302, which can increase the number of calibration data points and improve the accuracy of the updated calibration data structure for that image sensor 1302.

As depicted in FIGS. 31 and 32 , the proximal portion 3110 of the articulated arm 1006 can remain coupled to the chassis 1301 of the movable base 1002, and the tracks 1004 can remain in contact with the ground surface beneath the movable base 1002 throughout the calibration procedure. The vacuum source 1012 can be housed on the movable base 1002 and can maintain vacuum in an active state while a solar panel is coupled to the gripper assembly 1003 during the calibration procedure, as described with respect to FIG. 3. In some implementations, the calibration procedure can be performed while the gripper assembly 1003 is not retaining a solar panel, in which case the vacuum source 1012 can be in an inactive state during the calibration procedure. This flexibility can allow the calibration procedure to be performed in a variety of arm configurations without constraining the articulated arm 1006 to specific predefined positions, which can simplify the calibration procedure and can accommodate situations in which physical obstacles or operational constraints limit the available arm configurations at a given installation site.

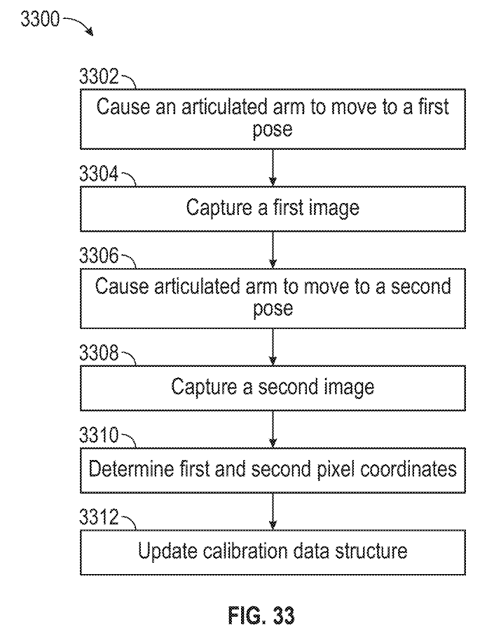

Referring now to FIG. 33, illustrated is a flow chart of a method 3300 for calibrating image sensors of a robotic system (e.g., the robotic system 1000) using different articulated arm poses and captured images, in accordance with one or more implementations. The method 3300 can be performed by a controller (e.g., the controller 1010) of the robotic system that includes a movable base (e.g., the movable base 1002), an articulated arm (e.g., the articulated arm 1006) disposed on the movable base, a first image sensor (e.g., one of the image sensors 1302) coupled to the movable base, a second image sensor (e.g., one of the image sensors 1320) coupled to the articulated arm, a first marker (e.g., the first marker 3106) positioned on the articulated arm, and a second marker (e.g., the second marker 3108) positioned on the movable base. The method 3300 can calibrate the first image sensor, the second image sensor, or both image sensors by leveraging known arm poses and the pixel positions of the markers within captured images to update calibration data structures for the respective image sensors.

At block 3302, the controller can cause the articulated arm disposed on the movable base to move to a first pose such that the first marker positioned on the articulated arm enters a field of view of the first image sensor coupled to the movable base. The controller can transmit a control signal to an arm controller of the articulated arm to transition the articulated arm from a current joint configuration to the first pose. The articulated arm can include a proximal portion coupled to the movable base and a distal portion opposite the proximal portion. The second image sensor can be coupled to the distal portion of the articulated arm, and the first marker can be positioned proximate to the distal portion of the articulated arm on a surface facing the first image sensor. At least one of a position or a pose of the first image sensor can be fixed relative to the movable base, and at least one of a position or a pose of the second image sensor can be fixed relative to the articulated arm. The first pose can correspond to a joint configuration of the articulated arm in which the distal portion is oriented such that the surface carrying the first marker faces toward the first image sensor on the movable base. The articulated arm can report precise pose information at the first pose based on encoder data and internal kinematics. The first pose may not be a predetermined position. The controller can use any pose at which the first marker enters the field of view of the first image sensor and at which the pose of the articulated arm is known.

In some implementations, the second marker can be positioned on the movable base such that the second marker is outside a field of view of the second image sensor during at least the first pose and the second pose. This positioning can isolate the calibration of the first image sensor from the calibration of the second image sensor when separate calibration routines are performed.

At block 3304, the controller can capture a first image using the first image sensor while the articulated arm is in the first pose. The controller can transmit a capture command to the first image sensor and can receive the first image in response. The first image can depict the first marker at a first position within the image frame of the first image sensor. In some implementations, the first image can include RGB image data, depth image data, or RGB-D image data. The first image can depict the first marker as a checkerboard pattern, a fiducial target, an ArUco marker, a circular dot pattern, or another visually detectable pattern positioned on the articulated arm proximate to the distal portion.

At block 3306, the controller can cause the articulated arm to move to a second pose such that the first marker enters the field of view of the first image sensor. The second pose can correspond to a different joint configuration of the articulated arm from the first pose, such that the distal portion is positioned at a different spatial location relative to the movable base and the first marker appears at a different position within the image frame of the first image sensor compared to the first pose. The controller can transmit a control signal to the arm controller of the articulated arm to transition the articulated arm from the first pose to the second pose. The articulated arm can report precise pose information at the second pose, including XYZ coordinates and orientation of the distal portion, based on encoder data and internal kinematics. The second pose may not be predetermined, and the controller can select any pose at which the first marker is within the field of view of the first image sensor and at which the arm pose is known.

At block 3308, the controller can capture a second image using the first image sensor while the articulated arm is in the second pose. The controller can transmit a capture command to the first image sensor and can receive the second image in response. The second image can depict the first marker at a second position within the image frame of the first image sensor that is different from the first position. The different position of the first marker in the second image relative to the first image can be a result of the change in arm configuration between the first pose and the second pose.

At block 3310, the controller can determine first pixel coordinates of the first marker depicted in the first image and second pixel coordinates of the first marker depicted in the second image. The first pixel coordinates can represent the location of the first marker within the image frame of the first image sensor in the first image. The second pixel coordinates can represent the location of the first marker within the image frame of the first image sensor in the second image. In some implementations, the controller can apply a pattern detection algorithm to each image to identify the first marker and to determine the pixel coordinates of the center, corners, or other feature points of the first marker within the image. For example, if the first marker is a checkerboard pattern, the controller can detect the intersections of the checkerboard squares and can determine the pixel coordinates of the detected intersections. The change in pixel coordinates between the first image and the second image can correspond to the change in spatial position of the first marker between the first pose and the second pose.

At block 3312, the controller can update a calibration data structure for the first image sensor based on the first pixel coordinates, the second pixel coordinates, the first pose, and the second pose. The calibration data structure can include intrinsic parameters, extrinsic parameters, distortion coefficients, or a combination thereof for the first image sensor. The controller can compare the change in pixel coordinates of the first marker between the first image and the second image with the known change in pose of the articulated arm between the first pose and the second pose. Based on this comparison, the controller can calculate updated calibration parameters that relate the pixel coordinates of the first image sensor to positions in a physical coordinate frame of the movable base. In some implementations, the controller can cause the articulated arm to move to additional poses beyond the first pose and the second pose to capture additional images, which can increase the number of calibration data points and improve the accuracy of the calibration data structure.

In some implementations, the controller can receive, via a user interface (e.g., the user interface 1014), a selection of at least one of the first image sensor or the second image sensor for calibration. In response to receiving the selection, the controller can initiate the method 3300 for the selected image sensor or image sensors. In some implementations, the operator can select a single image sensor, a subset of image sensors, or all image sensors for calibration via the user interface.

In some implementations, the controller can calibrate the second image sensor coupled to the articulated arm using the second marker positioned on the movable base. The controller can cause the articulated arm to move to a third pose such that the second marker enters a field of view of the second image sensor. The controller can capture a third image using the second image sensor while the articulated arm is in the third pose. The third image can depict the second marker at a first position within the image frame of the second image sensor. The controller can cause the articulated arm to move to a fourth pose such that the second marker enters the field of view of the second image sensor at a different position within the image frame. The controller can capture a fourth image using the second image sensor while the articulated arm is in the fourth pose. The controller can determine third pixel coordinates of the second marker depicted in the third image and fourth pixel coordinates of the second marker depicted in the fourth image. The controller can update a calibration data structure for the second image sensor based on the third pixel coordinates, the fourth pixel coordinates, the third pose, and the fourth pose. The third and fourth poses can orient the second image sensor toward the movable base where the second marker is located, such that the second marker is within the field of view of the second image sensor at each pose.

In some implementations, in response to receiving a selection of both the first image sensor and the second image sensor for calibration, the controller can perform simultaneous calibration of both image sensors. The controller can select the first pose and the second pose such that the first marker enters the field of view of the first image sensor and the second marker enters the field of view of the second image sensor simultaneously. In such poses, the first image and the second image can each depict the first marker and the second marker. The controller can update the calibration data structure for the first image sensor and the second image sensor based at least on the first pose and the second pose. Simultaneous calibration can reduce the number of poses traversed by the articulated arm compared to performing separate calibration routines for the first image sensor and the second image sensor, which can reduce the time for the calibration procedure.

In some implementations, the method 3300 can allow the robotic system to recalibrate the first image sensor and the second image sensor in the field without external calibration fixtures. The articulated arm can provide precise pose information at each calibration position from its encoders and internal kinematics, and the controller can use the known arm poses and the pixel coordinates of the first marker and the second marker in the captured images to update the calibration data structures for the respective image sensors. This calibration approach can address degradation of camera calibration that can occur over time due to vibrations, thermal cycling, and environmental exposure during operation at solar installation sites. In some implementations, the controller can cause the articulated arm to move to more than two poses for a given image sensor, which can increase the number of calibration data points and can improve the accuracy of the updated calibration data structure for that image sensor.

In some implementations, the blocks of the method 3300 can be performed in a different order, can be performed in parallel, or one or more blocks can be omitted, depending on the particular implementation and the operational conditions at the installation site. For example, the controller can perform block 3302 through block 3312 for the first image sensor, and can perform corresponding blocks for the second image sensor as a subsequent sequence or as a concurrent sequence in which both image sensors are calibrated using the same arm poses.

### E.Movement Restrictions of Robotic System for Safety

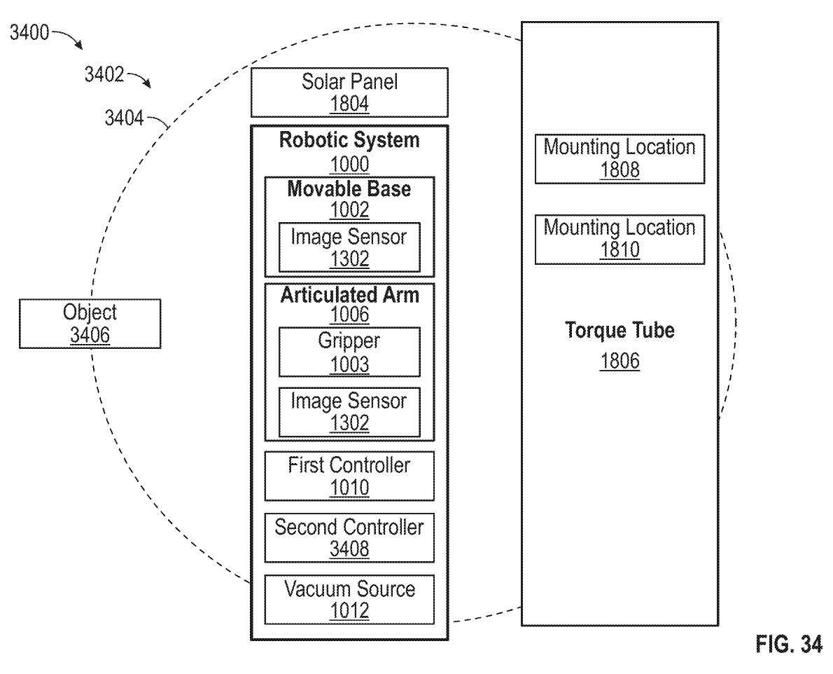

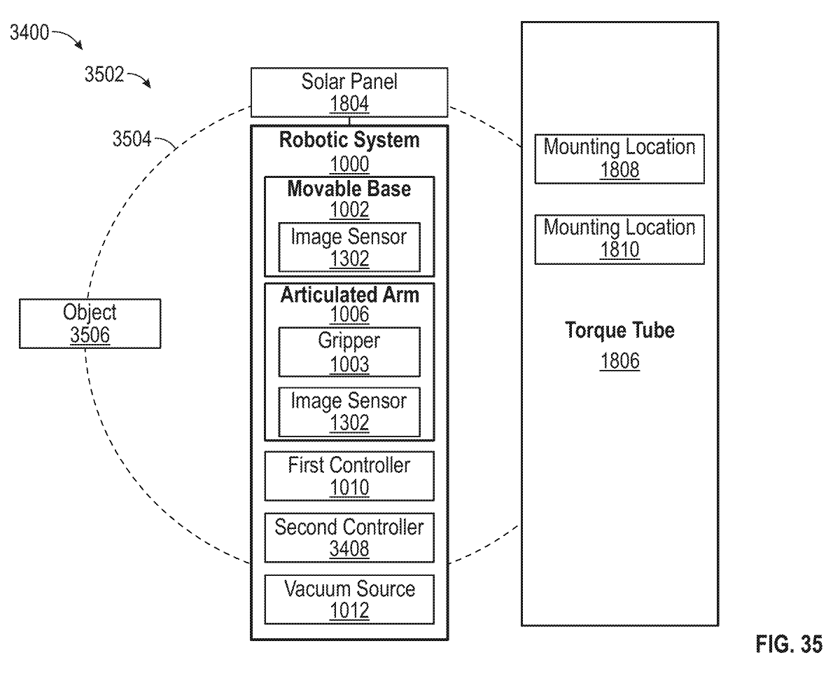

Referring now to FIGS. 34 and 35 , illustrated are schematic diagrams of an environment 3400 implementing camera-based safety restriction during solar panel installation operations, in accordance with one or more implementations. The environment 3400 can include the robotic system 1000, the solar panel 1804, the torque tube 1806, the mounting location 1808, the mounting location 1810, and one or more objects positioned in a region proximate to the robotic system 1000. FIG. 34 can depict the controller 1010 and/or the robotic system 1000 operating in a first mode 3402, and FIG. 35 can depict the controller 1010 and/or the robotic system 1000 operating in a second mode 3502. As described herein, the controller 1010 can select between the first mode 3402 and the second mode 3502 based on whether the gripper assembly 1003 is coupled to the solar panel 1804, and can apply a corresponding predetermined zone against which the position of a detected object is evaluated to determine whether to restrict movement of the articulated arm 1006 and the movable base 1002.

As shown in FIGS. 34 and 35 , the robotic system 1000 can include the movable base 1002 coupled with one or more image sensors 1302, the articulated arm 1006 disposed on the movable base 1002, the gripper assembly 100 coupled to a distal end of the articulated arm 1006, one or more image sensors 1320 coupled to the articulated arm 1006, the controller 1010 (e.g., first controller, etc.), a second controller 3408, and the vacuum source 1012. The articulated arm 1006 can include a proximal portion coupled to the movable base 1002 and a distal portion opposite the proximal portion, and the one or more image sensors 1320 can be coupled to the distal portion of the articulated arm 1006, as described with respect to FIG. 3.

The second controller 3408 can be associated with the articulated arm 1006. The second controller 3408 can receive control signals from the controller 1010 and can generate joint-level motor commands to position the articulated arm 1006 at commanded poses. In some implementations, the second controller 3408 can include one or more processors, one or more memory devices, and one or more communications interfaces for receiving the control signals from the controller 1010 and for transmitting motor drive signals to joint actuators of the articulated arm 1006. The second controller 3408 can execute a motion control library that converts pose commands received from the controller 1010 into individual joint angle trajectories for each joint of the articulated arm 1006. The second controller 3408 can receive encoder feedback from rotary encoders at the joints of the articulated arm 1006 and can perform closed-loop position control to track the commanded joint angle trajectories.

The controller 1010 can transmit high-level motion commands to the second controller 3408, such as a target pose for the gripper assembly 100 in the coordinate frame of the movable base 1002, and the second controller 3408 can perform inverse kinematics and trajectory interpolation to generate the corresponding joint-level motor commands. In some implementations, the second controller 3408 can be an arm controller that is co-located with the articulated arm 1006 and that communicates with the controller 1010 via a wired or wireless communications interface, such as an Ethernet connection, a serial bus, or a fieldbus protocol. In some implementations, the second controller 3408 can be a separate computing device from the controller 1010, with its own processor and memory that execute arm-specific control firmware independently of the controller 1010. The torque tube 1806 can be positioned lateral to the robotic system 1000, with the mounting location 1808 and the mounting location 1810 on the torque tube 1806 at positions at which respective solar panels are to be installed.

The controller 1010 can control the articulated arm 1006 to move the solar panel 1804 to the mounting location 1808 or the mounting location 1810 on the torque tube 1806 by transmitting motion commands to the second controller 3408. The second controller 3408 can execute a movement routine in response to the motion commands from the controller 1010. The movement routine can include a sequence of articulated arm 1006 motions that transport the solar panel 1804 from a staging location to the mounting location 1808 or the mounting location 1810 on the torque tube 1806, as described with respect to FIGS. 18 and 23 . The second controller 3408 can receive successive motion commands from the controller 1010 that define waypoints or target poses for each phase of the movement routine, and the second controller 3408 can generate joint-level motor commands that move the articulated arm 1006 along a trajectory between the waypoints. During execution of the movement routine, the controller 1010 can obtain image data from the one or more image sensors 1302 coupled to the movable base 1002 and/or the one or more image sensors 1320 coupled to the articulated arm 1006. The controller 1010 can continuously obtain image data from the image sensors 1302 and/or the image sensors 1320 during movement of the solar panel 1804 and can process the image data to determine whether a movement termination condition is satisfied.

The controller 1010 and/or the robotic system 1000 can operate in at least the first mode 3402 or the second mode 3502. In the first mode 3402, as depicted in FIG. 34, the gripper assembly 100 is not coupled to the solar panel 1804. In the second mode 3502, as depicted in FIG. 35, the solar panel 1804 is coupled to the gripper assembly 100 via the vacuum source 1012, with the gripper assembly 100 retaining the solar panel 1804 against a first surface of the solar panel 1804 using vacuum-actuated suction, as described with respect to FIG. 19.

The controller 1010 can determine whether the gripper assembly 100 is coupled to the solar panel 1804 and can set the operating mode of the controller 1010 and/or the robotic system 1000 based on the determination. For example, the controller 1010 can receive a vacuum status signal from the vacuum source 1012 indicating whether the vacuum source 1012 is in an active state or an inactive state. When the vacuum status signal indicates that the vacuum source 1012 is in the active state and that vacuum pressure at the plurality of suction cups of the gripper assembly 100 is at or above an operating threshold, the controller 1010 can determine that the gripper assembly 100 is coupled to the solar panel 1804 and can set the controller 1010 and/or the robotic system 1000 to the second mode 3502. When the vacuum status signal indicates that the vacuum source 1012 is in the inactive state, or when the controller 1010 has transmitted a release command to the vacuum source 1012 to deactivate the vacuum and activate a positive pressure source as described herein, the controller 1010 can determine that the gripper assembly 100 is not coupled to the solar panel 1804 and can set the controller 1010 and/or the robotic system 1000 to the first mode 3402. In some implementations, the controller 1010 can determine the coupling state of the gripper assembly 100 based on a pressure measurement from one or more pressure sensors disposed in-line with the vacuum lines between the vacuum source 1012 and the plurality of suction cups of the gripper assembly 100.

In some implementations, the controller 1010 can track the coupling state based on a state variable stored in a memory of the controller 1010 that is updated in response to commands issued by the controller 1010 during the pick-and-place cycle. For example, the controller 1010 can set the state variable to a coupled state in response to transmitting a vacuum activation command to the vacuum source 1012 during the pick phase, and the controller 1010 can set the state variable to an uncoupled state in response to transmitting the release command during the release phase. The controller 1010 can evaluate the state variable to determine the current operating mode and can select the corresponding predetermined zone. The controller 1010 can transition between the first mode 3402 and the second mode 3502 during a pick-and-place cycle as the coupling state of the gripper assembly 100 changes. For example, upon completion of the release phase in which the controller 1010 deactivates the vacuum source 1012 and activates the positive pressure source to release the solar panel 1804 at the mounting location 1808 or the mounting location 1810, the controller 1010 can transition from the second mode 3502 to the first mode 3402 and can replace the second zone 3504 with the first zone 3404 as the predetermined zone against which detected objects are evaluated. Upon coupling the gripper assembly 100 to a next solar panel 1804 during a subsequent pick phase, the controller 1010 can transition from the first mode 3402 to the second mode 3502 and can replace the first zone 3404 with the second zone 3504.

The controller 1010 can select a predetermined zone from a plurality of predetermined zones based at least in part on whether the gripper assembly 100 is coupled to the solar panel 1804. In the first mode 3402, the controller 1010 can select a first zone 3404 (e.g., a safety perimeter, exclusion boundary, proximity zone, detection region associated with the first mode 3402, etc.) from the plurality of predetermined zones. In the second mode 3502, the controller 1010 can select a second zone 3504 (e.g., a safety perimeter, exclusion boundary, proximity zone, detection region associated with the second mode 3502, etc.) from the plurality of predetermined zones. The first zone 3404 and the second zone 3504 can be different from one another. As depicted by comparing FIG. 34 and FIG. 35, a dimension of the first zone 3404 can be greater than a corresponding dimension of the second zone 3504. For example, a radius, a perimeter distance, or a boundary extent of the first zone 3404 can exceed that of the second zone 3504. The larger dimension of the first zone 3404 relative to the second zone 3504 can account for the circumstance in which, in the first mode 3402, the articulated arm 1006 is not carrying the solar panel 1804 and can be moving more freely or at higher speeds after a panel release, which can warrant a larger safety perimeter around the robotic system 1000. In the second mode 3502, the gripper assembly 100 is coupled to the solar panel 1804, and the articulated arm 1006 can be moving at a controlled speed while transporting the solar panel 1804 to the mounting location 1808 or the mounting location 1810, such that the second zone 3504 having a smaller dimension than the first zone 3404 can reflect the more constrained motion profile of the articulated arm 1006 while carrying the solar panel 1804.

The controller 1010 can determine that a movement termination condition is satisfied by detecting, based on the image data, an object within the applicable predetermined zone associated with the articulated arm 1006 or the movable base 1002. As depicted in FIG. 34, an object 3406 (e.g., a person, obstacle, equipment item, foreign body, detected entity, etc.) can be positioned within the first zone 3404. As depicted in FIG. 35, an object 3506 (e.g., a person, obstacle, equipment item, foreign body, detected entity, etc.) can be positioned within the second zone 3504. The object 3406 and/or the object 3506 can be a human, a piece of equipment, an installation structure, or another item detected within the image data obtained by the image sensors 1302 and/or the image sensors 1320. In some implementations, the controller 1010 can apply object detection to the image data to identify the object 3406 or the object 3506 and can determine whether the detected object is within the spatial bounds of the applicable predetermined zone. In some implementations, the object 3406 and the object 3506 are a same or different objects. The controller 1010 can apply one or more detection models, bounding box estimators, or semantic segmentation operations to the image data to identify regions of the image that correspond to a person, a vehicle, a torque tube, a hat rail, equipment, or another structure within the environment 1800.

In some implementations, the movement termination condition can be satisfied by detection of a person entering or being present within the applicable predetermined zone. In some implementations, the movement termination condition can be satisfied by detection of a static obstacle within the applicable predetermined zone, such as a racking post, a pallet of staged solar panels 1804, a tool, a cable, or another piece of field equipment positioned in the path of the articulated arm 1006 or the movable base 1002. In some implementations, the movement termination condition can be satisfied by detection of a moving object within the applicable predetermined zone, such as another robotic system, a vehicle, or a worker traversing the row 1802. In some implementations, the movement termination condition can be satisfied based on a proximity determination in which the controller 1010 determines that a distance between a detected object and the articulated arm 1006 or the movable base 1002 is less than a threshold distance, such as about 0.5 meters, about 1.0 meter, about 1.5 meters, about 2.0 meters, or about 3.0 meters, among others. The controller 1010 can calculate the distance based on depth data from one or more of the image sensors 1302 or the image sensors 1320, such as depth values derived from RGB-D image data, stereo disparity maps, or time-of-flight measurements.

In some implementations, the movement termination condition can be satisfied based on a rate of approach between the detected object and the articulated arm 1006 or the movable base 1002. The controller 1010 can determine the rate of approach by comparing positions of the detected object across successive frames of the image data and can determine that the movement termination condition is satisfied when the rate of approach exceeds a threshold rate, such as about 0.3 meters per second, about 0.5 meters per second, or about 1.0 meter per second, among others, In some implementations, the movement termination condition can be satisfied based on a predicted trajectory of the detected object. The controller 1010 can estimate the trajectory of the detected object over a prediction horizon, such as about 0.5 seconds, about 1.0 second, or about 2.0 seconds, among others, based on the position and velocity of the detected object across successive frames. The controller 1010 can determine that the movement termination condition is satisfied when the predicted trajectory of the detected object intersects the applicable predetermined zone within the prediction horizon, even if the detected object is not yet within the applicable predetermined zone at the time of the determination.

In some implementations, the movement termination condition can be satisfied based on a loss of image data from one or more of the image sensors 1302 or the image sensors 1320. For example, if the controller 1010 determines that an image sensor (e.g., image sensors 1302 or image sensors 1320, etc.) has ceased transmitting image data, has transmitted corrupted image data, or has transmitted image data in which a field of view is obstructed beyond a threshold percentage of the image area, the controller 1010 can determine that the movement termination condition is satisfied and can restrict movement of the articulated arm 1006 and the movable base 1002 until image data from that image sensor or from an alternate image sensor is restored. In some implementations, the movement termination condition can be satisfied based on detection of a collision or an impending collision between the articulated arm 1006 and a structure in the environment 1800, such as a torque tube 1806, a hat rail, or a previously placed solar panel 1804 on the torque tube 1806. The controller 1010 can determine that the movement termination condition is satisfied when the image data indicates that a distance between the gripper assembly 100 or a link of the articulated arm 1006 and a detected structure is less than a collision avoidance threshold, such as about 10 mm, about 25 mm, about 50 mm, or about 100 mm, among others.

In the first mode 3402, the movement termination condition can correspond to a first movement termination condition that is associated with the first zone 3404. The first movement termination condition can be satisfied by the controller 1010 detecting the object 3406 within the first zone 3404. In the second mode 3502, the movement termination condition can correspond to a second movement termination condition that is associated with the second zone 3504. The second movement termination condition can be satisfied by the controller 1010 detecting the object 3506 within the second zone 3504. The second movement termination condition can be different from the first movement termination condition. Because the first zone 3404 has a greater dimension than the second zone 3504, the first movement termination condition in the first mode 3402 can be triggered at a greater distance between the object 3406 and the robotic system 1000 compared to the second movement termination condition in the second mode 3502.

In response to determining that the applicable movement termination condition is satisfied based on the detected object being within the applicable predetermined zone, the controller 1010 can restrict movement of the articulated arm 1006 and the movable base 1002. Restricting movement of the articulated arm 1006 can include the controller 1010 transmitting a restriction signal to the second controller 3408 to cause the second controller 3408 to inhibit motion of the articulated arm 1006. The second controller 3408 can receive the restriction signal from the controller 1010 via the communications interface between the controller 1010 and the second controller 3408.

In response to receiving the restriction signal, the second controller 3408 can halt pending joint motions by ceasing transmission of motor drive signals to the joint actuators of the articulated arm 1006. The second controller 3408 can hold the articulated arm 1006 at its current joint configuration by maintaining the joint actuators in a position-hold state in which the joint actuators resist external torques and maintain the current joint angles. The second controller 3408 can refrain from initiating additional motions until the restriction is lifted by the controller 1010. In some implementations, the second controller 3408 can set an internal restriction flag in its memory in response to receiving the restriction signal, and the second controller 3408 can evaluate the restriction flag before executing any new motion command received from the controller 1010. While the restriction flag is set, the second controller 3408 can reject or queue incoming motion commands from the controller 1010 without transmitting corresponding motor drive signals to the joint actuators. In some implementations, the restriction signal can be a digital command transmitted over a communications bus between the controller 1010 and the second controller 3408, such as a stop command, an emergency halt command, or a motion inhibit command defined by a protocol of the second controller 3408.

In some implementations, restricting movement can include the controller 1010 terminating the movement routine that the second controller 3408 is executing. For example, if the second controller 3408 is executing a pre-programmed sequence of motions for transporting the solar panel 1804 from the staging location to the mounting location 1808 or the mounting location 1810, the controller 1010 can transmit the restriction signal to the second controller 3408 in response to the movement termination condition being satisfied, and the second controller 3408 can terminate the sequence by ceasing generation of joint-level motor commands for remaining waypoints in the sequence. The controller 1010 can transmit a drive restriction command to the tracked drivetrain of the movable base 1002 to inhibit movement of the movable base 1002 along the row 1802. The drive restriction command can cause the track 1004 to cease propelling the movable base 1002 and to hold the movable base 1002 at its current position within the row 1802. The controller 1010 can transmit the restriction signal to the second controller 3408 and the drive restriction command to the track 1004 concurrently, such that motion of the articulated arm 1006 and motion of the movable base 1002 are inhibited in response to the same movement termination condition determination. In some implementations, the controller 1010 can transmit the restriction signal to the second controller 3408 before transmitting the drive restriction command to the track 1004, or vice versa, depending on the relative proximity of the detected object to the articulated arm 1006 and the movable base 1002.

In some implementations, the controller 1010 can transition between the first mode 3402 and the second mode 3502 based on whether the gripper assembly 100 is coupled to the solar panel 1804. In response to the controller 1010 transitioning from the first mode 3402 to the second mode 3502, the controller 1010 can replace the first zone 3404 with the second zone 3504 as the predetermined zone against which the position of the detected object is evaluated. In response to the controller 1010 transitioning from the second mode 3502 to the first mode 3402, the controller 1010 can replace the second zone 3504 with the first zone 3404 as the predetermined zone.

In some implementations, when the gripper assembly 100 is retaining the solar panel 1804 in the second mode 3502, the image sensors 1320 on the articulated arm 1006 can be partially occluded by the solar panel 1804. In such implementations, the controller 1010 can rely on the image sensors 1302 on the movable base 1002 to obtain image data for determining whether the movement termination condition is satisfied. In implementations in which the gripper assembly 100 has released the solar panel 1804 and the image sensors 1320 are no longer occluded, the controller 1010 can rely on the image sensors 1320 or on a combination of the image sensors 1302 and the image sensors 1320 to obtain image data. The controller 1010 can select which of the image sensors 1302 or the image sensors 1320 to use based on whether the gripper assembly 100 is coupled to the solar panel 1804 and based on which image sensors have an unobstructed field of view.

The controller 1010 can maintain the restriction until the detected object 3406 and/or 3506 is no longer within the applicable predetermined zone. In response to determining that the detected object 3406 and/or 3506 has exited the applicable predetermined zone, the controller 1010 can transmit a resume signal to the second controller 3408. The second controller 3408 can receive the resume signal and can clear the internal restriction flag in its memory. In response to clearing the restriction flag, the second controller 3408 can resume accepting and executing motion commands from the controller 1010. The second controller 3408 can resume the movement routine for the articulated arm 1006 by generating joint-level motor commands for the remaining waypoints in the movement routine that were pending when the restriction signal was received. The controller 1010 can transmit a drive resume command to the tracked drivetrain of the movable base 1002, and the tracked drivetrain can resume propelling the movable base 1002 along the row 1802.

In some implementations, the controller 1010 can transmit the resume signal to the second controller 3408 and the drive resume command to the tracked drivetrain concurrently, such that motion of the articulated arm 1006 and navigation of the movable base 1002 are restored in response to the same determination that the detected object has exited the applicable predetermined zone. In some implementations, the controller 1010 can verify that the detected object has remained outside the applicable predetermined zone for a predetermined dwell period, such as about 0.5 seconds, about 1.0 second, or about 2.0 seconds, among others, before transmitting the resume signal to the second controller 3408 and the drive resume command to the tracked drivetrain. The dwell period can reduce the likelihood of the controller 1010 resuming motion in response to a transient detection event in which the detected object momentarily exits and re-enters the applicable predetermined zone.

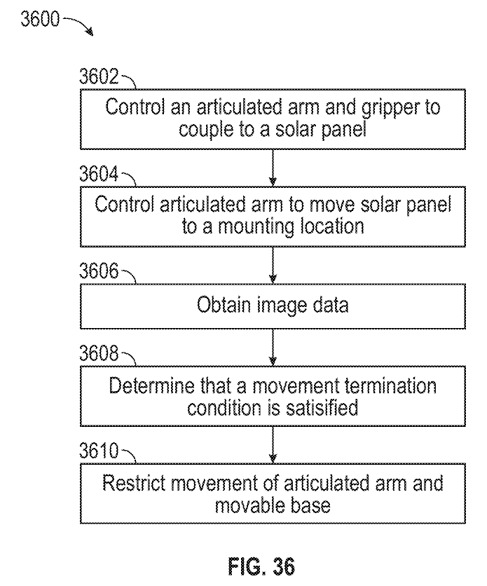

Referring now to FIG. 36, illustrated is a flow chart of a method 3600 for restricting movement of an articulated arm (e.g., the articulated arm 1006) and a movable base (e.g., the movable base 1002) based on image-detected movement termination conditions during solar panel handling, in accordance with one or more implementations. The method 3600 can be performed by a controller (e.g., the controller 1010) of a robotic system (e.g., the robotic system 1000). The robotic system can include the movable base coupled with a first image sensor (e.g., one of the image sensors 1302), the articulated arm disposed on the movable base, a gripper (e.g., the gripper assembly 1003) coupled to a distal end of the articulated arm, and a second image sensor (e.g., one of the image sensors 1320) coupled to the articulated arm. In some implementations, the articulated arm can include a proximal portion coupled to the movable base and a distal portion opposite the proximal portion, and the second image sensor can be coupled to the distal portion of the articulated arm.

At block 3602, the controller can control the articulated arm and the gripper to couple with a first surface of a solar panel (e.g., the solar panel 1804). The first surface can be an underside or non-active surface of the solar panel. The controller can transmit a control signal to the articulated arm to extend the articulated arm toward the solar panel and to position the gripper adjacent to the first surface. The controller can actuate a vacuum source (e.g., the vacuum source 1012) to generate negative pressure at a plurality of suction cups (e.g., the suction cups 108) of the gripper. The negative pressure can draw the suction cups against the first surface and couple the gripper to the solar panel.

At block 3604, the controller can control the articulated arm to move the solar panel to a mounting location (e.g., one of the mounting location 1808 or the mounting location 1810) on a torque tube (e.g., the torque tube 1806). The controller can control the articulated arm to move the solar panel by executing a movement routine that includes a sequence of articulated arm motions. The sequence of articulated arm motions can transport the solar panel from a staging location to the mounting location on the torque tube. In some implementations, the movement routine can include rotating and translating the solar panel laterally in a second direction transverse to a travel direction of the movable base, as described with respect to FIGS. 18 and 23 .

At block 3606, the controller can obtain, during movement of the solar panel, image data from the first image sensor coupled to the movable base or the second image sensor coupled to the articulated arm. The controller can continuously obtain image data from the first image sensor and/or the second image sensor while the articulated arm executes the movement routine. In some implementations, when the gripper is retaining the solar panel, the second image sensor on the articulated arm can be partially occluded by the solar panel. In such implementations, the controller can obtain image data from the first image sensor on the movable base. In implementations in which the gripper has released the solar panel and the second image sensor is no longer occluded, the controller can obtain image data from the second image sensor or from a combination of the first image sensor and the second image sensor. The controller can select which of the first image sensor or the second image sensor to use based on whether the gripper is coupled to the solar panel and/or based on which image sensor has an unobstructed field of view.

At block 3608, the controller can determine, based on the image data, that a movement termination condition is satisfied. The controller can determine that the movement termination condition is satisfied by detecting, based on the image data, an object within a predetermined zone associated with the articulated arm or the movable base. The object can be a person, a piece of equipment, an installation structure, or another item detected within the image data. The controller can apply object detection to the image data to identify the object and can determine whether the detected object is within the spatial bounds of the predetermined zone.

The controller can select the predetermined zone from a plurality of predetermined zones based at least in part on whether the gripper is coupled to the solar panel. The plurality of predetermined zones can include a first zone corresponding to the gripper not being coupled to the solar panel and a second zone corresponding to the gripper being coupled to the solar panel, the first zone being different from the second zone. A dimension of the first zone can be greater than a dimension of the second zone. The larger dimension of the first zone can account for a circumstance in which the articulated arm is not carrying the solar panel and can be moving more freely or at higher speeds after panel release, which can warrant a larger safety perimeter around the robotic system. When the gripper is coupled to the solar panel, the second zone having a smaller dimension than the first zone can reflect a more constrained motion profile of the articulated arm while carrying the solar panel.

In some implementations, the controller can operate in a first mode in which the gripper is coupled with the solar panel and the movement termination condition corresponds to a first movement termination condition, or in a second mode subsequent to releasing the solar panel from the gripper and the movement termination condition corresponds to a second movement termination condition. The second movement termination condition can be different from the first movement termination condition. The first movement termination condition can correspond to a first zone and the second movement termination condition can correspond to a second zone, a dimension of the second zone being greater than a dimension of the first zone. The controller can transition between the first mode and the second mode based on whether the gripper is coupled to the solar panel. The controller can determine that the gripper is coupled to the solar panel based on the vacuum source being in an active state, and the controller can determine that the gripper is not coupled to the solar panel based on the vacuum source being in an inactive state or based on a release command having been executed.

At block 3610, the controller can restrict movement of the articulated arm and the movable base in response to determining that the movement termination condition is satisfied. The controller can restrict movement by terminating the movement routine that the articulated arm is executing in response to determining that the movement termination condition is satisfied. In some implementations, the robotic system can include a second controller associated with the articulated arm. The second controller can receive control signals from the controller and can generate joint-level motor commands to position the articulated arm at commanded poses. Restricting movement can include the controller transmitting a restriction signal to the second controller to cause the second controller to inhibit motion of the articulated arm. The restriction signal can cause the second controller to halt pending joint motions, to hold the articulated arm at a current joint configuration, and to refrain from initiating additional motions until the restriction is lifted. The controller can transmit a drive restriction command to a tracked drivetrain of the movable base to inhibit movement of the movable base along a row of the environment.

The controller can maintain the restriction until the detected object is no longer within the applicable predetermined zone. In response to determining that the detected object has exited the applicable predetermined zone, the controller can resume the movement routine for the articulated arm and can resume navigation of the movable base. In some implementations, resuming the movement routine can include the controller transmitting a resume signal to the second controller associated with the articulated arm and transmitting a drive resume command to the tracked drivetrain of the movable base.

In some implementations, the blocks of the method 3600 can be performed in a different order, can be performed in parallel, or one or more blocks can be omitted, depending on the particular implementation and the operational conditions at the installation site.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

The term “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain implementations require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A robotic system, comprising:
a movable base configured to navigate along a first direction of a row of an environment for solar panel installation;
an articulated arm disposed on the movable base and comprising a gripper configured to couple to a solar panel; and
a controller configured to:
control the articulated arm and the gripper to move towards a first surface of the solar panel;
actuate a vacuum source to couple the gripper to the first surface of the solar panel, the solar panel having a first orientation relative to a body of the movable base; and
control the articulated arm to move the solar panel to a mounting location in the environment at a second orientation relative to the body of the movable base, the articulated arm to move the solar panel in a second direction transverse to the first direction.

2. The robotic system of claim 1, wherein the first surface of the solar panel is an underside of the solar panel, wherein the solar panel is above the gripper while the articulated arm moves the solar panel to the mounting location following coupling to the first surface.

3. The robotic system of claim 2, wherein the first surface is a non-active surface of the solar panel.

4. The robotic system of claim 1, wherein the solar panel is a first solar panel moved according to a first operating mode of the controller, the mounting location is a first mounting location, the row is a first row of the environment, and the gripper couples to the first surface at a first coupling location, wherein the controller is further configured to operate in a second operating mode, the controller further configured to:
determine, in the second operating mode while the movable base moves along a second direction opposite the first direction of a second row of the environment, a second coupling location on the solar panel different from the first coupling location;
control, in the second operating mode, the articulated arm and the gripper to couple to the solar panel at the second coupling location; and
control, in the second operating mode, the articulated arm to move the solar panel to a second mounting location in the environment different from the mounting location.

5. The robotic system of claim 1, wherein the movable base comprises a track to move the movable base along the row.

6. The robotic system of claim 1, wherein in the first orientation, the solar panel extends along a first plane and in the second orientation, the solar panel extends along a second plane angled relative to the first plane.

7. The robotic system of claim 1, wherein the gripper comprises a plurality of suction cups configured to engage the first surface of the solar panel in response to the vacuum source being actuated.

8. The robotic system of claim 1, wherein the controller is further configured to:
in response to actuating the vacuum source to decouple the gripper from the first surface and disposing the solar panel at the mounting location, controlling the articulated arm to move in a third direction transverse to the first direction and the second direction, and back towards the movable base along the second direction.

9. The robotic system of claim 1, wherein the movable base is in an orientation extending along the first direction during coupling of the gripper to the solar panel and movement of the solar panel to the mounting location.

10. The robotic system of claim 1, wherein the first surface of the solar panel is substantially perpendicular to the first direction.

11. A method for installing a solar panel in an environment using a robotic system comprising a movable base, an articulated arm, a gripper, a vacuum source, and a controller, the method comprising:
navigating, by the controller, the movable base along a first direction of a row of the environment;
controlling, by the controller, the articulated arm disposed on the movable base to move the gripper toward a first surface of the solar panel;
actuating, by the controller, the vacuum source to couple the gripper to the first surface of the solar panel, the solar panel having a first orientation relative to a body of the movable base; and
controlling, by the controller, the articulated arm to move the solar panel to a mounting location in the environment at a second orientation relative to the body of the movable base, the articulated arm moving the solar panel in a second direction transverse to the first direction.

12. The method of claim 11, wherein the first surface of the solar panel is an underside of the solar panel, and wherein the solar panel is positioned above the gripper while the articulated arm moves the solar panel to the mounting location following coupling to the first surface.

13. The method of claim 12, wherein the first surface is a non-active surface of the solar panel.

14. The method of claim 11, wherein the solar panel is a first solar panel moved according to a first operating mode of the controller, the mounting location is a first mounting location, the row is a first row of the environment, and the gripper couples to the first surface at a first coupling location, the method further comprising:
determining, by the controller in a second operating mode while the movable base moves along a second direction opposite the first direction of a second row of the environment, a second coupling location on the solar panel different from the first coupling location;
controlling, by the controller in the second operating mode, the articulated arm and the gripper to couple to the solar panel at the second coupling location; and
controlling, by the controller in the second operating mode, the articulated arm to move the solar panel to a second mounting location in the environment different from the mounting location.

15. The method of claim 11, wherein navigating the movable base comprises moving the movable base along the row using a track.

16. The method of claim 11, wherein in the first orientation, the solar panel extends along a first plane and in the second orientation, the solar panel extends along a second plane angled relative to the first plane.

17. The method of claim 11, wherein coupling the gripper to the first surface comprises actuating, by the controller, the vacuum source to draw suction through a plurality of suction cups of the gripper to engage the first surface of the solar panel.

18. The method of claim 11, further comprising:
deactivating, by the controller, the vacuum source to decouple the gripper from the first surface after disposing the solar panel at the mounting location; and
controlling, by the controller, the articulated arm to move in a third direction transverse to the first direction and the second direction, and then back toward the movable base along the second direction.

19. The method of claim 11, wherein the movable base is oriented to extend along the first direction during both coupling of the gripper to the solar panel and movement of the solar panel to the mounting location.

20. The method of claim 11, wherein the first surface of the solar panel is substantially perpendicular to the first direction.
